(19) United States
(12) Patent Application Publication
(10) Pub. No.: US 2012/0278118 A1
(43) Pub. Date: Nov. 1, 2012

(54) INFORMATION PROCESSING SYSTEM, PROGRAM, AND INFORMATION PROCESSING METHOD

(75) Inventors: Katsufumi ARAKI, Kanagawa (JP); Katsuya TERASHIMA, Kanagawa (JP)

(73) Assignee: ITID CONSULTING, LTD., Tokyo (JP)

(21) Appl. No.: 13/547,065

(22) Filed: Jul. 12, 2012

Related U.S. Application Data
(62) Division of application No. 12/841,155, filed on Jul. 21, 2010.
Application No. 12/841,155 is a continuation of application No. PCT/JP2009/000183, filed on Jan. 20, 2009.

(30) Foreign Application Priority Data
Jan. 23, 2008 (JP) 2008-013162

(51) Int. Cl. G06Q 10/06

(52) U.S. Cl. 705/7.17; 705/7.28

(57) ABSTRACT

The object of the present invention is to decrease the effort and cost involved in managing a product development project. Provided is an information processing system comprising a specific task list acquiring section that acquires a specific task list in which at least one of a requirement that is needed for a product being developed and a component included in the product being developed is associated with each of a plurality of specific tasks; a requirement/component dependency relationship information acquiring section that acquires requirement/component dependency relationship information indicating dependency relationships of the requirements and the components indicated by the specific task list; an integrated task dependency relationship calculating section that calculates dependency relationships of the specific tasks based on the requirement/component dependency relationship information; and an integrated task dependency relationship information generating section that generates integrated task dependency relationship information indicating the dependency relationships of the specific tasks.

### CROSS REFERENCE TO RELATED APPLICATION

The contents of the following patent application is incorporated herein by reference,

No. 2008-013162 filed on Jan. 23, 2008.

### 1. TECHNICAL FIELD

The present invention relates to an information processing system, a recording medium, and an information processing method. In particular, the present invention relates to an information processing system, a recording medium, and an information processing method used for a product development project.

### 2. RELATED ART

There is a known computer system that, for a product development project, aims to improve operating efficiency by calculating a dependency relationship between technically examined items based on data concerning the examined items input by a user, and determining a work order for a plurality of the examined items based on the calculated dependency relationship between the examined items, as shown in, for example, Patent Document 1.
Patent Document 1: Japanese Patent Application Publication No. 2007-109073.

In the above system, however, the computer cannot calculate the dependency relationship and work order for each task that is an actual work item in the product development project. Therefore, the user must reference the work order of the plurality of examined items and manually create a work schedule for the tasks. Furthermore, if the progress of the tasks changes, the user must manually update the related examined item data.

In the above system, when the user updates the examined item data, the computer updates the dependency relationship and the work order of the examined items. However, the computer cannot update the dependency relationship and the work order for each task. Therefore, the user must reference the updated dependency relationship and work order of the examined items and manually update the work schedule of the tasks. Since the above system requires many manual operations by the user, management of the product development project incurs a high cost and large amount of effort.

### SUMMARY

Therefore, it is an object of an aspect of the innovations herein to provide an information processing system, a recording medium, and an information processing method, which are capable of overcoming the above drawbacks accompanying the related art. The above and other objects can be achieved by combinations described in the independent claims. The dependent claims define further advantageous and exemplary combinations of the innovations herein.

According to a first aspect of the present invention, provided is an information processing system for obtaining dependency relationships of a plurality of tasks in a product development project, the information processing system comprising a specific task list acquiring section that acquires a specific task list in which at least one of a requirement that is needed for a product being developed and a component included in the product being developed is associated with each of a plurality of specific tasks; a status acquiring section that acquires a risk value for each requirement and component indicated by the specific task list; a dependency degree acquiring section that acquires, for each requirement and component indicated by the specific task list, a degree of dependency of the requirement or component on another requirement or component; an integrated task dependency relationship calculating section that calculates dependency relationships of the specific tasks based on the risk values acquired by the status acquiring section and the degrees of dependency acquired by the dependency degree acquiring section; and an integrated task dependency relationship information generating section that generates integrated task dependency relationship information indicating the dependency relationships of the specific tasks.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary information processing system 10 according to an embodiment of the present invention.

FIG. 2 shows an exemplary function configuration of the information processing apparatus 100.

FIGS. 3A and 3B show exemplary configurations of requirements and components.

FIG. 4 shows an exemplary process flow performed by the schedule generating unit 200.

FIG. 5 shows exemplary risk values acquired by the status acquiring section 222 and degrees of dependency acquired by the dependency degree acquiring section 224.

FIG. 6 shows other exemplary risk values acquired by the status acquiring section 222 and degrees of dependency acquired by the dependency degree acquiring section 224.

FIG. 7 shows other exemplary risk values acquired by the status acquiring section 222 and degrees of dependency acquired by the dependency degree acquiring section 224.

FIG. 8 shows exemplary requirement/component dependency relationship information generated by the requirement/component dependency relationship information generating section 226.

FIG. 9 shows an exemplary specific task list acquired by the specific task list acquiring section 204.

FIG. 10 shows an exemplary general task list acquired by the general task list acquiring section 201.

FIG. 11 shows exemplary general task dependency relationship information acquired by the general task dependency relationship information acquiring section 202.

FIG. 12 shows exemplary integrated task dependency relationship information generated by the integrated task dependency relationship information generating section 212.

FIG. 13 shows exemplary integrated task dependency relationship information generated by the integrated task dependency relationship information generating section 212.

FIG. 14 shows exemplary integrated task dependency relationship information indicating the work order of a plurality of specific tasks.

FIG. 15 shows an exemplary overlap policy acquired by the overlap policy acquiring section 214.

FIG. 16 shows an exemplary schedule output by the output section 217.

FIG. 17 shows an exemplary function configuration of the data check unit 300.

FIG. 18 shows an exemplary process performed by the data check unit 300.

FIG. 19 shows another exemplary process performed by the data check unit 300.

FIG. 20 shows another exemplary process performed by the data check unit 300.

FIG. 21 shows another exemplary process performed by the data check unit 300.

FIG. 22 shows an exemplary function configuration of the data conforming unit 400.

FIGS. 23A and 23B show exemplary processes performed by the data conforming unit 400.

FIGS. 24A and 24B show other exemplary processes performed by the data conforming unit 400.

FIG. 25 shows an exemplary hardware configuration of the information processing apparatus 100.

FIG. 26 shows an exemplary process flow performed by the schedule generating unit 200.

FIG. 27 shows exemplary statuses acquired by the status acquiring section 222 and degrees of dependency acquired by the dependency degree acquiring section 224.

FIG. 28 shows an exemplary general task list acquired by the general task list acquiring section 201.

FIG. 29 shows exemplary general task dependency relationship information acquired by the general task dependency relationship information acquiring section 202.

FIG. 30 shows an exemplary general schedule output by the output section 217.

FIG. 31 shows an exemplary specific task list acquired by the specific task list acquiring section 204.

FIG. 32 shows an exemplary integrated task list generated by the integrated task dependency relationship calculating section 208.

FIG. 33 shows exemplary integrated task dependency relationship information generated by the integrated task dependency relationship information generating section 212.

FIG. 34 shows exemplary integrated task dependency relationship information generated by the integrated task dependency relationship information generating section 212.

FIG. 35 shows exemplary integrated task dependency relationship information indicating the work order of a plurality of specific tasks.

FIG. 36 shows an exemplary overlap policy acquired by the overlap policy acquiring section 214.

FIG. 37 shows an exemplary synchronization relationship table generated by the integrated schedule generating section 216.

FIG. 38 shows an exemplary integrated schedule output by the output section 217.

FIG. 39 shows an exemplary integrated task list generated by the integrated task dependency relationship calculating section 208.

FIG. 40 shows exemplary risk values acquired by the status acquiring section 222 and degrees of dependency acquired by the dependency degree acquiring section 224.

FIG. 41 shows an exemplary integrated task list generated by the integrated task dependency relationship calculating section 208.

FIG. 42 shows exemplary risk values acquired by the status acquiring section 222 and degrees of dependency acquired by the dependency degree acquiring section 224.

FIGS. 43A to 43C show other exemplary processes performed by the data conforming unit 400.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

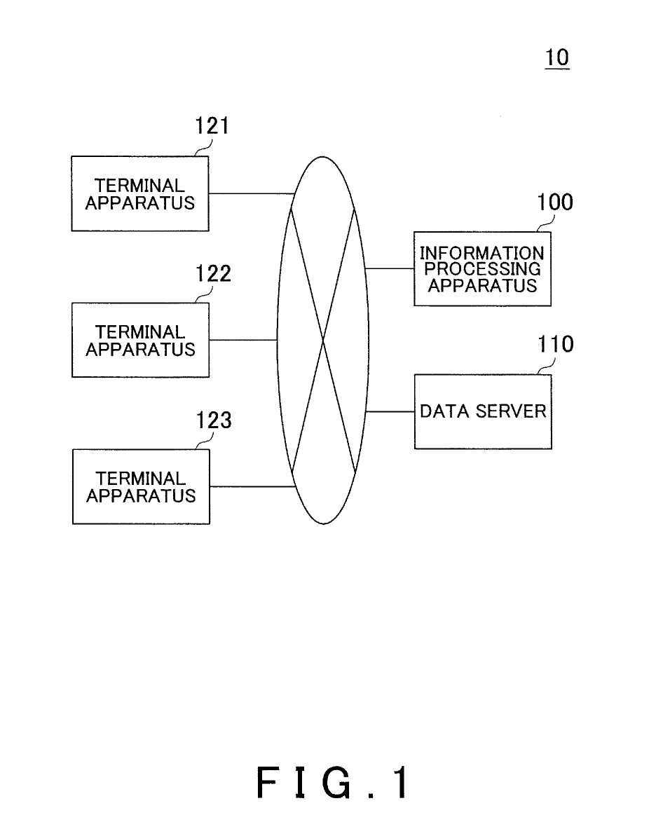

FIG. 1 shows an exemplary information processing system 10 according to an embodiment of the present invention. The information processing system 10 includes an information processing apparatus 100, a data server 110, a terminal apparatus 121, a terminal apparatus 122, and a terminal apparatus 123. The information processing system 10 functions as a project management system.

The information processing system 10 manages a product development project that is divided into a plurality of management layers. For example, the information processing system 10 manages a product development project that is divided into three layers, which are an organizational management layer, a labor management layer, and a design management layer. The information processing system 10 manages each phase of the product development project. The product development project may be any type of system development project or project for managing work processes and dates.

The organizational management layer is for managing the highest layer of management items in the product development project. Specifically, the organizational management layer is for managing the product development project at a general task level, which is the highest layer in the product development project. A general task is a task that is above a specific task, and includes a plurality of specific tasks.

The labor management layer is for managing items that are in a layer below the general tasks. Specifically, the labor management layer is for managing the product development project at a specific task level, which includes management items that are a layer below the general tasks. The specific tasks represent work items in the product development project.

The design management level is for managing technical items, which are items that are a layer below the specific tasks. Specifically, the design management level is for managing the product development project at a requirement and component level, which includes management items that are a layer below the specific tasks. Here, “requirements” refer to requirements that are necessary for the product being developed, and “components” refer to components that are included in the product being developed.

The information processing system 10 uses a combination of management data from the design management layer, management data from the labor management layer, and management data from the organizational management layer to generate a general schedule and an integrated schedule. Integrated tasks include a plurality of general tasks and a plurality of specific tasks.

The general schedule includes a schedule of general tasks as a binding schedule. Here, a “binding schedule” refers to a schedule that is created by leaders of the project based on the requirements of the managers, for example. The integrated schedule includes, as a loose schedule, a schedule of specific tasks based on the schedule of the general tasks. Here, a “loose schedule” refers to a realistic schedule that is created by people in charge of the labor for the project.

Specifically, the information processing system 10 calculates the dependency relationship of the integrated tasks, which includes the dependency relationship among the specific tasks, the dependency relationship among the general tasks, and the dependency relationship between the specific tasks and the general tasks, based on the management data from each management level. The information processing system 10 determines the work order of the integrated tasks, which includes the work order of specific tasks and of general tasks, based on the dependency relationship of the integrated tasks. Furthermore, the information processing system 10 generates the integrated schedule, which includes a loose schedule of specific tasks and general tasks, based on the work order of the integrated tasks.

The dependency relationship among the tasks represents the amount of impact that a task receives when something occurs in another task. For example, when there is a high probability that a design change will occur in a certain task when a design change occurs in another task, these two tasks are considered to have a strong dependency relationship. On the other hand, when there is a low probability that a design change will occur in a certain task when a design change occurs in another task, these two tasks are considered to have a weak dependency relationship.

When the management data of the design management layer, the management data of the labor management layer, or the management data of the organizational layer is changed, the information processing system 10 changes the integrated schedule according to the content of the change in the data. As a result, the information processing system 10 can constantly keep the integrated schedule in synchronization with the management data of each management layer.

Specifically, when the management data of any one of the management layers is changed, the information processing system 10 changes the dependency relationship of the integrated schedule according to the content of the change in the management data. The information processing system 10 then changes the work order of the integrated tasks based on the dependency relationship of the changed integrated tasks. Furthermore, the information processing system 10 changes the integrated schedule based on the changed work order of the integrated tasks.

The data server 110 stores the management data of each management level. For example, the data server 110 may store the management data of each management level received from the terminal apparatus 121 and the like. The data server 110 may store the management data of each management level output from the information processing apparatus 100. The data server 110 may be formed as a single physical apparatus. Instead, the data server 110 may be formed as a plurality of physical apparatuses.

The information processing apparatus 100 functions as a project management apparatus that controls the information processing system 10. For example, the information processing apparatus 100 may calculate the dependency relationship of the integrated tasks based on the management data of each management layer received from the terminal apparatus 121 and the management data of each management layer stored in the data server 110. The information processing apparatus 100 determines the work order of the integrated tasks based on the dependency relationship of the integrated tasks. The information processing apparatus 100 generates the integrated schedule based on the work order of the integrated tasks.

The information processing apparatus 100 checks the conformity of the management data of each management level received from the terminal apparatus 121 and the like. The information processing apparatus 100 performs an operation to ensure the conformity of the management data of each management level received from the terminal apparatus 121 and the like. For example, when the management data in one of the management layers received from the terminal apparatus 121 or the like is changed, the information processing apparatus 100 may update the management data relating to the changed management data. As a result, the information processing apparatus 100 can ensure that the management data of each management layer is always consistent.

The information processing apparatus 100 may be formed as a single physical apparatus. The information processing apparatus 100 may be formed as a plurality of physical apparatuses. The information processing apparatus 100 may perform the input/output process for the management data in one or more of the management layers in place of the terminal apparatus 121 or the like. The information processing apparatus 100 may store a portion or the entirety of the management data of each management level in place of the data server 110.

The terminal apparatuses 121, 122, and 123 each input and output the management data of each management level. For example, the terminal apparatuses 121, 122, and 123 may each transmit, to the data server 110 or the information processing apparatus 100 via a communication network, the management data of each management level received from a user via an input device such as a keyboard. As another example, the terminal apparatuses 121, 122, and 123 may each transmit, to an output device such as a display, the management data of each management level transmitted from the data server 110 or the information processing apparatus 100.

The terminal apparatuses 121, 122, and 123 may each input and output a portion of the management data of the management layers. For example, the terminal apparatus 121 may input and output the management data of the organizational management layer. The terminal apparatus 122 may input and output the management data of the labor management layer. The terminal apparatus 123 may input and output the management data of the design management layer.

The terminal apparatuses 121, 122, and 123 may perform a portion of the processes performed by the information processing apparatus 100. The terminal apparatuses 121, 122, and 123 may store a portion or the entirety of the management data of each management level in place of the data server 110.

The information processing system 10 of the present embodiment can automatically calculate the dependency relationships of the integrated tasks, which includes the dependency relationships of a plurality of specific tasks, based on the management data of a plurality of management levels. Furthermore, when the management data is changed, the information processing system 10 can automatically change the dependency relationships of the integrated tasks according to the content of the change in the management data.

The information processing system 10 of the present embodiment can automatically generate the integrated schedule, which indicates an appropriate work order, based on the management data of a plurality of management levels. Furthermore, when the management data is changed, the information processing system 10 can automatically change the integrated schedule according to the content of the change in the management data.

The information processing system 10 of the present embodiment can generate the integrated schedule with focus placed on a certain time period of the product development project, by using a combination of management data from several layers. For example, the information processing system 10 can generate the integrated schedule with focus placed on a portion of the phases or on a portion of the general tasks. As a result, the information processing system 10 can generate an integrated schedule that is more appropriate than an integrated schedule generated for the entire product development project.

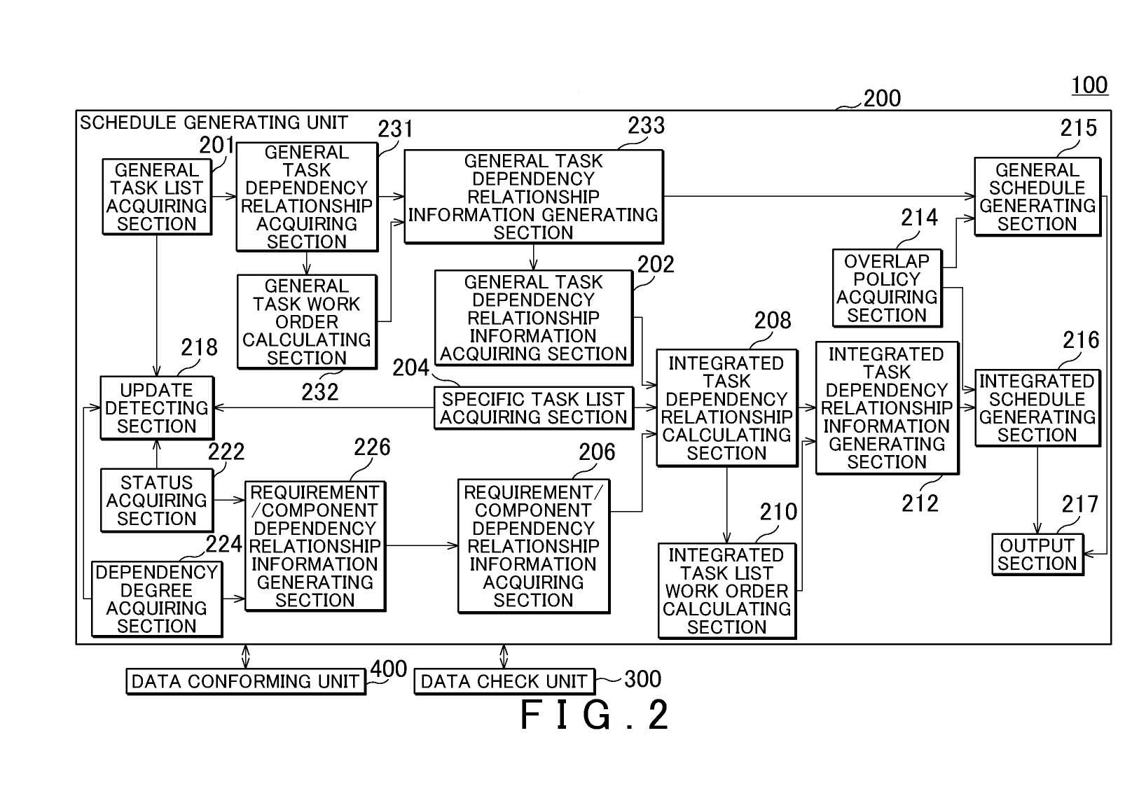

FIG. 2 shows an exemplary function configuration of the information processing apparatus 100. The information processing apparatus 100 includes a schedule generating unit 200, a data check unit 300, and a data conforming unit 400.

The schedule generating unit 200 includes a general task list acquiring section 201, a general task dependency relationship information acquiring section 202, a specific task list acquiring section 204, a requirement/component dependency relationship information acquiring section 206, an integrated task dependency relationship calculating section 208, and an integrated task work order calculating section 210. The schedule generating unit 200 further includes an integrated task dependency relationship information generating section 212, an overlap policy acquiring section 214, a general schedule generating section 215, an integrated schedule generating section 216, an output section 217, and an update detecting section 218. The schedule generating unit 200 also includes a status acquiring section 222, a dependency degree acquiring section 224, and a requirement/component dependency relationship information generating section 226. The schedule generating unit 200 further includes a general task dependency relationship acquiring section 231, a general task work order calculating section 232, and a general task dependency relationship information generating section 233.

The general task list acquiring section 201 acquires a general task list indicating a plurality of general tasks. The general task list acquiring section 201 may acquire the general task list with focus placed on a portion of the phases in the product development project. The general task list acquiring section 201 may acquire the general task list from a storage medium such as a memory or a hard disk provided to the computer.

The general task dependency relationship acquiring section 231 acquires the dependency relationships of the general tasks indicated by the general task list acquired by the general task list acquiring section 201. The general task dependency relationship acquiring section 231 may acquire the dependency relationships of the general tasks from a storage medium such as a memory or a hard disk provided to the computer. The general task dependency relationship acquiring section 231 may acquire the dependency relationships of the general tasks input by a user via an input device such as a keyboard provided to the computer.

The general task work order calculating section 232 calculates the work order of the general tasks indicated by the general task list acquired by the general task list acquiring section 201. For example, the general task work order calculating section 232 calculates the work order of the general tasks based on the dependency relationships of the general tasks acquired by the general task dependency relationship acquiring section 231.

The general task dependency relationship information generating section 233 generates general task dependency relationship information indicating the dependency relationship of a plurality of general tasks. The general task dependency relationship information generating section 233 may generate the general task dependency relationship information indicating the dependency relationship and the work order of a plurality of general tasks.

For example, the general task dependency relationship information generating section 233 may generate the general task dependency relationship information indicating the dependency relationship and the work order calculated by the general task work order calculating section 232 for the plurality of general tasks acquired by the general task dependency relationship acquiring section 231. The general task dependency relationship information generating section 233 may generate the general task dependency relationship information indicating the dependency relationship of the plurality of general tasks in a DSM (Design Structure Matrix) format. The general task dependency relationship information generating section 233 may generate the general task dependency relationship information indicating the dependency relationship and the work order of a plurality of general tasks in a DSM format. The general task dependency relationship information generating section 233 may store the generated general task dependency relationship information in a recording medium such as memory or a hard disk provided to the computer.

The general task dependency relationship information acquiring section 202 acquires the general task dependency relationship information indicating the dependency relationship of the general tasks indicated by the general task list acquired by the general task list acquiring section 201. For example, the general task dependency relationship information acquiring section 202 may acquire the general task dependency relationship information generated by the general task dependency relationship information generating section 233. The general task dependency relationship information acquiring section 202 may acquire the general task dependency relationship information indicating the dependency relationship of a plurality of general tasks in a DSM format. The general task dependency relationship information acquiring section 202 may acquire the general task dependency relationship information from a storage medium such as a memory or a hard disk provided to the computer.

The specific task list acquiring section 204 acquires a specific task list in which at least one of the requirements necessary for the product being developed or the components included in the product being developed is associated with each of the specific tasks. The specific task list acquiring section 204 may acquire the specific task list with focus placed on a portion of the phases in the product development project. The specific task list acquiring section 204 may acquire the specific task list with focus placed on a portion of the specific tasks in the product development project. The specific task list acquiring section 204 may acquire the specific task list from a storage medium such as a memory or a hard disk provided to the computer.

The requirement/component dependency relationship information acquiring section 206 acquires the requirement/component dependency relationship information indicating the dependency relationships of the requirements and components indicated by the specific task list. The requirement/component dependency relationship information acquiring section 206 may acquire the requirement/component dependency relationship information indicating the dependency relationships of the requirements and components indicated by the specific task list in a DSM format. The requirement/component dependency relationship information acquiring section 206 may acquire the requirement/component dependency relationship information from a storage medium such as a memory or a hard disk provided to the computer.

The requirement/component dependency relationship information acquiring section 206 may acquire the requirement/component dependency relationship information generated based on differential risk values between (i) risk values of the requirements and components at the work start time and (ii) risk values of the requirements and components at the work end time. For example, the requirement/component dependency relationship information acquiring section 206 may acquire the requirement/component dependency relationship information generated based on differential risk values between (i) risk values of the requirements and components at the work start time and (ii) risk values of the requirements and components at the work end time, for a portion of the phases or a portion of the general tasks in the design development project.

The integrated task dependency relationship calculating section 208 calculates an integrated task dependency relationship, which includes the dependency relationship of the specific tasks indicated by the specific task list acquired by the specific task list acquiring section 204, based on the requirement/component dependency relationship information acquired by the requirement/component dependency relationship information acquiring section 206. The integrated task dependency relationship calculating section 208 may calculate the integrated task dependency relationship based on the requirement/component dependency relationship information acquired by the requirement/component dependency relationship information acquiring section 206 and on the general task dependency relationship information acquired by the general task dependency relationship information acquiring section 202.

When the requirement/component dependency relationship information acquiring section 206 has acquired differential requirement/component dependency relationship information based on the differential risk values between the risks value at the work start time and the risk values at the work end time, the integrated task dependency relationship calculating section 208 may calculate the dependency relationships of the specific tasks based on the differential requirement/component dependency relationship information. The integrated task dependency relationship calculating section 208 may calculate the integrated task dependency relationships, which include the dependency relationships of the specific tasks indicated by the specific task list and the dependency relationships of the general tasks indicated by the general task list.

The integrated task work order calculating section 210 calculates an integrated task work order, which includes the work order of the specific tasks indicated by the specific task list acquired by the specific task list acquiring section 204, based on the integrated task dependency relationship information calculated by the integrated task dependency relationship calculating section 208. The integrated task work order calculating section 210 may calculate the integrated task work order, which includes the work order of the general tasks indicated by the general task list acquired by the general task list acquiring section 201.

The integrated task dependency relationship information generating section 212 generates integrated task dependency relationship information indicating the dependency relationships of the integrated tasks calculated by the integrated task dependency relationship calculating section 208. The integrated task dependency relationship information generating section 212 may generate the integrated task dependency relationship information further indicating the work order of the integrated tasks calculated by the integrated task work order calculating section 210.

The integrated task dependency relationship information generating section 212 may generate the integrated task dependency relationship information indicating the dependency relationships of the integrated tasks in a DSM format. The integrated task dependency relationship information generating section 212 may generate the integrated task dependency relationship information indicating the dependency relationships and the work order of the integrated tasks in a DSM format. The integrated task dependency relationship information generating section 212 may store the generated integrated task dependency relationship information in a recording medium such as memory or a hard disk provided to the computer.

The overlap policy acquiring section 214 acquires an overlap policy that determines a synchronization timing for work dates among specific tasks. The overlap policy acquiring section 214 may acquire an overlap policy that determines a synchronization timing for work dates among general tasks. The overlap policy acquiring section 214 may acquire the overlap policy from a storage medium such as a memory or a hard disk provided to the computer.

The general schedule generating section 215 generates a general schedule based on the work order of a plurality of general tasks indicated by the general task dependency relationship information. The general schedule generating section 215 may generate the general schedule further based on estimated work time for each of the general tasks indicated by the general task list.

The general schedule generating section 215 may generate the general schedule such that work dates for a plurality of general tasks are in synchronization with each other, based on the overlap policy acquired by the overlap policy acquiring section 214. The general schedule generating section 215 may generate a task chart indicating the general schedule. The general schedule generating section 215 may store the generated schedule in a recording medium such as memory or a hard disk provided to the computer.

The integrated schedule generating section 216 generates an integrated schedule based on the work order of a plurality of integrated tasks indicated by the integrated task dependency relationship information generated by the integrated task dependency relationship information generating section 212. The integrated schedule generating section 216 may generate the integrated schedule further based on estimated work time for each of the specific tasks indicated by the specific task list.

The integrated schedule generating section 216 may generate the integrated schedule such that work dates for a plurality of general tasks are in synchronization with each other, based on the overlap policy acquired by the overlap policy acquiring section 214. The integrated schedule generating section 216 may generate a task chart indicating the integrated schedule. The integrated schedule generating section 216 may store the generated integrated schedule in a recording medium such as memory or a hard disk provided to the computer.

The output section 217 outputs the general schedule generated by the general schedule generating section 215. The output section 217 outputs the integrated schedule generated by the integrated schedule generating section 216. The output section 217 may store the general schedule and the integrated schedule in a recording medium such as memory or a hard disk provided to the computer.

The output section 217 may display the general schedule and the integrated schedule in a display provided to the computer. The output section 217 may transmit the general schedule and the integrated schedule to the terminal apparatuses 121, 122, and 123. The terminal apparatuses 121, 122, and 123 may display the received general schedule and integrated schedule on displays provided thereto. The output section 217 may display the general schedule and the integrated schedule in a display provided to the computer, in a manner enabling comparison between the general schedule and the integrated schedule.

The update detecting section 218 detects an update of the dependency relationships of the requirements or the components indicated by the requirement/component dependency relationship information. The update detecting section 218 may detect a change in the risk value acquired by the status acquiring section 222 by monitoring this risk value. The update detecting section 218 may detect a change in the degrees of dependency acquired by the dependency degree acquiring section 224 by monitoring these degrees of dependency.

The update detecting section 218 may detect addition, change, or deletion of a general task in the general task list by monitoring the general task list acquired by the general task list acquiring section 201. The update detecting section 218 may detect addition, change, or deletion of a specific task in the specific task list by monitoring the specific task list acquired by the specific task list acquiring section 204. The update detecting section 218 may detect an update in the progress of a specific task by monitoring the specific task list acquired by the specific task list acquiring section 204.

In response to the update detecting section 218 detecting an update to a dependency relationship of a requirement or component indicated by the requirement/component dependency relationship information, the requirement/component dependency relationship information acquiring section 206 may acquire the updated requirement/component dependency relationship information. The integrated task dependency relationship calculating section 208 may then recalculate the integrated task dependency relationships based on the updated requirement/component dependency relationship information.

The integrated task work order calculating section 210 may also recalculate the integrated task work order based on the recalculated integrated task dependency relationship information. The integrated task dependency relationship information generating section 212 may regenerate the integrated task dependency relationship information indicating the recalculated dependency relationship and work order of the integrated tasks. The integrated schedule generating section 216 may also regenerate the integrated schedule based on the recalculated integrated task work order.

The status acquiring section 222 acquires a risk value indicating the probability of implementation for each requirement necessary for the product being developed and a risk value indicating a degree of reliability for each component included in the product being developed. The status acquiring section 222 acquires a degree of design freedom and a degree of importance for each requirement and component. The status acquiring section 222 may acquire the risk values, the degrees of design freedom, and the degrees of importance from a storage medium such as a memory or a hard disk provided to the computer. The status acquiring section 222 may acquire the risk values, the degrees of design freedom, and the degrees of importance input by a user via an input device such as a keyboard provided to the computer.

The dependency degree acquiring section 224 acquires the degrees of dependency of the requirements and components for which the status acquiring section 222 acquired the risk values. Specifically, the dependency degree acquiring section 224 acquires the degrees of dependency among the requirements, the degrees of dependency among the components, and the degrees of dependency between the requirements and the components. The dependency degree acquiring section 224 may acquire the degrees of dependency from a storage medium such as a memory or a hard disk provided to the computer. The dependency degree acquiring section 224 may acquire the degrees of dependency input by a user via an input device such as a keyboard provided to the computer.

The requirement/component dependency relationship information generating section 226 generates requirement/component dependency relationship information indicating the dependency relationships of a plurality of requirements and a plurality of components, based on the risk values acquired by the status acquiring section 222 and the degrees of dependency acquired by the dependency degree acquiring section 224. The requirement/component dependency relationship information generating section 226 may generate the requirement/component dependency relationship information indicating the dependency relationships of a plurality of requirements and a plurality of components in a DSM format, based on the risk values acquired by the status acquiring section 222 and the degrees of dependency acquired by the dependency degree acquiring section 224.

The requirement/component dependency relationship information generating section 226 may acquire the risk values acquired by the status acquiring section 222 and the degrees of dependency acquired by the dependency degree acquiring section 224 from a DMM table. The requirement/component dependency relationship information generating section 226 may store the generated requirement/component dependency relationship information in a recording medium such as memory or a hard disk provided to the computer.

The requirement/component dependency relationship information generating section 226 may generate the requirement/component dependency relationship information based on the differential risk values between the risk values at the work start time and the risk values at the work end time, which are acquired by the status acquiring section 222. The requirement/component dependency relationship information generating section 226 may generate the requirement/component dependency relationship information based on the differential risk values between the risk values at the work start time and the risk values at the work end time, for a portion of the phases or a portion of the general tasks of the product development project.

The requirement/component dependency relationship information generating section 226 may calculate the degrees of dependency of the requirements and components indicated by the requirement/component dependency relationship information, based on the risk values acquired by the status acquiring section 222 and the degrees of dependency acquired by the dependency degree acquiring section 224. The requirement/component dependency relationship information generating section 226 may determine the work order of the requirements and components indicated by the requirement/component dependency relationship information, based on the calculated degrees of dependency. The requirement/component dependency relationship information generating section 226 may acquire the degrees of design freedom and the degrees of importance for each requirement and component, and calculate the work order and the degrees of dependency of the requirements and components indicated by the requirement/component dependency relationship information based further on the acquired degrees of design freedom and degrees of importance.

As a specific example, first, the requirement/component dependency relationship information generating section 226 receives from the status acquiring section 222 risk values, a degree of design freedom, and a degree of importance for each requirement and component. For example, the requirement/component dependency relationship information generating section 226 may acquire the risk values, the degrees of design freedom, and the degrees of importance from a DMM table. Next, the requirement/component dependency relationship information generating section 226 receives the degrees of dependency from the dependency degree acquiring section 224. For example, the requirement/component dependency relationship information generating section 226 may acquire the degrees of dependency from a DMM table.

The requirement/component dependency relationship information generating section 226 then calculates the degrees of dependency indicated by the requirement/component dependency relationship information based on the risk values, the degrees of dependency, the degrees of design freedom, and the degrees of importance. In this case, the requirement/component dependency relationship information generating section 226 may calculate the degrees of dependency indicated by the requirement/component dependency relationship information by using the method disclosed in Japanese Patent Application Publication No. 2007-109073.

Furthermore, by performing a partition analysis on the requirement/component dependency relationship information indicating the calculated degrees of dependency, the requirement/component dependency relationship information generating section 226 can rearrange the rows and columns of the requirement/component dependency relationship information such that requirements and components with strong dependency relationships are grouped together within the requirement/component dependency relationship information. In this case, the requirement/component dependency relationship information generating section 226 may determine the work order of the requirements and the components by performing, on the requirement/component dependency relationship information, the partition analysis disclosed in Japanese Patent Application Publication No. 2007-109073.

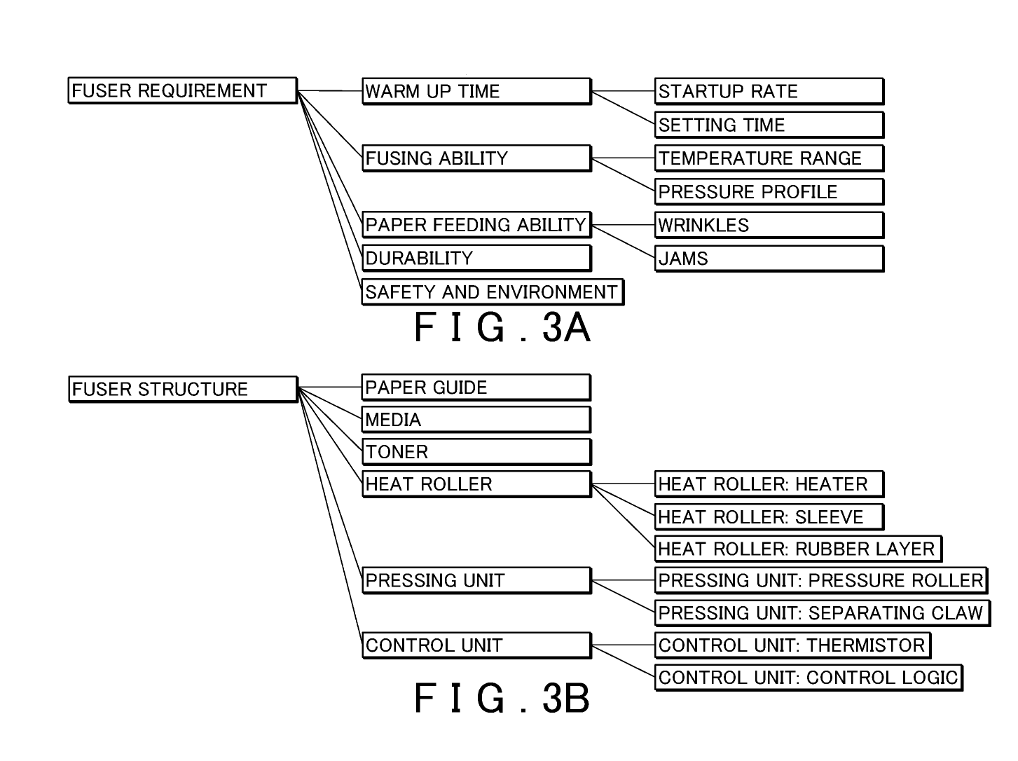

FIGS. 3A and 3B show exemplary configurations of requirements and components. FIG. 3A shows a partial configuration of requirements necessary for a printer, which is the product being developed here. The parent requirement is “fuser requirements,” and this parent requirement includes “warm up time,” “fusing ability,” “paper feeding ability,” “durability,” and “safety and environment” as sub-requirements.

Furthermore, the sub-requirement of “warm up time” includes “startup rate” and “setting time” as sub-sub-requirements. The sub-requirement of “fusing ability” includes “temperature range” and “pressure profile” as sub-sub-requirements. The sub-requirement of “paper feeding ability” includes “wrinkles” and “jams” as sub-sub-requirements.

FIG. 3B shows a partial configuration of components included in a printer, which is the product being developed here. The parent component, which is a “fuser structure,” includes a “paper guide,” “media,” “toner,” a “heat roller,” a “pressing unit,” and a “control unit” as sub-components.

Furthermore, the sub-component “heat roller” includes a “heat roller: heater,” a “heat roller: sleeve,” and a “heat roller: rubber layer” as sub-sub-components. The sub-component “pressing unit” includes a “pressing unit: pressure roller” and a “pressing unit: separating claw” as sub-sub-components. The sub-component “control unit” includes a “control unit: thermistor” and a “control unit: control logic” as sub-sub-components.

The information processing apparatus 100 may display the requirement and component tree structure, such as shown in FIG. 3, on a display provided to the computer. In addition to this tree, the information processing apparatus 100 may display the risk value for each of the requirements and components. For example, the information processing apparatus 100 may display each component and requirement in a color corresponding to the risk value.

In addition to the above tree, the information processing apparatus 100 may display information for identifying whether each risk value conforms to another risk value. For example, the information processing apparatus 100 may display requirements or components that have risk values that do not conform with other risk values in an emphasized manner, such as by displaying these requirements or components in a highly noticeable color. The information processing apparatus 100 may receive any risk values of requirements or components via the screen on which the tree is displayed, as input from a user.

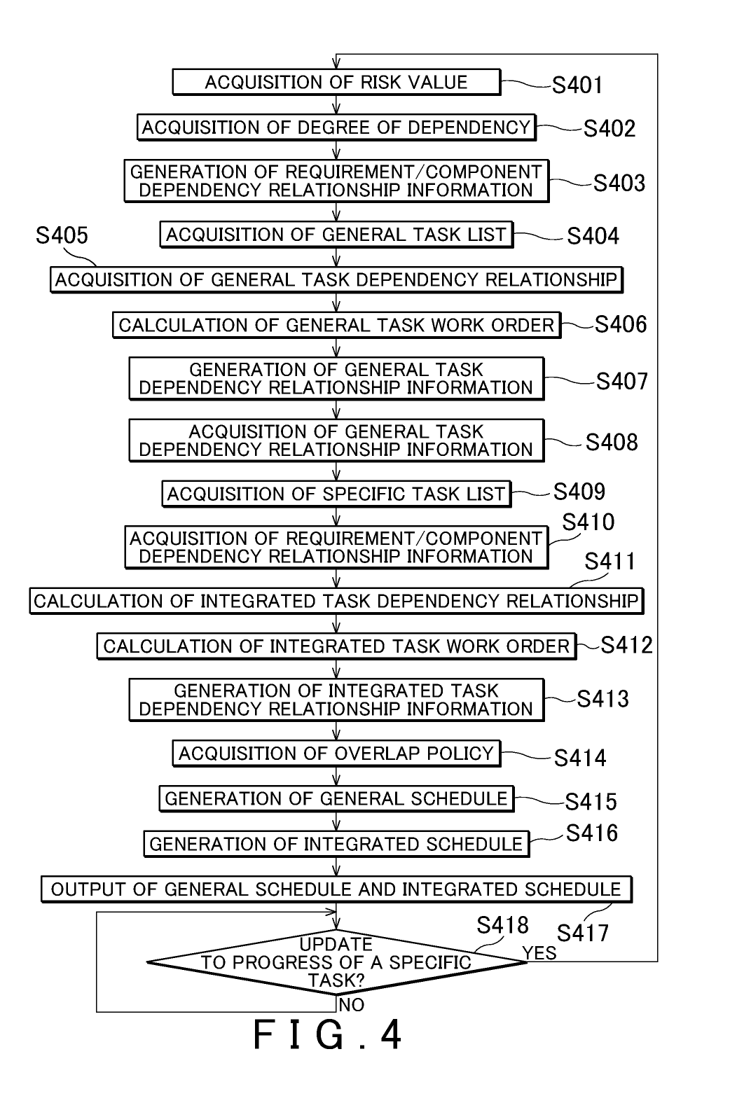

FIG. 4 shows an exemplary process flow performed by the schedule generating unit 200. First, the status acquiring section 222 acquires the risk value for each of the requirements and components (S401). The dependency degree acquiring section 224 then acquires the degrees of dependency of these requirements and components (S402).

Next, the requirement/component dependency relationship information generating section 226 generates the requirement/component dependency relationship information indicating the dependency relationships of the requirements and components (S403). The general task list acquiring section 201 then acquires the general task list indicating a plurality of general tasks (S404).

Next, the general task dependency relationship acquiring section 231 acquires the dependency relationship for the general tasks indicated by the general task list acquired at S404 (S405). The general task work order calculating section 232 then calculates the work order of the general tasks indicated by the general task list acquired at S404 (S406). Next, the general task dependency relationship information generating section 233 generates the general task dependency relationship information indicating the dependency relationships acquired at S405 and the work order calculated at S406 of the general tasks (S407). The general task dependency relationship information acquiring section 202 then acquires the general task dependency relationship information generated at S407 (S408).

Next, the specific task list acquiring section 204 acquires the specific task list associated with at least one of a requirement and a component for each of the specific tasks (S409). The requirement/component dependency relationship information acquiring section 206 then acquires the requirement/component dependency relationship information generated by the requirement/component dependency relationship information generating section 226 (S410).

Next, the integrated task dependency relationship calculating section 208 calculates the integrated task dependency relationship, which includes the dependency relationships for the specific tasks indicated by the specific task list acquired at S409 (S411). The integrated task work order calculating section 210 then calculates the integrated task work order, which includes the work order of the specific tasks indicated by the specific task list acquired at S409, based on the integrated task dependency relationship information calculated by the integrated task dependency relationship calculating section 208 (S412).

Next, the integrated task dependency relationship information generating section 212 generates the integrated task dependency relationship information indicating the dependency relationships calculated at S411 and the work order calculated at S412 of the integrated tasks (S413). The overlap policy acquiring section 214 then acquires the overlap policy that determines the synchronization timing for work dates among specific tasks and the general tasks (S414).

Next, the general schedule generating section 215 generates the general schedule in which the work dates of the general tasks are synchronized with each other (S415). The integrated schedule generating section 216 then generates the integrated schedule in which the work dates of the specific tasks are synchronized with each other (S416).

Next, the output section 217 outputs a plurality of general schedules generated at S415 and the integrated schedule generated at S416 (S417). The update detecting section 218 then determines whether the progress of any of the specific tasks indicated by the specific task list has been updated (S418).

If there is a change in the progress of the project, the user may update the progress of the corresponding specific tasks in the specific task list. The update detecting section 218 monitors the progress of the specific tasks in the specific task list. Therefore, the update detecting section 218 can detect an update to the progress of the specific tasks in the specific task list. When the update detecting section 218 detects an update to the progress of a specific task, the information processing apparatus 100 updates the risk values of the requirements or components associated with the specific task whose progress was updated. The user may edit the risk values of the requirements or components updated by the information processing apparatus 100.

At S418, the update detecting section 218 may detect an update to information other than the progress of the specific tasks. For example, the update detecting section 218 may detect addition, change, or deletion of a general task in the general task list by monitoring the general task list acquired by the updated risk value calculating section 404. The update detecting section 218 may detect addition, change, or deletion of a specific task in the specific tasks in the specific task list acquired at S409. Furthermore, the update detecting section 218 may detect a change in the risk values acquired at S401. Yet further, the update detecting section 218 may detect a change in the degrees of dependency acquired at S402.

When the update detecting section 218 determines that there has been an update to the progress of the specific tasks indicated by the specific task list (the “YES” of S418), the information processing apparatus 100 repeats the steps from S401 onward. On the other hand, when the update detecting section 218 determines that there has not been an update to the progress of the specific tasks indicated by the specific task list (the “NO” of S418), the information processing apparatus 100 performs S418 again.

In this way, when there is an update to the progress of the specific tasks, the information processing apparatus 100 of the present embodiment can automatically update the integrated schedule to have an appropriate work order according to the content of the update to the progress of the specific tasks. Therefore, the effort and cost incurred by the product development project can be decreased. In the above description, the information processing apparatus 100 performs a plurality of processes in series, but the information processing apparatus 100 may instead perform a portion of these processes in parallel with others of these processes. For example, the information processing apparatus 100 may perform processes for different management layers in parallel.

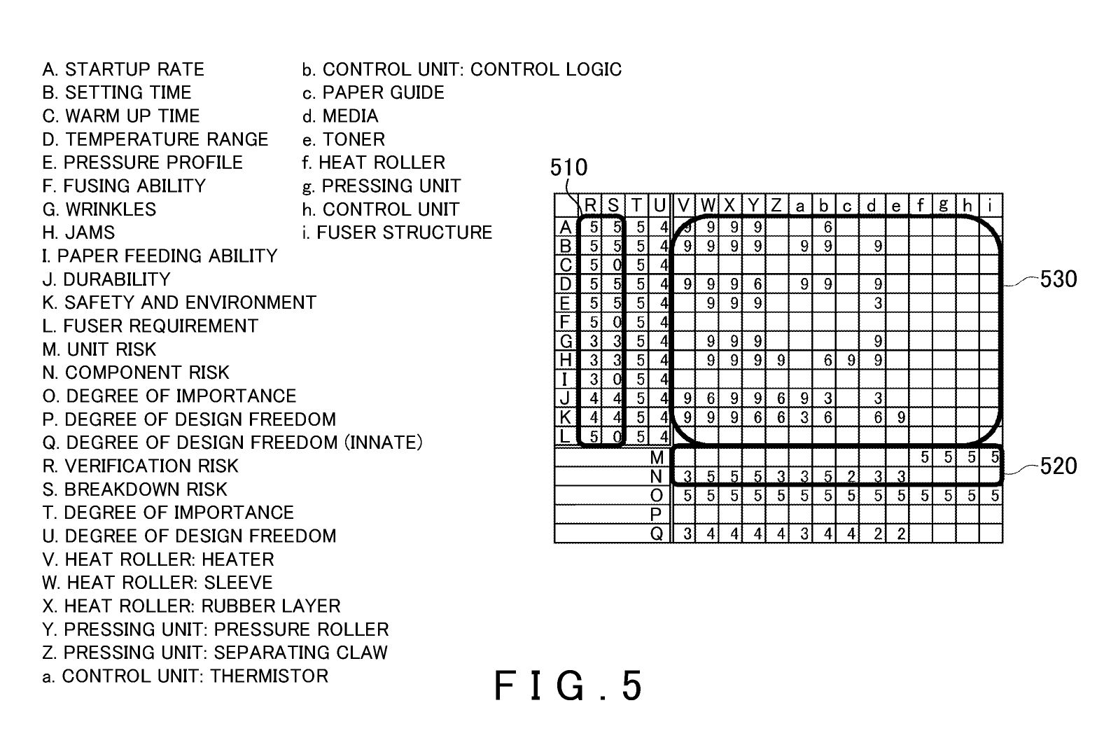

FIG. 5 shows exemplary risk values acquired by the status acquiring section 222 and degrees of dependency acquired by the dependency degree acquiring section 224. The information processing apparatus 100 can display the risk values acquired by the status acquiring section 222 and degrees of dependency acquired by the dependency degree acquiring section 224 in a DMM format. The information processing apparatus 100 may display the components in the columns of the DMM table. The information processing apparatus 100 may display the requirements in the rows of the DMM table.

The status region 510 displays status information for each requirement. The requirement status information includes “verification risk” and “breakdown risk.” The “verification risk” is a risk value obtained by the status acquiring section 222 for each requirement, and indicates a degree of attainment. The “breakdown risk” is a risk value acquired by the status acquiring section 222 for each requirement, and indicates the risk of extracting sub-requirements or design components for achieving the requirement, allocating target specifications to sub-requirements, and implementing design specifications.

The status region 520 displays status information for each component. The component status information includes “unit risk” and “component risk.” The “unit risk” is a risk value obtained by the status acquiring section 222 for each component and displayed in units. The “component risk” is an innate risk value acquired for each component by the status acquiring section 222, and indicates a degree of risk with regard to degrees of verification and implementation of a design for achieving a requirement associated with the requirement. A high value for the risk value of a requirement or component means that it is difficult to achieve that requirement or component.

The dependency degree region 530 displays the degrees of dependency between the requirements and the components. A high value for the degree of dependency between a requirement and a component means that there is a strong dependency relationship between the requirement and the component. For example, the dependency degree region 530 displays “9” for the degree of dependency between the requirement “durability” and the component “control unit: thermistor.” This means that the requirement “durability” and the component “control unit: thermistor” exert a strong effect on each other.

Furthermore, the dependency degree region 530 displays “6” for the degree of dependency between the requirement “durability” and the component “pressing unit: separating claw.” This means that the requirement “durability” and the component “pressing unit: separating claw” exert a relatively strong effect on each other.

The dependency degree region 530 displays “3” for the degree of dependency between the requirement “durability” and the component “control unit: control logic.” This means that the requirement “durability” and the component “control unit: control logic” exert an effect on each other that is weak, but not weak enough to be ignored.

The dependency degree region 530 does not display a value for the degree of dependency between the requirement “durability” and the component “paper guide.” This means that the requirement “durability” and the component “paper guide” do not exert an effect on each other, or exert an effect that is small enough to be ignored.

The DMM table displays a degree of design freedom and a degree of importance for each requirement and component. The degree of design freedom represents the degree to which the requirements and components can be freely designed in the current design plan. A large value for the degree of design freedom indicates a high degree of design freedom. For example, in the DMM chart of FIG. 5, the cell designated by the row of “degree of design freedom” and the column of “startup rate” displays a value of “4” for the degree of design freedom of the requirement “startup rate.” Furthermore, in the DMM chart of FIG. 5, the cell designated by the row of “heat roller: heater” and the column of “degree of design freedom (innate)” displays a value of “3” for the innate degree of design freedom of the component “heat roller: heater.”

The DMM table also displays a degree of importance for each requirement and component. The degree of importance represents how important a requirement or component is in the product planning. A large value for the degree of importance means that a requirement or component is essential in the product planning. For example, in the DMM chart of FIG. 5, the cell designated by the row of “degree of importance” and the column of “startup rate” displays a value of “5” for the degree of importance of the requirement “startup rate.” Furthermore, in the DMM chart of FIG. 5, the cell designated by the row of “heat roller: heater” and the column of “degree of importance” displays a value of “5” for the innate degree of importance of the component “heat roller: heater.”

In the DMM table shown in FIG. 5, the status regions 510 and 520 display risk values at the time when work is begun. For example, in the status region 510, the cell designated by the row of “verification risk” and the column of “startup rate” displays a value of “5” for the risk value at the work start time of the requirement “startup rate.” Furthermore, in the status region 520, the cell designated by the row of “heat roller: heater” and the column of “component risk” displays a value of “3” for the innate risk value at the work start time of the component “heat roller: heater.”

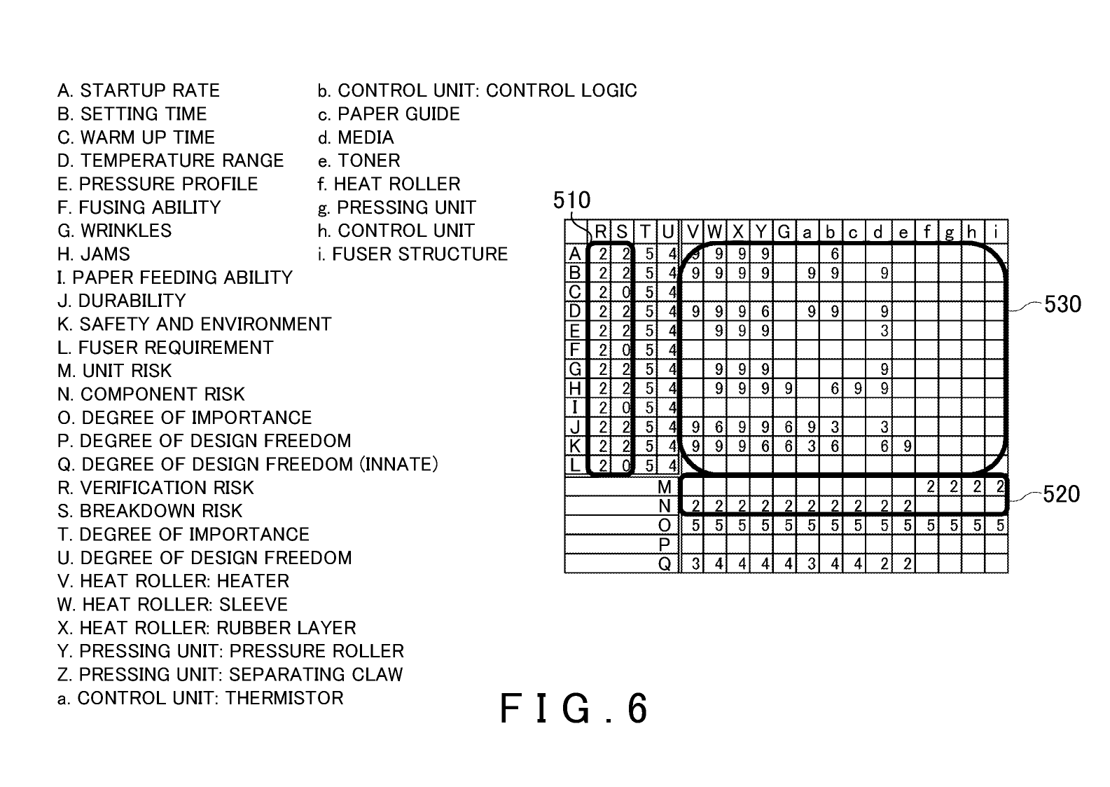

FIG. 6 shows other exemplary risk values acquired by the status acquiring section 222 and degrees of dependency acquired by the dependency degree acquiring section 224. In contrast to the DMM table of FIG. 5, in the DMM table shown in FIG. 6, the status regions 510 and 520 display risk values at the work end time.

For example, in the status region 510, the cell designated by the row of “verification risk” and the column of “startup rate” displays a value of “2” for the target risk value at the work end time of the requirement “startup rate.” Furthermore, in the status region 520, the cell designated by the row of “heat roller: heater” and the column of “component risk” displays a value of “2” for the innate target risk value at the work end time of the component “heat roller: heater.”

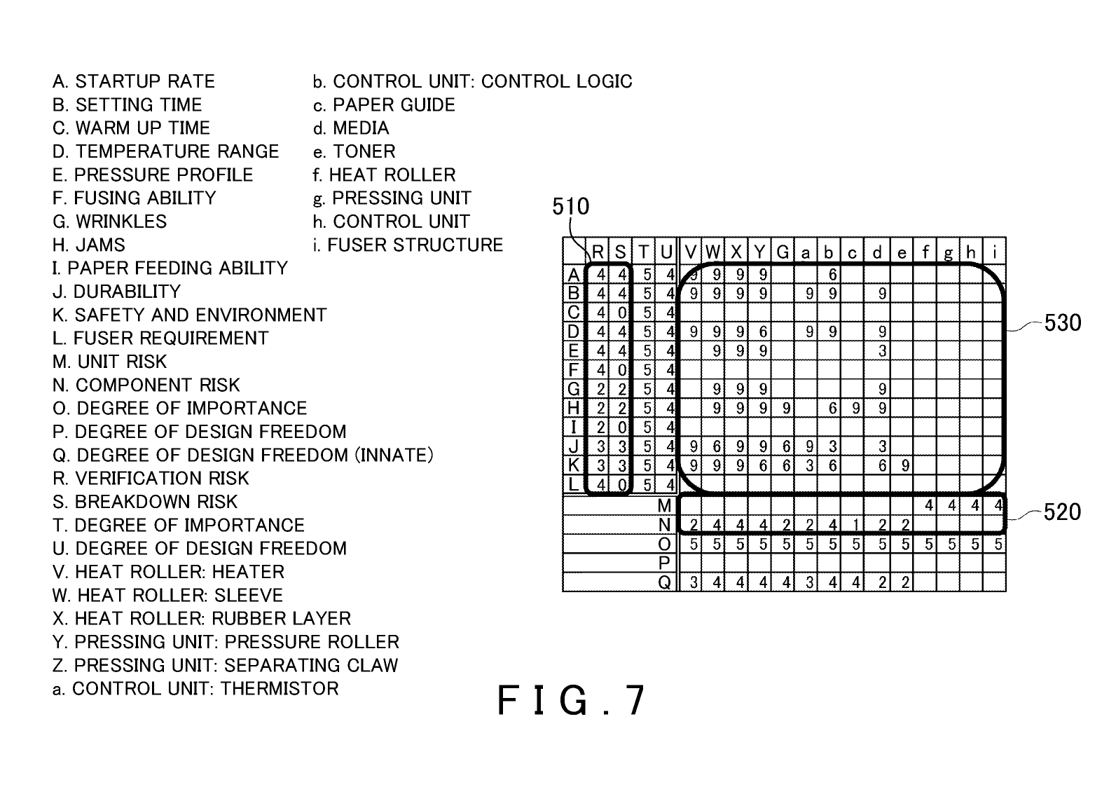

FIG. 7 shows other exemplary risk values acquired by the status acquiring section 222 and degrees of dependency acquired by the dependency degree acquiring section 224. In the DMM table shown in FIG. 7, the status regions 510 and 520 display differential risk values indicating the difference between the risk values at the work start time shown in FIG. 5 and the risk values at the work end time shown in FIG. 6.

For example, in the status region 510, the cell designated by the row of “verification risk” and the column of “startup rate” displays a value of “4” for the differential risk value of the requirement “startup rate.” The information processing apparatus 100 may acquire the value of “5” from the DMM table of FIG. 5 as the risk value at the work start time of the requirement “startup rate.” The information processing apparatus 100 may acquire the value of “2” from the DMM table of FIG. 6 as the target risk value at the work end time of the requirement “startup rate.” Therefore, by subtracting the target risk value at the work end time, which is “2,” form the risk value at the work start time, which is “5,” and then adding “1” to the result, the information processing apparatus 100 can calculate the differential risk value to be “4.” In the present embodiment, a process of adding “1” is performed when calculating the differential risk value, but this process need not be used.

Furthermore, in the status region 520, the cell designated by the row of “heat roller: heater” and the column of “component risk” displays a value of “2” for the innate differential risk value of the component “heat roller: heater.” The information processing apparatus 100 may acquire the value of “3” from the DMM table of FIG. 5 as the innate risk value at the work start time of the component “heat roller: heater.” The information processing apparatus 100 may acquire the value of “2” from the DMM table of FIG. 6 as the innate target risk value at the work end time of the component “heat roller: heater.” Therefore, by subtracting the target risk value at the work end time, which is “2,” form the risk value at the work start time, which is “3,” and then adding “1” to the result, the information processing apparatus 100 can calculate the differential risk value to be “2.” Here as well, a process of adding “1” is performed when calculating the differential risk value, but this process need not be used.

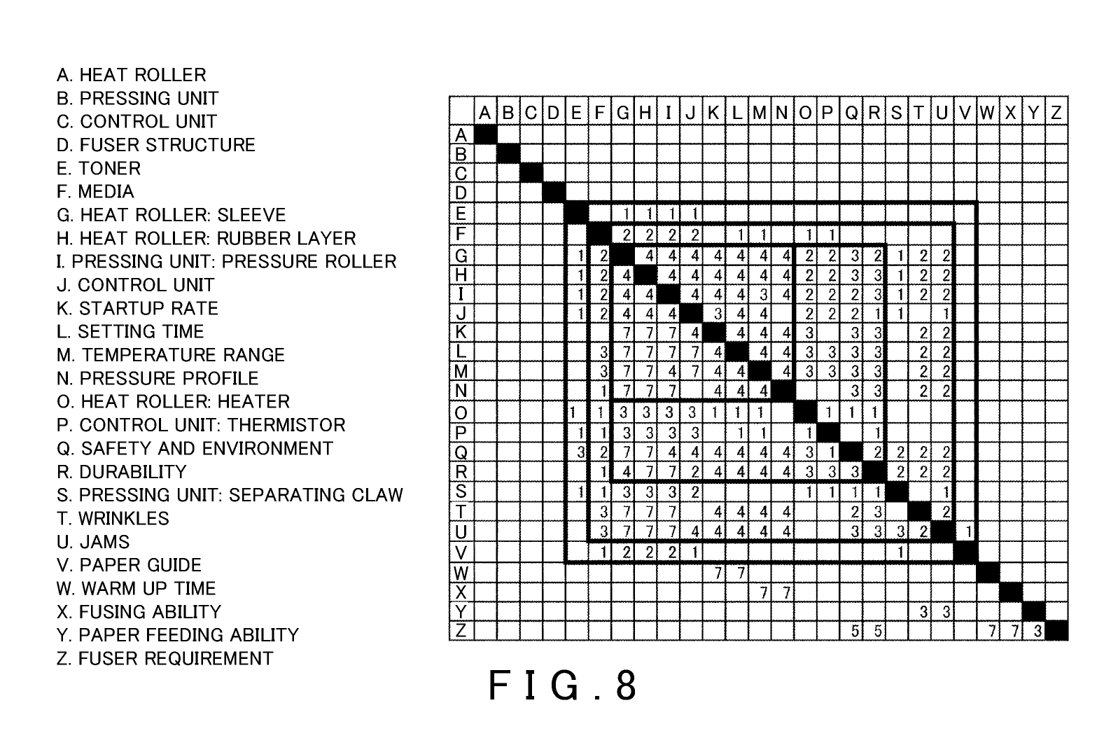

FIG. 8 shows exemplary requirement/component dependency relationship information generated by the requirement/component dependency relationship information generating section 226. The information processing apparatus 100 can display the requirement/component dependency relationship information in a DSM format. As shown in FIG. 8, the information processing apparatus 100 may display the requirements and components as main items in the rows of the DSM table. The information processing apparatus 100 may display the requirements and components as reference items in the columns of the DSM table.

A large value for the degree of dependency in the requirement/component dependency relationship information means that a certain requirement or component exerts a strong effect on another requirement or component. For example, the requirement/component dependency relationship information displays a value of “7” as the degree of dependency in the cell designated by the row of “heat roller; sleeve” and the column “startup rate.” On the other hand, the requirement/component dependency relationship information displays a value of “4” as the degree of dependency in the cell designated by the row of “startup rate” and the column “heat roller; sleeve.” This means that the effect of the component “heat roller; sleeve” on the requirement “startup rate” is greater than the effect of the requirement “startup rate” on the component “heat roller; sleeve.”

The DSM table of FIG. 8 displays degrees of dependency calculated by the requirement/component dependency relationship information generating section 226 based on the differential risk values, degrees of dependency, degrees of importance, and degrees of design freedom shown in the DMM table of FIG. 7. For example, the requirement/component dependency relationship information generating section 226 may acquire the differential risk values, degrees of dependency, degrees of importance, and degrees of design freedom from the DMM table of FIG. 7. The requirement/component dependency relationship information generating section 226 then calculates the degrees of dependency indicated by the requirement/component dependency relationship information based on the acquired risk values, degrees of dependency, degrees of design freedom, and degrees of importance. In this case, the requirement/component dependency relationship information generating section 226 may calculate the degrees of dependency indicated by the requirement/component dependency relationship information by using the method disclosed in Japanese Patent Application Publication No. 2007-109073.

Furthermore, by performing a partition analysis on the requirement/component dependency relationship information indicating the calculated degrees of dependency, the requirement/component dependency relationship information generating section 226 can rearrange the rows and columns of the requirement/component dependency relationship information such that requirements and components with strong dependency relationships are grouped together within the requirement/component dependency relationship information. In this case, the requirement/component dependency relationship information generating section 226 may determine the work order of the requirements and the components by performing, on the requirement/component dependency relationship information, the partition analysis disclosed in Japanese Patent Application Publication No. 2007-109073. As a result, the requirement/component dependency relationship information generating section 226 can generate the requirement/component dependency relationship information shown in FIG. 8.

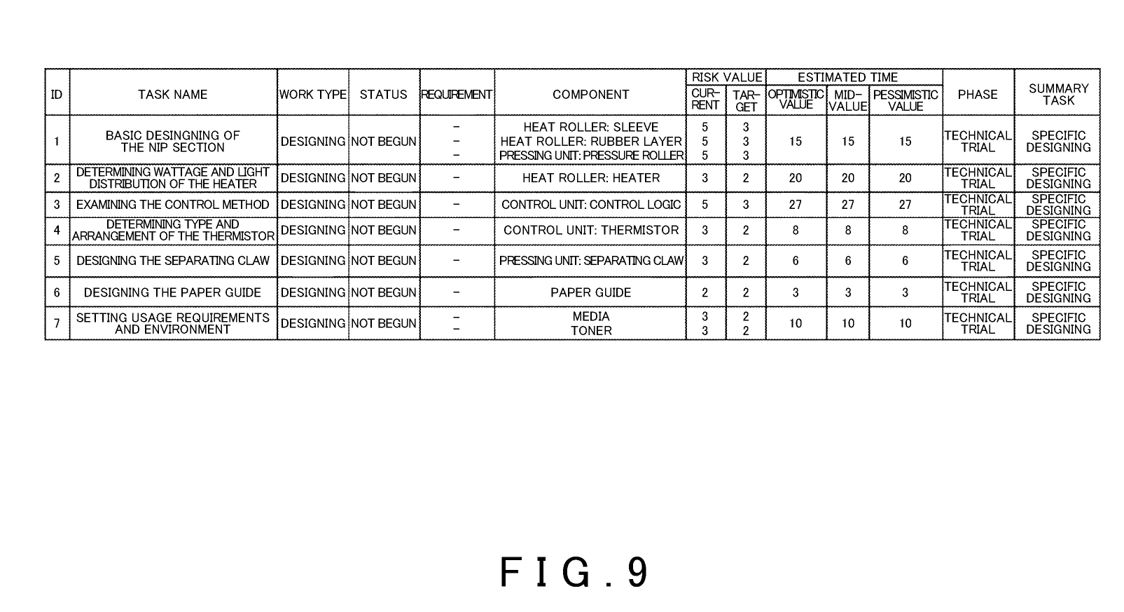

FIG. 9 shows an exemplary specific task list acquired by the specific task list acquiring section 204. FIG. 9 shows the specific task list with focus placed on the “technical trial phase” and the “specific designing task” of the product development project. The specific task list includes the fields of “task name,” “work type,” “status,” “requirement,” “component,” “risk value,” “estimated time,” “phase,” and “summary task.”

The name of the specific task is input to the “task name” field. Names of requirements associated with the specific task are input to the “requirement” field. By inputting a requirement name into the “requirement” field, the input requirement becomes associated with the specific task. In the specific task list, a plurality of requirements can be associated with a single specific task.

Names of components associated with the specific task are input to the “component” field. By inputting a component name into the “component” field, the input component becomes associated with the specific task. In the specific task list, a plurality of components can be associated with a single specific task.

The work type associated with the specific task is input to the “work type” field. For example, the work type associated with the specific task input to the “work type” field may be “designing,” “testing,” or “evaluating.”

The progress of the specific task is input to the “status” field. For example, “in progress,” “not begun,” or “complete” may be input to the “status” field as the progress of a specific task.

Risk values of a requirement or component associated with the specific task are input to the “risk value” field. The “risk value” field includes a “current” field and a “target” field. The risk value at the work start time of a requirement or component is input to the “current” field.

The risk value at the work end time of a requirement or component is input to the “target” field. The risk values input to the “risk value” field are acquired by the status acquiring section 222. The risk values acquired by the status acquiring section 222 are used by the requirement/component dependency relationship information generating section 226 when generating the requirement/component dependency relationship information.

The “current” field is associated with the “status” field. For example, when a specific task is completed, the user inputs “complete” into the “status” field. As a result, the information processing apparatus 100 updates the risk value displayed in the “current” field to be the value displayed in the “target” field. The status acquiring section 222 acquires the updated risk value at a prescribed timing or at the timing at which the risk value in the “risk value” field is updated. The requirement/component dependency relationship information generating section 226 updates the requirement/component dependency relationship information based on the updated risk value.

The number of work days necessary for the specific task is input to the “estimated time” field. The “estimated time” field includes “optimistic value,” “intermediate value,” and “pessimistic value” fields. The same number of days may be entered in each of the “optimistic value,” “intermediate value,” and “pessimistic value” fields. By entering a different number of days into each of the “optimistic value,” “intermediate value,” and “pessimistic value” fields, a range of work days can be set for the specific task.

The name of a phase is input to the “phase” field. The name of a general task that is the higher-level task of the specific task is input to the “summary task” field. By inputting a general task name into the “summary task” field, the general task becomes associated with the specific task. In the specific task list, a plurality of specific tasks can be associated with a single general task.

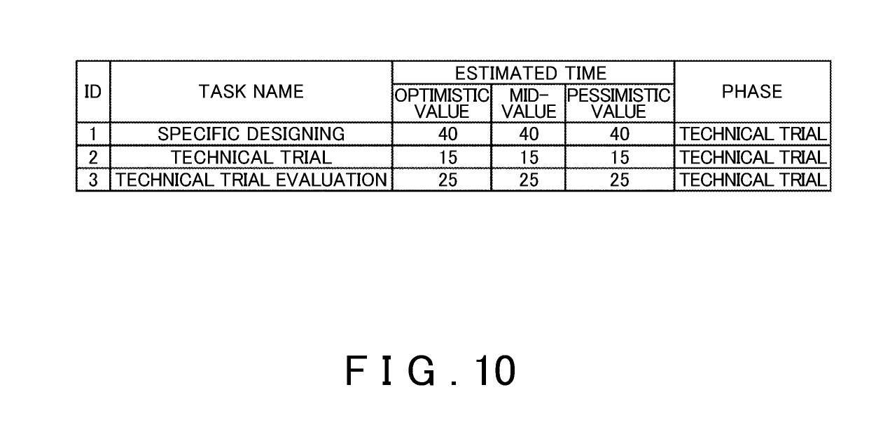

FIG. 10 shows an exemplary general task list acquired by the general task list acquiring section 201. FIG. 10 shows the general task list with focus placed on the “technical trial phase” of the product development project. The general task list includes “task name,” “estimated time,” and “phase” fields.

The name of the general task is input to the “task name” field. The number of work days necessary for the general task is input to the “estimated time” field. The “estimated time” field includes “optimistic value,” “intermediate value,” and “pessimistic value” fields. The same number of days may be entered in each of the “optimistic value,” “intermediate value,” and “pessimistic value” fields. By entering a different number of days into each of the “optimistic value,” “intermediate value,” and “pessimistic value” fields, a range of work days can be set for the general task.

The name of a phase is input to the “phase” field. By inputting a phase name into the “phase” field, the phase becomes associated with the general task.

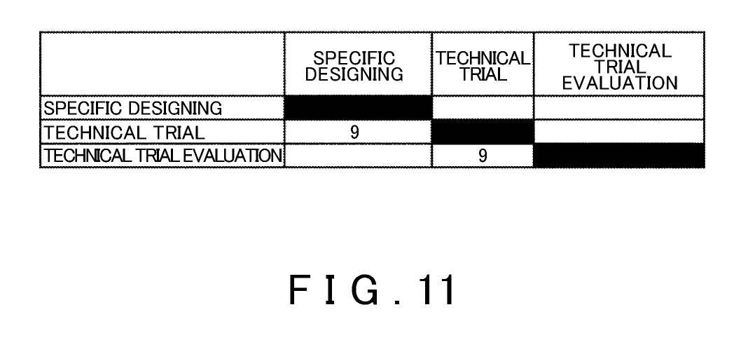

FIG. 11 shows exemplary general task dependency relationship information acquired by the general task dependency relationship information acquiring section 202. FIG. 11 shows the general task dependency relationship information with focus placed on the “technical trial phase” of the product development project. The information processing apparatus 100 can display the general task dependency relationship information in a DSM table. The information processing apparatus 100 may display the general tasks as main items in the rows of the DSM table. The information processing apparatus 100 may display the general tasks as reference items in the columns of the DSM table.

The general task dependency relationship information displays a value of “9” as the degree of dependency in the cell designated by the row of “specific designing” and the column of “technical trial.” This means that the general task “technical trial” has a relatively strong effect on the general task “specific designing.” On the other hand, the general task dependency relationship information does not display a value for the degree of dependency in the cell designated by the row of “technical trial” and the column of “specific designing.” This means that the general task “specific designing” does not exert an effect on the general task “technical trial,” or exerts an effect that is small enough to be ignored.

The general task dependency relationship information indicates the work order of the general tasks. For example, in the general task dependency relationship information shown in FIG. 11, the rows and columns are arranged in the order of “specific designing,” “technical trial,” and “technical trial evaluation.” Therefore, the general task dependency relationship information indicates that these tasks are desirably performed in the order of “specific designing,” “technical trial,” and “technical trial evaluation.”

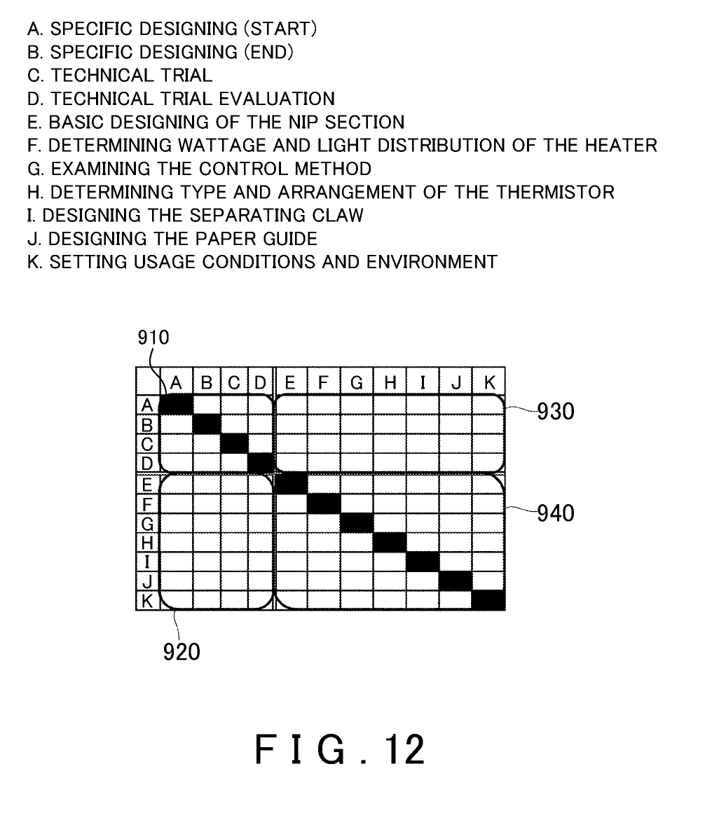

FIG. 12 shows exemplary integrated task dependency relationship information generated by the integrated task dependency relationship information generating section 212. FIG. 12 shows the integrated task dependency relationship information with focus placed on the “technical trial phase” and the “specific designing task” of the product development project. FIG. 12 shows the integrated task dependency relationship information before the degrees of dependency among the tasks are set.

The information processing apparatus 100 can display the integrated task dependency relationship information in a DSM format. The information processing apparatus 100 may display the specific tasks and general tasks as main items in the rows of the DSM table. The information processing apparatus 100 may display the specific tasks and general tasks as reference items in the columns of the DSM table.

The display region 910 displays the dependency relationship among the general tasks. The display regions 920 and 930 display the dependency relationship between the general tasks and the specific tasks. The display region 940 displays the dependency relationship among the specific tasks.

The integrated task dependency relationship information generating section 212 sets the degree of dependency as a value between “1” and “10” indicating the strength of the dependency relationship, in the cell of each task having a dependency relationship with another task. A large value for the degree of dependency indicates a strong dependency relationship.

The integrated task dependency relationship information generating section 212 may divide the general tasks for which schedules are generated at the specific task level into tasks that are begun and tasks that are complete. For example, as shown in FIG. 12, the integrated task dependency relationship information generating section 212 may divide the “specific designing” field, which is a general task having sub-tasks, into “specific designing (start)” and “specific designing (end).” On the other hand, the integrated task dependency relationship information generating section 212 does not divide the “technical trial” and “technical trial evaluation” fields, since these general tasks do not have sub-tasks.

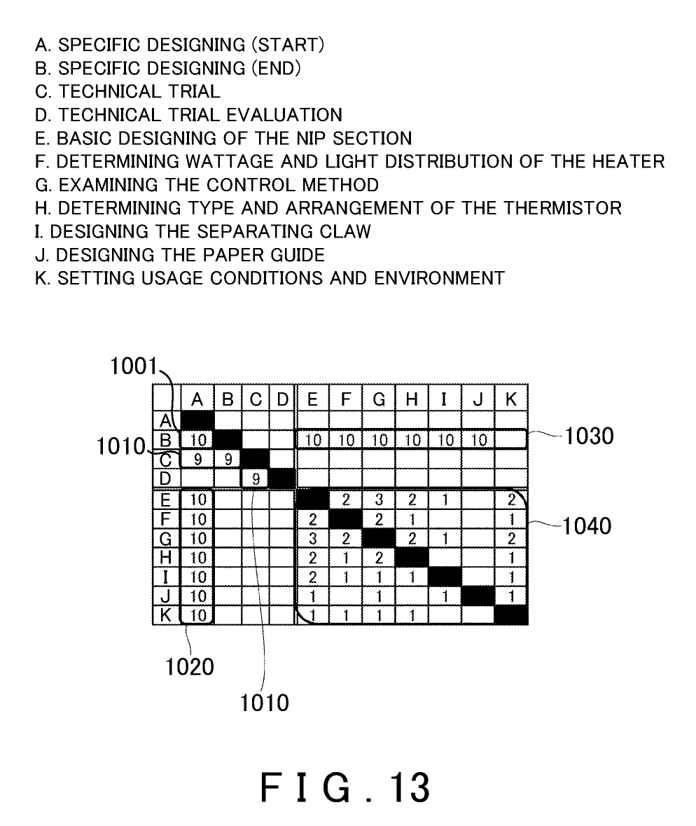

FIG. 13 shows exemplary integrated task dependency relationship information generated by the integrated task dependency relationship information generating section 212. FIG. 13 shows the integrated task dependency relationship information with focus placed on the “technical trial phase” and the “specific designing task” of the product development project. FIG. 13 shows the integrated task dependency relationship information after the degrees of dependency between the tasks are set.

In the integrated task dependency relationship information, an end-task cannot be achieved if a start-task is not begun. Therefore, the integrated task dependency relationship information generating section 212 sets a degree of dependency of “10” in cell 1001.

In the integrated task dependency relationship information, the degrees of dependency among the general tasks may be the same as the degrees of dependency among the general tasks in the general task dependency relationship information. Accordingly, the integrated task dependency relationship information generating section 212 sets a degree of dependency of “9” in each cell in the display region 1010, in the same manner as for the general task dependency relationship information shown in FIG. 11.

In the integrated task dependency relationship information, the specific tasks cannot be begun if a start-task is not begun. Therefore, the integrated task dependency relationship information generating section 212 sets a degree of dependency of “10” in each cell in the display region 1020.

In the integrated task dependency relationship information, an end-task cannot be achieved if the specific tasks are not complete. Therefore, the integrated task dependency relationship information generating section 212 sets a degree of dependency of “10” in each cell in the display region 1030.

The integrated task dependency relationship calculating section 208 calculates the degrees of dependency among the specific tasks in the integrated task dependency relationship information using a calculation method corresponding to a combination of the work types of the specific tasks. For example, by referencing the specific task list shown in FIG. 9, the integrated task dependency relationship calculating section 208 can determine the work type of each specific task indicated by the integrated task dependency relationship information.

The integrated task dependency relationship calculating section 208 calculates the degree of dependency to be set in each cell in the display region 1040 by using a calculation method corresponding to a combination of the work types of the specific tasks. Furthermore, the integrated task dependency relationship information generating section 212 sets the degree of dependency calculated by the integrated task dependency relationship calculating section 208 in each cell in the display region 1040. The following describes an exemplary method for calculating the degrees of dependency for specific tasks according to the combination of work types of the specific tasks, for each combination of specific task work types.

First, an exemplary dependency degree calculation method is described for a case in which the work type of the main specific task is “designing” and the work type of the reference specific task is “designing.” Here, the integrated task dependency relationship calculating section 208 references the specific task list to identify the components associated with the two specific tasks.

Next, the integrated task dependency relationship calculating section 208 extracts from the requirement/component dependency relationship information a degree of dependency A, which indicates the effect of the component associated with the main specific task on the component associated with the reference specific task. The integrated task dependency relationship calculating section 208 then extracts from the requirement/component dependency relationship information a degree of dependency B, which indicates the effect of the component associated with the reference specific task on the component associated with the main specific task. If there are a plurality of combinations of components associated with the main specific task and components associated with the reference specific task, the integrated task dependency relationship calculating section 208 extracts the degree of dependency A and the degree of dependency B for each combination.

Next, the integrated task dependency relationship calculating section 208 calculates the degree of dependency A′ indicating the degree of dependency on the specific task, which is the effect that the component associated with the main specific task exerts on the component associated with the reference specific task, by multiplying the degree of dependency A by the quotient of (i) a reduction amount of the risk value for the specific task of the component associated with the main specific task divided by (ii) a reduction amount of the risk value for the phase of the component associated with the main specific task. Furthermore, the integrated task dependency relationship calculating section 208 calculates the degree of dependency B′ indicating the degree of dependency on the specific task, which is the effect that the component associated with the reference specific task exerts on the component associated with the main specific task, by multiplying the degree of dependency B by the quotient of (i) a reduction amount of the risk value for the specific task of the component associated with the reference specific task divided by (ii) a reduction amount of the risk value for the phase of the component associated with the reference specific task.

The reduction amount of the specific task risk value of the component can be obtained by subtracting the “target” value in the “risk value” field indicated by the specific task list from the “current” value in the “risk value” field indicated by the specific task list. The reduction amount of the phase risk value of the component can be obtained by subtracting the risk value at the work end time acquired by the status acquiring section 222 from the risk value at the work start time acquired by the status acquiring section 222.

If there are a plurality of combinations of components associated with the main specific task and components associated with the reference specific task, the integrated task dependency relationship calculating section 208 calculates the degree of dependency A and the degree of dependency B for each combination. The integrated task dependency relationship calculating section 208 then determines the degree of dependency of the main specific task on the reference specific task to be the maximum value from among the calculated degrees of dependency A′. Furthermore, the integrated task dependency relationship calculating section 208 determines the degree of dependency of the reference specific task on the main specific task to be the maximum value from among the calculated degrees of dependency B′.

The following describes a specific example of the process described above. The following describes an exemplary case in which the main specific task is “basic designing of the NIP section” and the reference specific task is “determining wattage and light distribution of the heater.”

In this case, the integrated task dependency relationship calculating section 208 references the specific task list shown in FIG. 9 and identifies the “heat roller: sleeve,” “heat roller: rubber layer,” and “pressing unit: pressure roller” as the components associated with the main specific task “basic designing of the NIP section.” Furthermore, the integrated task dependency relationship calculating section 208 references the specific task list shown in FIG. 9 and identifies the “heat roller: heater” as the component associated with the reference specific task “determining wattage and light distribution of the heater.”

The integrated task dependency relationship calculating section 208 extracts the value “3,” from the requirement/component dependency relationship information shown in FIG. 8, as the degree of dependency A that the “heat roller: sleeve” has on the “heat roller: heater.” Furthermore, the integrated task dependency relationship calculating section 208 extracts the value “3,” from the requirement/component dependency relationship information shown in FIG. 8, as the degree of dependency A that the “heat roller: rubber layer” has on the “heat roller: heater.” Yet further, the integrated task dependency relationship calculating section 208 extracts the value “3,” from the requirement/component dependency relationship information shown in FIG. 8, as the degree of dependency A that the “pressing unit: pressure roller” has on the “heat roller: heater.”

The integrated task dependency relationship calculating section 208 extracts the value “2,” from the requirement/component dependency relationship information shown in FIG. 8, as the degree of dependency B that the “heat roller: heater” has on the “heat roller: sleeve.” The integrated task dependency relationship calculating section 208 extracts the value “2,” from the requirement/component dependency relationship information shown in FIG. 8, as the degree of dependency B that the “heat roller: heater” has on the “heat roller: rubber layer.” The integrated task dependency relationship calculating section 208 extracts the value “2,” from the requirement/component dependency relationship information shown in FIG. 8, as the degree of dependency B that the “heat roller: heater” has on the “pressing unit: pressure roller.”

For the “heat roller: sleeve,” the integrated task dependency relationship calculating section 208 subtracts a value of “3,” as indicated in the “target” field of the “risk value” field in the specific task list shown in FIG. 9, from a value of “5,” as indicated in the “current” field of the “risk value” field in the specific task list shown in FIG. 9. In this way, the integrated task dependency relationship calculating section 208 calculates the reduction amount of the specific task risk value of the “heat roller: sleeve” to be “2.”

For the “heat roller: sleeve,” the integrated task dependency relationship calculating section 208 subtracts a value of “2,” which is the risk value of the “heat roller: sleeve” shown in the DMM table of FIG. 6, from a value of “5,” which is the risk value of the “heat roller: sleeve” shown in the DMM table of FIG. 5. In this way, the integrated task dependency relationship calculating section 208 calculates the reduction amount of the phase risk value of the “heat roller: sleeve” to be “3.” The integrated task dependency relationship calculating section 208 then calculates the value “2” to be the degree of dependency A′ that the “heat roller: sleeve” has on the “heat roller: heater,” by multiplying the degree of dependency A by the quotient of the calculated reduction amount of the specific task risk value divided by the calculated reduction amount of the phase risk value.

For the “heat roller: heater,” the integrated task dependency relationship calculating section 208 subtracts a value of “2,” as indicated in the “target” field of the “risk value” field in the specific task list shown in FIG. 9, from a value of “3,” as indicated in the “current” field of the “risk value” field in the specific task list shown in FIG. 9. In this way, the integrated task dependency relationship calculating section 208 calculates the reduction amount of the specific task risk value of the “heat roller: heater” to be “1.”

For the “heat roller: heater,” the integrated task dependency relationship calculating section 208 subtracts a value of “2,” which is the risk value of the “heat roller: heater” shown in the DMM table of FIG. 6, from a value of “3,” which is the risk value of the “heat roller: heater” shown in the DMM table of FIG. 5. In this way, the integrated task dependency relationship calculating section 208 calculates the reduction amount of the phase risk value of the “heat roller: heater” to be “1.” The integrated task dependency relationship calculating section 208 then calculates the value “2” to be the degree of dependency B′ that the “heat roller: heater” has on the “heat roller: sleeve,” by multiplying the degree of dependency B by the quotient of the calculated reduction amount of the specific task risk value divided by the calculated reduction amount of the phase risk value.

In the same way, the integrated task dependency relationship calculating section 208 calculates the degree of dependency A′ of the “heat roller: rubber layer” on the “heat roller: heater” to be “2.” Furthermore, the integrated task dependency relationship calculating section 208 calculates the degree of dependency B′ of the “heat roller: heater” on the “heat roller: rubber layer” to be “2.”

In the same way, the integrated task dependency relationship calculating section 208 calculates the specific task degree of dependency A′ of the “pressing unit: pressure roller” on the “heat roller: heater” to be “2.” Furthermore, the integrated task dependency relationship calculating section 208 calculates the specific task degree of dependency B′ of the “heat roller: heater” on the “pressing unit: pressure roller” to be “2.”

As a result of the above process, the integrated task dependency relationship calculating section 208 determines the degree of dependency of the main specific task “basic designing of the NIP section” on the reference specific task “determining wattage and light distribution of the heater” to be the maximum value of “2” from among the calculated degrees of dependency A′. Furthermore, the integrated task dependency relationship calculating section 208 determines the degree of dependency of the reference specific task “determining wattage and light distribution of the heater” on the main specific task “basic designing of the NIP section” to be the maximum value of “2” from among the calculated degrees of dependency B′. In this way, the integrated task dependency relationship calculating section 208 can calculate a more appropriate dependency relationship among the specific tasks by focusing on a partial period of the product development project, instead of the entire period of the product development project.

Next, an exemplary dependency degree calculation method is described for a case in which the work type of the main specific task is “evaluation” and the work type of the reference specific task is “evaluation.” Here, the integrated task dependency relationship calculating section 208 references the specific task list to identify the requirements associated with the two specific tasks.

Next, the integrated task dependency relationship calculating section 208 extracts from the requirement/component dependency relationship information a degree of dependency C, which indicates the effect of the requirement associated with the main specific task on the requirement associated with the reference specific task. The integrated task dependency relationship calculating section 208 then extracts from the requirement/component dependency relationship information a degree of dependency D, which indicates the effect of the requirement associated with the reference specific task on the requirement associated with the main specific task. If there are a plurality of combinations of requirements associated with the main specific task and requirements associated with the reference specific task, the integrated task dependency relationship calculating section 208 extracts the degree of dependency C and the degree of dependency D for each combination.

Next, the integrated task dependency relationship calculating section 208 calculates the degree of dependency C′ indicating the degree of dependency on the specific task, which is the effect that the requirement associated with the main specific task exerts on the requirement associated with the reference specific task, by multiplying the degree of dependency C by the quotient of (i) a reduction amount of the risk value for the specific task of the requirement associated with the main specific task divided by (ii) a reduction amount of the risk value for the phase of the requirement associated with the main specific task. Furthermore, the integrated task dependency relationship calculating section 208 calculates the degree of dependency D′ indicating the degree of dependency on the specific task, which is the effect that the requirement associated with the reference specific task exerts on the requirement associated with the main specific task, by multiplying the degree of dependency D by the quotient of (i) a reduction amount of the risk value for the specific task of the requirement associated with the reference specific task divided by (ii) a reduction amount of the risk value for the phase of the requirement associated with the reference specific task.

The reduction amount of the specific task risk value of the requirement can be obtained by subtracting the “target” value in the “risk value” field indicated by the specific task list from the “current” value in the “risk value” field indicated by the specific task list. The reduction amount of the phase risk value of the requirement can be obtained by subtracting the risk value at the work end time acquired by the status acquiring section 222 from the risk value at the work start time acquired by the status acquiring section 222.

If there are a plurality of combinations of requirements associated with the main specific task and requirements associated with the reference specific task, the integrated task dependency relationship calculating section 208 calculates the degree of dependency C′ and the degree of dependency D′ for each combination. The integrated task dependency relationship calculating section 208 then determines the degree of dependency of the main specific task on the reference specific task to be the maximum value from among the calculated degrees of dependency C′. Furthermore, the integrated task dependency relationship calculating section 208 determines the degree of dependency of the reference specific task on the main specific task to be the maximum value from among the calculated degrees of dependency D′. In this way, the integrated task dependency relationship calculating section 208 can calculate a more appropriate dependency relationship among the specific tasks by focusing on a partial period of the product development project, instead of the entire period of the product development project.

Next, an exemplary dependency degree calculation method is described for a case in which the work type of the main specific task is “designing” or “testing” and the work type of the reference specific task is “testing.” Here, the integrated task dependency relationship calculating section 208 references the specific task list to identify the components associated with the two specific tasks.

Next, the integrated task dependency relationship calculating section 208 judges whether one of the components associated with the main specific task is associated with the reference specific task. If one of the components associated with the main specific task is associated with the reference specific task, the integrated task dependency relationship calculating section 208 determines a value of “9” as the degree of dependency of the main specific task on the reference specific task.

If none of the components associated with the main specific task are associated with the reference specific task, the integrated task dependency relationship calculating section 208 determines that the main specific tasks have no degree of dependency on the reference specific task. If one of the components associated with the main specific task has a “sub” type relationship with a component associated with the reference specific task, i.e. if one of the components associated with the main specific tasks is a sub-component of the component associated with the reference specific task or vice-versa, the integrated task dependency relationship calculating section 208 determines a value of “9” as the degree of dependency of the main specific task on the reference specific task.

Next, an exemplary dependency degree calculation method is described for a case in which the work type of the main specific task is “designing” and the work type of the reference specific task is “evaluation.” Here, the integrated task dependency relationship calculating section 208 references the specific task list to identify the components associated with the main specific task. The integrated task dependency relationship calculating section 208 then references the specific task list to identify the requirements associated with the reference specific task.

Next, the integrated task dependency relationship calculating section 208 extracts from the requirement/component dependency relationship information a degree of dependency E, which indicates the effect of the component associated with the main specific task on the requirement associated with the reference specific task. If there are a plurality of combinations of components associated with the main specific task and requirements associated with the reference specific task, the integrated task dependency relationship calculating section 208 extracts the degree of dependency E for each combination.

Next, the integrated task dependency relationship calculating section 208 calculates the degree of dependency E′ indicating the degree of dependency on the specific task, which is the effect that the component associated with the main specific task exerts on the requirement associated with the reference specific task, by multiplying the degree of dependency E by the quotient of (i) a reduction amount of the risk value for the specific task of the component associated with the main specific task divided by (ii) a reduction amount of the risk value for the phase of the component associated with the main specific task.

The reduction amount of the specific task risk value of the component can be obtained by subtracting the “target” value in the “risk value” field indicated by the specific task list from the “current” value in the “risk value” field indicated by the specific task list. The reduction amount of the phase risk value of the components and requirements can be obtained by subtracting the risk value at the work end time acquired by the status acquiring section 222 from the risk value at the work start time acquired by the status acquiring section 222.

The integrated task dependency relationship calculating section 208 then determines the degree of dependency of the main specific task on the reference specific task to be the calculated degree of dependency E′. If there are a plurality of combinations of components associated with the main specific task and requirements associated with the reference specific task, after calculating the degrees of dependency E′, the integrated task dependency relationship calculating section 208 determines the degree of dependency of the main specific task on the reference specific task to be the maximum value from among the degrees of dependency E′.

Next, an exemplary dependency degree calculation method is described for a case in which the work type of the main specific task is “evaluation” and the work type of the reference specific task is “designing.” Here, the integrated task dependency relationship calculating section 208 references the specific task list to identify the requirements associated with the main specific task. The integrated task dependency relationship calculating section 208 then references the specific task list to identify the components associated with the reference specific task.

Next, the integrated task dependency relationship calculating section 208 extracts from the requirement/component dependency relationship information a degree of dependency F, which indicates the effect of the requirement associated with the main specific task on the component associated with the reference specific task. If there are a plurality of combinations of requirements associated with the main specific task and components associated with the reference specific task, the integrated task dependency relationship calculating section 208 extracts the degree of dependency F for each combination.

Next, the integrated task dependency relationship calculating section 208 calculates the degree of dependency F indicating the degree of dependency on the specific task, which is the effect that the requirement associated with the main specific task exerts on the component associated with the reference specific task, by multiplying the degree of dependency F by the quotient of (i) a reduction amount of the risk value for the specific task of the requirement associated with the main specific task divided by (ii) a reduction amount of the risk value for the phase of the requirement associated with the main specific task.

The reduction amount of the specific task risk value of the requirement can be obtained by subtracting the “target” value in the “risk value” field indicated by the specific task list from the “current” value in the “risk value” field indicated by the specific task list. The reduction amount of the phase risk value of the components and requirements can be obtained by subtracting the risk value at the work end time acquired by the status acquiring section 222 from the risk value at the work start time acquired by the status acquiring section 222.

The integrated task dependency relationship calculating section 208 then determines the degree of dependency of the main specific task on the reference specific task to be the calculated degree of dependency F′. If there are a plurality of combinations of requirements associated with the main specific task and components associated with the reference specific task, after calculating the degrees of dependency F, the integrated task dependency relationship calculating section 208 determines the degree of dependency of the main specific task on the reference specific task to be the maximum value from among the degrees of dependency F′.

Next, an exemplary dependency degree calculation method is described for a case in which the work type of the main specific task is “testing” and the work type of the reference specific task is “evaluation.” First, the integrated task dependency relationship calculating section 208 acquires the name of the test object that is realized by the main specific task. The name of the test object realized by the main specific task may be stored in advance in the specific task list or the like. Therefore, the integrated task dependency relationship calculating section 208 can reference the specific task list or the like to acquire the name of the test object realized by the main specific task.

Next, the integrated task dependency relationship calculating section 208 acquires the name of a work tool that is used in the reference specific task. For example, the name of the work tool used in the reference specific task may be stored in advance in the specific task list or the like. Therefore, the integrated task dependency relationship calculating section 208 can reference the specific task list or the like to acquire the name of the work tool used in the reference specific task.

Next, the integrated task dependency relationship calculating section 208 judges whether the name of the work tool acquired for the reference specific task includes the name of the test object acquired for the main specific task. If the name of the acquired work tool includes the name of the acquired test object, the integrated task dependency relationship calculating section 208 determines a value of “9” as the degree of dependency of the main specific task on the reference specific task. On the other hand, if the name of the acquired work tool does not include the name of the acquired test object, the integrated task dependency relationship calculating section 208 determines that there is no degree of dependency between these specific tasks.

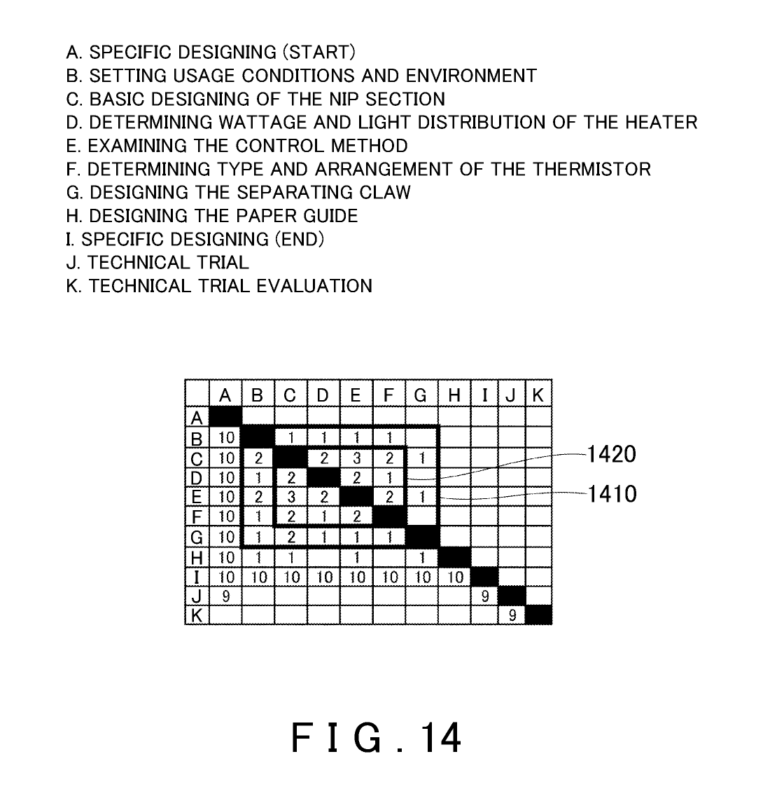

FIG. 14 shows exemplary integrated task dependency relationship information indicating the work order of a plurality of specific tasks. The integrated task dependency relationship information shown in FIG. 14 differs from the integrated task dependency relationship information shown in FIG. 13 in that the rows and columns are lined up according to the work order of the integrated tasks calculated by the integrated task work order calculating section 210.

The integrated task work order calculating section 210 determines the work order of the specific tasks based on the degrees of dependency indicated by the integrated task dependency relationship information. Specifically, by performing a partition analysis on the integrated task dependency relationship information, the integrated task work order calculating section 210 can rearrange the rows and columns of the integrated task dependency relationship information such that specific tasks having a strong dependency relationship are arranged together in the integrated task dependency relationship information. In this case, the integrated task work order calculating section 210 may determine the work order of the specific tasks by performing, on the integrated task dependency relationship information, the partition analysis disclosed in Japanese Patent Application Publication No. 2007-109073.

Specifically, the integrated task work order calculating section 210 generates a loop chain of the integrated task dependency information by performing a partition analysis on the integrated task dependency relationship information. Here, the “loop chain” refers to a grouping of dependency relationships that have a fixable relationship. For example, in the integrated task dependency relationship information shown in FIG. 14, the loop chain 1410 has a loop level of “1.” Furthermore, the loop chain 1420 has a loop level of “2.”

A large value for the loop level indicates a strong loop chain. For example, in the integrated task dependency relationship information shown in FIG. 14, “basic designing of the NIP section,” “determining wattage and light distribution of the heater,” “examining the control method,” and “determining type and arrangement of the thermistor” have a loop chain level of “2.” In this case, the integrated task work order calculating section 210 may generate the loop chains of the integrated task dependency relationships by performing, on the integrated task dependency relationship information, the partition analysis disclosed in Japanese Patent Application Publication No. 2007-109073.

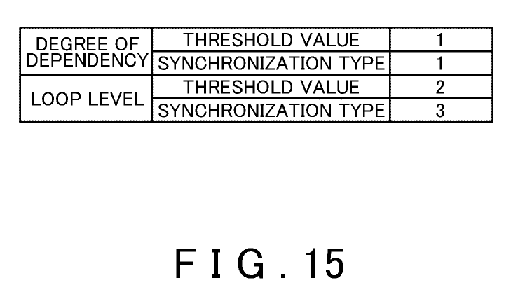

FIG. 15 shows an exemplary overlap policy acquired by the overlap policy acquiring section 214. The overlap policy shown in FIG. 15 includes “degree of dependency” and “loop level” fields. The “degree of dependency” and “loop level” fields each include a “threshold value” field and a “synchronization type” field.

The user may set, in the “threshold value” field within the “degree of dependency” field, a threshold value for determining tasks to be synchronized. In the present embodiment, the user sets a value from “1” to “10” in the “threshold value” field within the “degree of dependency” field. For example, when the user sets a value of “1” in the “threshold value” field within the “degree of dependency” field, the integrated schedule generating section 216 determines the tasks to be synchronized as being the tasks that have degrees of dependency greater than or equal to “1” in the lower-left half of the integrated task dependency relationship information shown in FIG. 14.

Furthermore, the user sets, in the “synchronization type” field within the “degree of dependency” field, a set value indicating how the determined tasks to be synchronized are to be arranged. In the present embodiment, the user sets a value from “1” to “3” in the “synchronization type” field within the “degree of dependency” field.

The user sets, in the “threshold value” field within the “loop level” field, a threshold value for determining tasks to be performed concurrently. In the present embodiment, the user sets a value from “1” to “10” in the “threshold value” field within the “loop level” field. For example, when the user sets a value of “2” in the “threshold value” field within the “loop level” field, the integrated schedule generating section 216 determines the tasks to be performed concurrently to be the tasks that have degrees of dependency within a loop level greater than or equal to “2” in the integrated task dependency relationship information.

Furthermore, the user sets, in the “synchronization type” field within the “loop level” field, a set value indicating how the determined tasks to be performed concurrently are to be arranged. In the present embodiment, the user sets a value from “2” to “3” in the “synchronization type” field within the “loop level” field.

The tasks determined to be synchronized according to the set value in the “degree of dependency” field may also be determined as the tasks to be performed concurrently according to the set value in the “loop level” field. For tasks such as these, the set value in the “loop level” field is given priority.

The integrated schedule generating section 216 generates the integrated schedule such the tasks determined to be in synchronized are synchronized with each other. In this case, for tasks whose synchronization type is “1,” the integrated schedule generating section 216 generates the schedule in which the tasks are synchronized with each other such that a following task is begun as soon as a preceding task is completed. For tasks whose synchronization type is “2,” the integrated schedule generating section 216 generates the schedule in which the tasks are synchronized with each other such that a preceding task and a following task are completed at the same time. For tasks whose synchronization type is “3,” the integrated schedule generating section 216 generates the schedule in which the tasks are synchronized with each other such that a preceding task and a following task are begun at the same time.

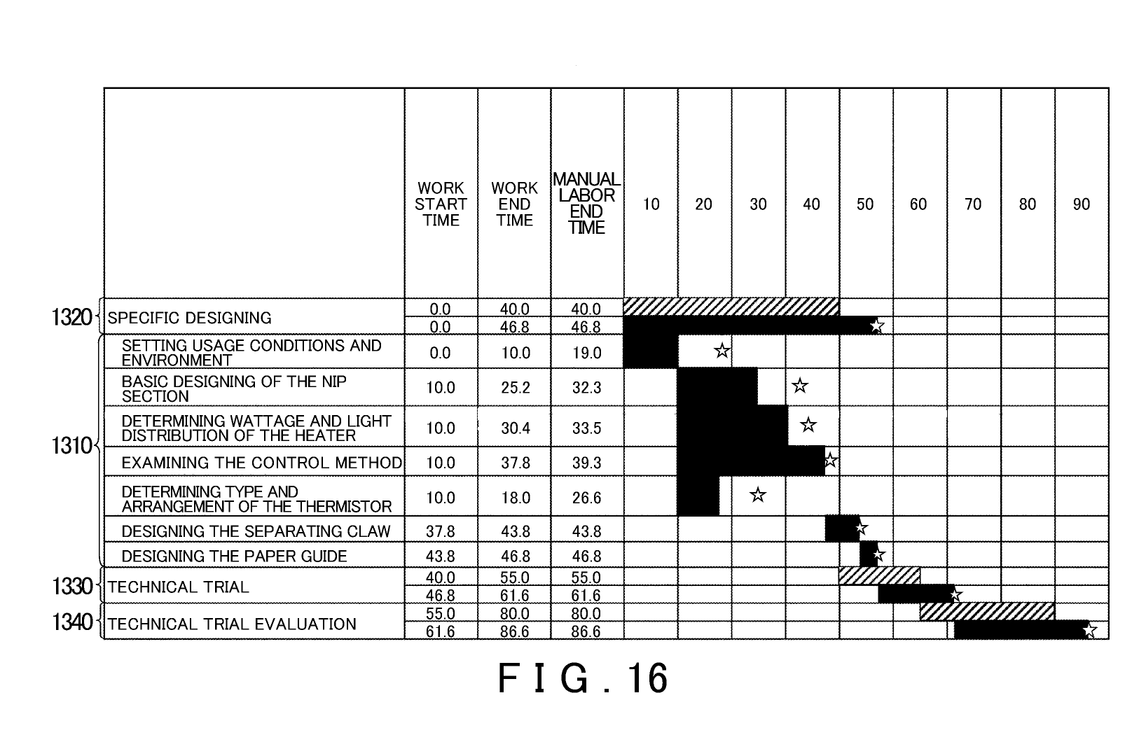

FIG. 16 shows an exemplary schedule output by the output section 217. The schedule 1310 shows a specific task schedule with focus placed on the “technical trial phase” and the “specific designing task” of the product development project. The schedules 1320, 1330, and 1340 show general schedules with focus placed on the “technical trial phase” of the product development project.

The task bars with a diagonal-line pattern indicate binding schedules generated by the general schedule generating section 215. The task bars with a solid pattern indicate loose schedules generated by the integrated schedule generating section 216. The stars indicate estimated completion dates that incorporate manual labor.

The integrated schedule generating section 216 may determine the work time for each of the specific tasks based on the estimated number of days for each of the specific tasks indicated by the specific task list. For example, in the schedule of FIG. 16, the work time for each of the specific tasks is determined based on the estimated number of days for each of the specific tasks indicated by the specific task list of FIG. 9.

The integrated schedule generating section 216 may determine the work order for each of the specific tasks based on the work order for each of the specific tasks indicated by the integrated task dependency relationship information. For example, in the schedule of FIG. 16, the work order for each of the specific tasks is determined based on the work order for each of the specific tasks indicated by the integrated task dependency relationship information of FIG. 14.

The general schedule generating section 215 may determine the work time for each of the general tasks based on the estimated number of days for each of the general tasks indicated by the general task list. For example, in the schedule of FIG. 16, the work time for each of the general tasks is determined based on the estimated number of days for each of the general tasks indicated by the general task list of FIG. 10.

The general schedule generating section 215 may determine the work order for each of the general tasks based on the work order for each of the general tasks indicated by the general task dependency relationship information. For example, in the schedule of FIG. 16, the work order for each of the general tasks is determined based on the work order for each of the general tasks indicated by the general task dependency relationship information of FIG. 11.

The integrated schedule generating section 216 may generate the integrated schedule such that work dates for a plurality of specific tasks are in synchronization with each other, based on the overlap policy. For example, in the schedule shown in FIG. 16, the timing for beginning work for “basic designing of the NIP section,” “determining wattage and light distribution of the heater,” “examining the control method,” and “determining type and arrangement of the thermistor” are synchronized based on the overlap policy shown in FIG. 15.

For example, as described in FIG. 14, “basic designing of the NIP section,” “determining wattage and light distribution of the heater,” “examining the control method,” and “determining type and arrangement of the thermistor” have a loop chain level of “2.” Furthermore, in the overlap policy shown in FIG. 15, a value of “3” is set as the synchronization type for the loop level value “2.” Accordingly, for “basic designing of the NIP section,” “determining wattage and light distribution of the heater,” “examining the control method,” and “determining type and arrangement of the thermistor,” the integrated schedule generating section 216 generates the schedule in which the specific tasks are synchronized with each other such that a preceding specific task and a following specific task are begun at the same time.

In this way, the information processing apparatus 100 of the present embodiment can generate the integrated schedule with focus placed on a portion of the phases or a portion of the general tasks in the product development project, by using a combination of management data from several layers. As a result, the information processing apparatus 100 can generate an integrated schedule that is more appropriate than an integrated schedule generated for the entire product development project.

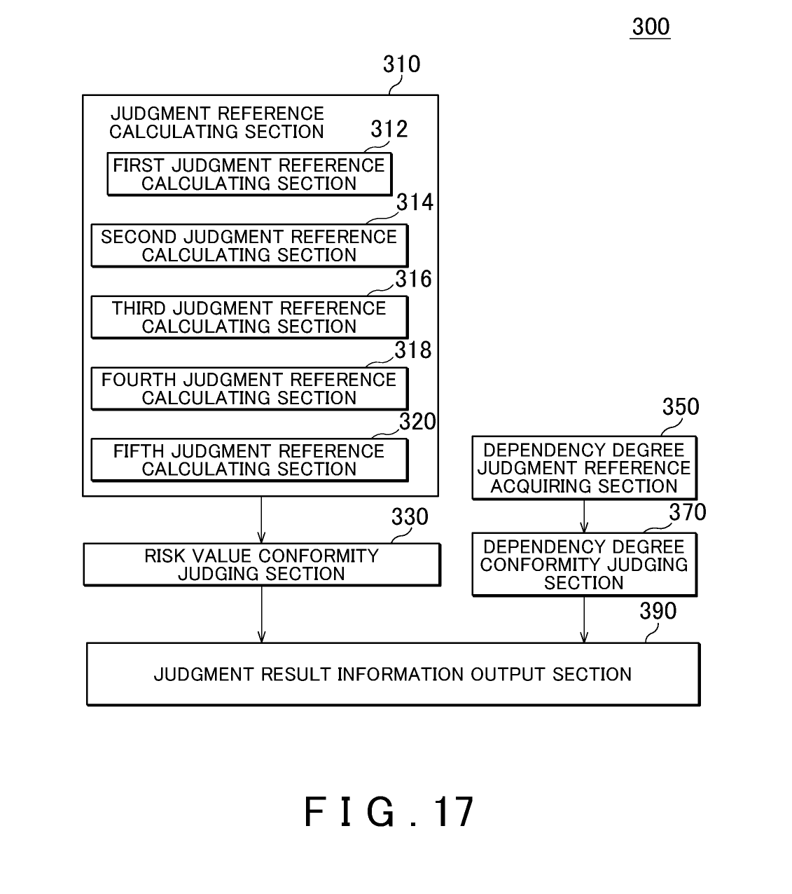

FIG. 17 shows an exemplary function configuration of the data check unit 300. The data check unit 300 checks whether overlap and low-order risk values conform with each other, according to a rule that “a low-order requirement or component having a dependency relationship with a certain high-order requirement or component has a risk value greater than or equal to the risk value of the certain high-order requirement or component.” Furthermore, the data check unit 300 checks whether high-order and low-order risk values conform with each other, according to a rule that “the risk value of a certain low-order requirement or component is no greater than a maximum value of intermediate values each obtained as a product of (i) the risk value of one of the high-order requirements or components having a dependency relationship with the certain low-order requirement or component and (ii) a quotient of the degree of dependency therebetween divided by “9.” Note that a specification risk of a requirement is of a higher order than a component risk, and a component risk is of a higher order than a verification risk of a requirement. Furthermore, among specification risks of requirements, the specification risk of a sub-requirement is of a lower order than the specification risk of the parent requirement thereof. Among verification risks of requirements, verification risk of a sub-requirement is of a higher order than the verification risk of the parent requirement thereof. Breakdown risk is one type of specification risk, and in a process for judging conformity of the risk values and a process for updating the risk values, the breakdown risk is processed in alignment with specification risks that are not related to high-order specification risk.

The data check unit 300 includes a judgment reference value calculating section 310, a risk value conformity judging section 330, a dependency degree judgment reference value acquiring section 350, a dependency degree conformity judging section 370, and a judgment result information output section 390. The judgment reference value calculating section 310 includes a first judgment reference value calculating section 312, a second judgment reference value calculating section 314, a third judgment reference value calculating section 316, a fourth judgment reference value calculating section 318, and a fifth judgment reference value calculating section 320.

The first judgment reference value calculating section 312 calculates a first judgment reference value, which serves as a judgment reference for whether the risk value of a parent requirement conforms with the risk value of a sub-requirement, based on the risk value of the sub-requirement whose parent requirement is acquired by the status acquiring section 222 and on the degree of dependency between the sub-requirement and the parent requirement obtained by the dependency degree acquiring section 224. For example, when the parent requirement is a specification requirement, after acquiring the specification risk value for each sub-requirement, the first judgment reference value calculating section 312 may set the maximum value from among the acquired specification risk values to be the first judgment reference value. When the parent requirement is a verification requirement, after calculating the intermediate value for each sub-requirement as a product of (i) the verification risk value and (ii) a quotient of the degree of dependency on the parent requirement divided by “9,” the first judgment reference value calculating section 312 may set the maximum value from among the calculated intermediate values and innate verification risk values to be the first judgment reference value.

The second judgment reference value calculating section 314 calculates a second judgment reference value, which serves as a judgment reference for whether the risk value of a sub-requirement conforms with the risk value of a parent requirement, based on the risk value of the parent requirement containing the sub-requirement acquired by the status acquiring section 222 and on the degree of dependency between the parent requirement and the sub-requirement obtained by the dependency degree acquiring section 224. When the parent requirement is a specification requirement, after calculating the intermediate value for each parent requirement as a product of (i) the specification risk value and (ii) a quotient of the degree of dependency on the sub-requirement divided by “9,” the second judgment reference value calculating section 314 may set the maximum value from among the calculated intermediate values and innate verification risk values to be the second judgment reference value. When the parent requirement is a verification requirement, after acquiring the verification risk value for each parent requirement, the second judgment reference value calculating section 314 may set the maximum value from among the acquired verification risk values to be the second judgment reference value.

The third judgment reference value calculating section 316 calculates a third judgment reference value, which serves as a judgment reference for whether the risk value of a parent component conforms with the risk value of a sub-component, based on the risk value of the sub-component whose parent component is acquired by the status acquiring section 222 and on an innate risk value of the parent component obtained by the status acquiring section 222. For example, the third judgment reference value calculating section 316 may set the maximum value from among the risk values of the sub-components and the innate risk value of the parent component to be the third judgment reference value.

The fourth judgment reference value calculating section 318 calculates a fourth judgment reference value, which serves as a judgment reference for whether the risk value of a parent requirement conforms with the risk value of a sub-component, based on the risk value of the sub-subcomponent whose parent requirement is acquired by the status acquiring section 222 and on the degree of dependency between the sub-component and the parent requirement obtained by the dependency degree acquiring section 224. For example, when the parent requirement is a specification requirement, after acquiring the risk value for each sub-component, the fourth judgment reference value calculating section 318 may set the maximum value from among the acquired risk values to be the fourth judgment reference value. When the parent requirement is a verification requirement, after calculating the intermediate value for each sub-component as a product of (i) the risk value and (ii) a quotient of the degree of dependency on the parent requirement divided by “9,” the fourth judgment reference value calculating section 318 may set the maximum value from among the calculated intermediate values to be the fourth judgment reference value.

The fifth judgment reference value calculating section 320 calculates a fifth judgment reference value, which serves as a judgment reference for whether the risk value of a sub-component conforms with the risk value of a parent requirement, based on the risk value of the parent requirement containing the sub-component acquired by the status acquiring section 222 and on the degree of dependency between the parent requirement and the sub-component obtained by the dependency degree acquiring section 224. For example, when the parent requirement is a specification requirement, after calculating the intermediate value for each parent requirement as a product of (i) the specification risk value and (ii) a quotient of the degree of dependency on the sub-component divided by “9,” the fifth judgment reference value calculating section 320 may set the maximum value from among the calculated intermediate values to be the fifth judgment reference value. When the parent requirement is a verification requirement, after acquiring the verification risk value for each parent requirement, the fifth judgment reference value calculating section 320 may set the maximum value from among the acquired verification risk values to be the fifth judgment reference value.

The risk value conformity judging section 330 may judge whether the risk values that are used when generating the requirement/component dependency relationship information conform with each other, based on the risk values acquired by the status acquiring section 222 and the degree of dependency acquired by the dependency degree acquiring section 224. For example, the risk value conformity judging section 330 may judge whether the risk value of the parent requirement conforms with the risk value of the sub-requirement by comparing the first judgment reference value calculated by the first judgment reference value calculating section 312 with the risk value of the parent requirement. The risk value conformity judging section 330 may judge that the risk value of the parent requirement conforms with the risk value of the sub-requirement when the first judgment reference value is greater than or equal to the risk value of the parent requirement.

The risk value conformity judging section 330 may judge whether the risk value of the sub-requirement conforms with the risk value of the parent requirement by comparing the second judgment reference value calculated by the second judgment reference value calculating section 314 with the risk value of the sub-requirement. The risk value conformity judging section 330 may judge that the risk value of the sub-requirement conforms with the risk value of the parent requirement when the second judgment reference value is greater than or equal to the risk value of the sub-requirement.

The risk value conformity judging section 330 may judge whether the risk value of the parent component conforms with the risk value of the sub-component by comparing the third judgment reference value calculated by the third judgment reference value calculating section 316 with the risk value of the parent component. The risk value conformity judging section 330 may judge that the risk value of the parent component conforms with the risk value of the sub-component when the third judgment reference value is greater than or equal to the risk value of the parent component.

The risk value conformity judging section 330 may judge whether the risk value of the parent requirement conforms with the risk value of the sub-component by comparing the fourth judgment reference value calculated by the fourth judgment reference value calculating section 318 with the risk value of the parent requirement. The risk value conformity judging section 330 may judge that the risk value of the parent requirement conforms with the risk value of the sub-component when the fourth judgment reference value is greater than or equal to the risk value of the parent requirement.

The risk value conformity judging section 330 may judge whether the risk value of the sub-requirement conforms with the risk value of the parent requirement by comparing the fifth judgment reference value calculated by the fifth judgment reference value calculating section 320 with the risk value of the sub-component. The risk value conformity judging section 330 may judge that the risk value of the sub-component conforms with the risk value of the parent requirement when the fifth judgment reference value is greater than or equal to the risk value of the sub-component.

The dependency degree judgment reference value acquiring section 350 acquires a dependency degree judgment reference value that serves as a judgment reference for whether the degrees of dependency used when the generating the requirement/component dependency relationship information conform with each other. The dependency degree judgment reference value acquiring section 350 may acquire dependency degree judgment reference values within a certain range.

The dependency degree conformity judging section 370 may judge whether the degrees of dependency that are used when generating the requirement/component dependency relationship information conform with each other, based on the degrees of dependency used hen generating the requirement/component dependency relationship information and on the dependency degree judgment reference values acquired by the dependency degree judgment reference value acquiring section 350. For example, when the degree of dependency of a parent requirement on one of a plurality of sub-requirements matches a dependency degree judgment reference value, the dependency degree conformity judging section 370 may judge that the degrees of dependency of the parent requirement and these sub-requirements conform with each other. For example, when the degree of dependency of a sub-requirement on one of a plurality of parent requirements matches a dependency degree judgment reference value, the dependency degree conformity judging section 370 may judge that the degrees of dependency of the sub-requirement and these parent requirements conform with each other.

For example, when the degree of dependency of a parent requirement on one of a plurality of sub-components matches a dependency degree judgment reference value, the dependency degree conformity judging section 370 may judge that the degrees of dependency of the parent requirement and these sub-components conform with each other. When the degree of dependency of a sub-component on one of a plurality of parent requirements matches a dependency degree judgment reference value, the dependency degree conformity judging section 370 may judge that the degrees of dependency of the sub-component and these parent requirements conform with each other.

The judgment result information output section 390 outputs the results of the judgment process performed by the risk value conformity judging section 330. Specifically, the judgment result information output section 390 outputs the item name, the current risk value, a recommended value for the risk value, and the like for each requirement or component that is judged to have a non-conforming risk value. The judgment result information output section 390 may output the recommended value for the risk value as a range of values. The judgment result information output section 390 may output requirement/component dependency relationship information in which risk values that are errors are displayed in an emphasized manner. The judgment result information output section 390 may output requirement/component dependency relationship information in which requirements and components for which are set risk values that are errors are displayed in an emphasized manner.

The judgment result information output section 390 outputs the results of the judgment process performed by the dependency degree conformity judging section 370. Specifically, the judgment result information output section 390 outputs the item name, the current degree of dependency, a recommended value for the degree of dependency, and the like for each requirement or component that is judged to have a non-conforming degree of dependency. The judgment result information output section 390 may output the recommended value for the degree of dependency as a range of values. The judgment result information output section 390 may output requirement/component dependency relationship information in which degrees of dependency that are errors are displayed in an emphasized manner. The judgment result information output section 390 may output requirement/component dependency relationship information in which requirements and components for which are set degrees of dependency that are errors are displayed in an emphasized manner.

The judgment result information output section 390 may display the judgment process results on the screen of the computer. The judgment result information output section 390 may store the judgment process results in a recording medium such as memory or a hard disk provided to the computer.

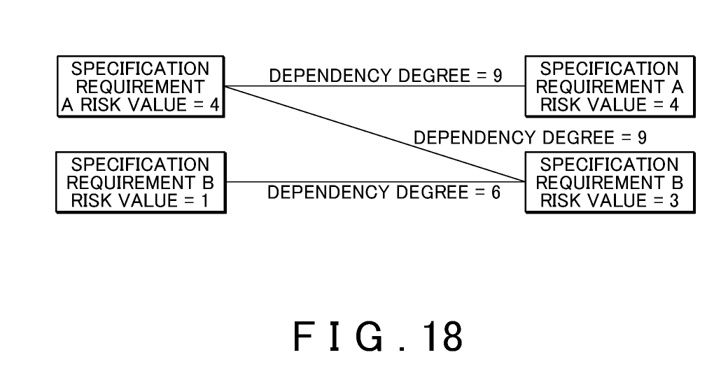

FIG. 18 shows an exemplary process performed by the data check unit 300. FIG. 18 is used to describe an example of checking the conformity of risk values among specification requirement A and specification requirement B, which are parent requirements, and specification requirement “a” and specification requirement “b,” which are sub-requirements.

The first judgment reference value calculating section 312 acquires the risk values for specification requirement “a” and specification requirement “b.” For example, the first judgment reference value calculating section 312 acquires a risk value of “4” for specification requirement “a.” Furthermore, the first judgment reference value calculating section 312 acquires a risk value of “3” for specification requirement “b.”

The first judgment reference value calculating section 312 determines the first judgment reference value to be “4,” which is the maximum value from among the acquired risk values. Since the first judgment reference value of “4” is greater than or equal to the risk value of “4” of specification requirement A, the risk value conformity judging section 330 determines that the risk value of specification requirement A conforms with the risk values of specification requirement “a” and specification requirement “b.”

The second judgment reference value calculating section 314 calculates the intermediate value for each of specification requirement A and specification requirement B by multiplying the risk value thereof by the quotient of the degree of dependency on specification requirement “b” divided by “9.” As a result, the second judgment reference value calculating section 314 acquires an intermediate value of “4” for specification requirement A. Furthermore, the second judgment reference value calculating section 314 acquires an intermediate value of “0.67” for specification requirement B.

The second judgment reference value calculating section 314 determines the second judgment reference value to be “4,” which is the maximum value from among the calculated intermediate values. Since the second judgment reference value of “4” is greater than or equal to the risk value of “3” of specification requirement “b,” the risk value conformity judging section 330 determines that the risk value of specification requirement “b” conforms with the risk values of specification requirement A and specification requirement B.

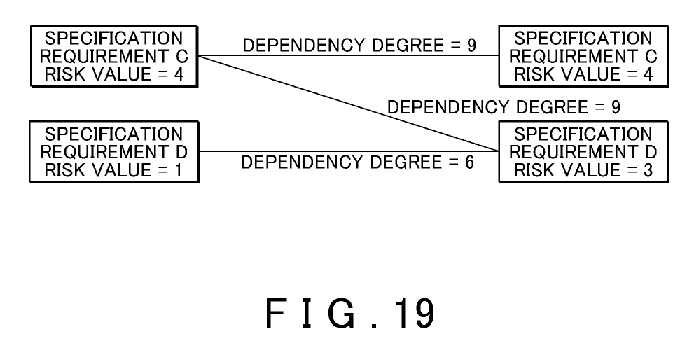

FIG. 19 shows another exemplary process performed by the data check unit 300. FIG. 19 is used to describe an example of checking the conformity of risk values among verification requirement C and verification requirement D, which are parent requirements, and specification requirement “c” and specification requirement “d,” which are sub-requirements.

The first judgment reference value calculating section 312 calculates the intermediate value for each of verification requirement “c” and verification requirement “d” by multiplying the risk value thereof by the quotient of the degree of dependency on verification requirement C divided by “9.” As a result, the first judgment reference value calculating section 312 calculates an intermediate value of “4” for verification requirement “c.” Furthermore, the first judgment reference value calculating section 312 calculates an intermediate value of “3” for verification requirement “d.”

The first judgment reference value calculating section 312 determines the first judgment reference value to be “4,” which is the maximum value from among the calculated intermediate values. Since the first judgment reference value of “4” is greater than or equal to the risk value of “4” of verification requirement C, the risk value conformity judging section 330 determines that the risk value of verification requirement C conforms with the risk values of verification requirement “c” and verification requirement “d.”

The second judgment reference value calculating section 314 calculates the intermediate value for each of verification requirement C and verification requirement D by multiplying the risk value thereof by the quotient of the degree of dependency on verification requirement “d” divided by “9.” As a result, the second judgment reference value calculating section 314 calculates an intermediate value of “4” for verification requirement C. Furthermore, the second judgment reference value calculating section 314 calculates an intermediate value of “1.49” for verification requirement D.

The second judgment reference value calculating section 314 determines the second judgment reference value to be “4,” which is the maximum value from among the calculated intermediate values. Since the first judgment reference value of “4” is greater than or equal to the risk value of “3” of verification requirement “d,” the risk value conformity judging section 330 determines that the risk value of verification requirement “d” conforms with the risk values of verification requirement C and verification requirement D.

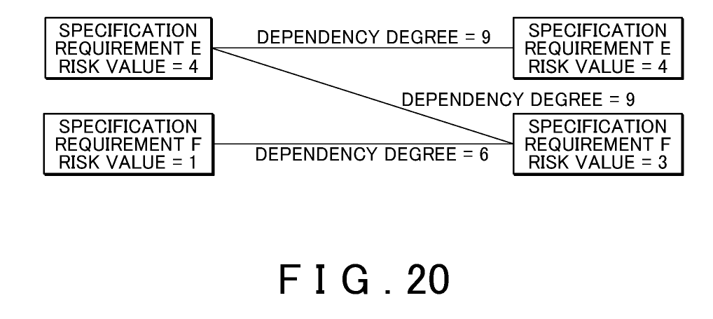

FIG. 20 shows another exemplary process performed by the data check unit 300. FIG. 20 is used to describe an example of checking the conformity of risk values among specification requirement E and specification requirement F, which are parent requirements, and component “e” and component “f,” which are sub-components.

The fourth judgment reference value calculating section 318 acquires the risk values for component “e” and component “f.” For example, the fourth judgment reference value calculating section 318 acquires a risk value of “4” for component “e.” Furthermore, the fourth judgment reference value calculating section 318 acquires a risk value of “3” for component “f.”

The fourth judgment reference value calculating section 318 determines the fourth judgment reference value to be “4,” which is the maximum value from among the acquired risk values. Since the fourth judgment reference value of “4” is greater than or equal to the risk value of “4” of specification requirement E, the risk value conformity judging section 330 determines that the risk value of specification requirement E conforms with the risk values of component “e” and component “f.”

The fifth judgment reference value calculating section 320 calculates the intermediate value for each of specification requirement E and specification requirement F by multiplying the risk value thereof by the quotient of the degree of dependency on component “f” divided by “9.” As a result, the fifth judgment reference value calculating section 320 calculates an intermediate value of “4” for specification requirement E. Furthermore, the fifth judgment reference value calculating section 320 acquires an intermediate value of “0.67” for specification requirement F.

The fifth judgment reference value calculating section 320 determines the fifth judgment reference value to be “4,” which is the maximum value from among the calculated intermediate values. Since the fifth judgment reference value of “4” is greater than or equal to the risk value of “3” of component “f,” the risk value conformity judging section 330 determines that the risk value of component “f” conforms with the risk values of specification requirement E and specification requirement F.

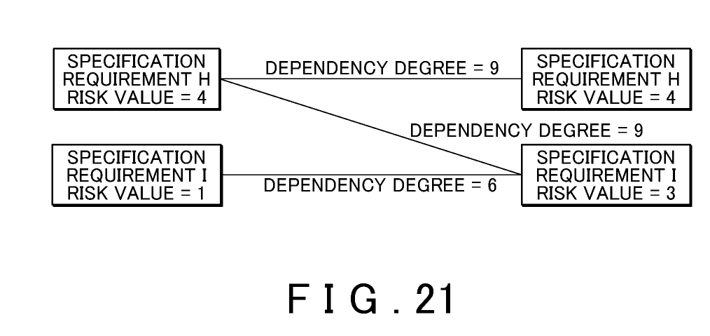

FIG. 21 shows another exemplary process performed by the data check unit 300. FIG. 21 is used to describe an example of checking the conformity of risk values among verification requirement G and verification requirement H, which are parent requirements, and component “e” and component “f,” which are sub-components.

The fourth judgment reference value calculating section 318 calculates the intermediate value for each of component “g” and component “h” by multiplying the risk value thereof by the quotient of the degree of dependency on verification requirement G divided by “9.” As a result, the fourth judgment reference value calculating section 318 calculates an intermediate value of “4” for component “g.” Furthermore, the fourth judgment reference value calculating section 318 calculates an intermediate value of “3” for component “h.”

The fourth judgment reference value calculating section 318 determines the fourth judgment reference value to be “4,” which is the maximum value from among the calculated intermediate values. Since the fourth judgment reference value of “4” is greater than or equal to the risk value of “4” of verification requirement G, the risk value conformity judging section 330 determines that the risk value of verification requirement G conforms with the risk values of component “g” and component “h.”

The fifth judgment reference value calculating section 320 acquires the risk values for verification requirement G and verification requirement H. For example, the fifth judgment reference value calculating section 320 acquires a risk value of “4” for verification requirement G. Furthermore, the fifth judgment reference value calculating section 320 acquires a risk value of “1” for verification requirement H.

The fifth judgment reference value calculating section 320 determines the fifth judgment reference value to be “4,” which is the maximum value from among the acquired risk values. Since the fifth judgment reference value of “4” is greater than or equal to the risk value of “3” of component “h,” the risk value conformity judging section 330 determines that the risk value of component “h” conforms with the risk values of verification requirement G and verification requirement H.

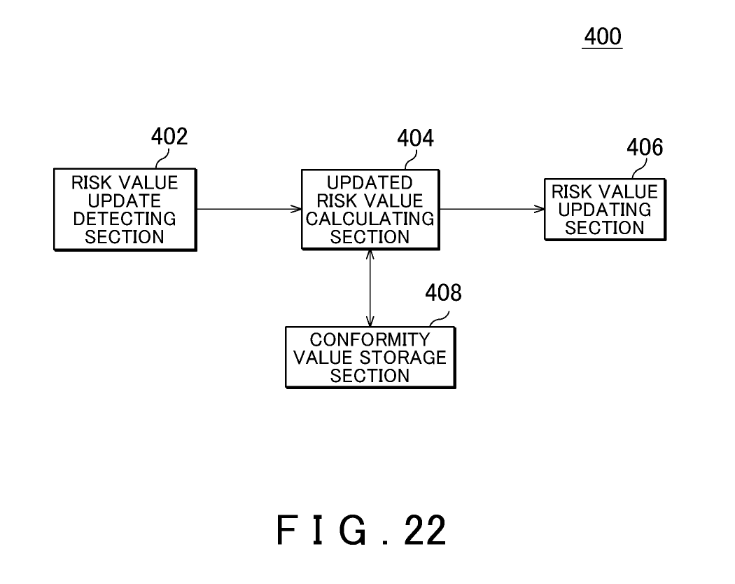

FIG. 22 shows an exemplary function configuration of the data conforming unit 400. The data conforming unit 400 includes a risk value update detecting section 402, an updated risk value calculating section 404, a risk value updating section 406, and a conformity value storage section 408.

The risk value update detecting section 402 detects an update to the risk values of the requirements or the components used when generating the requirement/component dependency relationship information. For example, the risk value update detecting section 402 may detect an update to the risk values used when generating the requirement/component dependency relationship information by constantly monitoring the requirements or components.

The updated risk value calculating section 404 calculates an updated value for achieving conformity between the risk value of a requirement or component whose risk value has been updated and the risk value of a requirement or component that is associated with the requirement or component whose risk value was updated, in response to the risk value update detecting section 402 detecting an update to a risk value. The updated risk value calculating section 404 may calculate this updated value based on a conformity value acquired by the conformity value storage section 408. The conformity value indicates a maximum value of a risk value provided from an affecting item to an affected item.

The risk value updating section 406 updates the risk value of the requirement or component associated with the requirement or component whose risk value was updated, to be the updated value calculated by the updated risk value calculating section 404. The conformity value storage section 408 stores the conformity value.

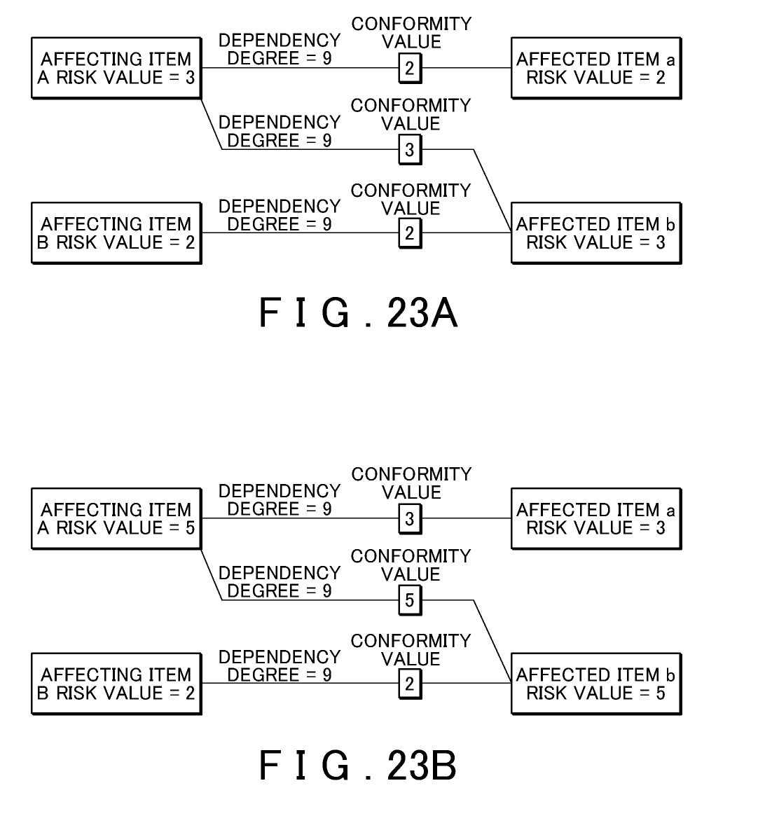

FIGS. 23A and 23 B show an exemplary process performed by the data conforming unit 400. The data conforming unit 400 eliminates non-conformity between the risk value of an affecting item whose risk value has been updated and the risk value of an affected item that is affected by the affecting item.

An initial conformity value is stored in the conformity value storage section 408. The initial conformity value may be the conformity value at a time when there is no risk value non-conformity according to the process performed by the data check unit 300, or may be the conformity value at a time when non-conformity of the risk values has been eliminated. The initial conformity value may be stored in the conformity value storage section 408 by the data check unit 300.

In the example of FIG. 23A, the conformity value storage section 408 stores a value of “2” as the conformity value that the affected item “a” receives from the affecting item A. Furthermore, the conformity value storage section 408 stores a value of “3” as the conformity value that the affected item “b” receives from the affecting item A. The conformity value storage section 408 stores a value of “2” as the conformity value that the affected item “b” receives from the affecting item B.

When the risk value of the affecting item increases, the data conforming unit 400 calculates a new conformity value that the affected item receives from the affecting item whose risk value was updated, by multiplying (i) the quotient of the updated risk value divided by the risk value before the update by (ii) the quotient of the degree of dependency divided by “9” by (iii) the known conformity value. The data conforming unit 400 updates the conformity value that the affected item receives from the affecting item whose risk value was updated, to be the conformity value calculated as described above. For example, as shown in FIG. 23B, when the risk value of the affecting item A is updated from “3” to “5,” the data conforming unit 400 updates the conformity value that the affected item “a” receives from the affecting item A to be “3.” Furthermore, the data conforming unit 400 updates the conformity value that the affected item “b” receives from the affecting item A to be “5.”

The data conforming unit 400 updates the risk value of the affected item to be the maximum value from among the conformity values received from the plurality of affecting items. For example, as shown in FIG. 23B, the data conforming unit 400 updates the risk value of the affected item “a” to be “3.” Furthermore, the data conforming unit 400 updates the risk value of the affected item “b” to be “5.” If the affected item has items that are further affected, the data conforming unit 400 updates the risk values of these further affected items by repeating the process described above.

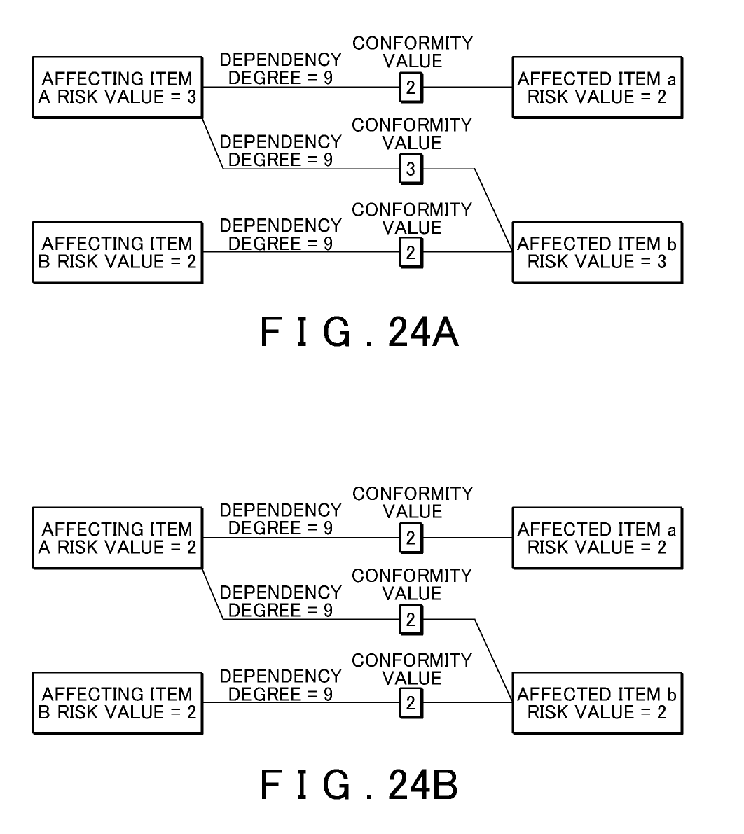

FIGS. 24A and 24B show other exemplary processes performed by the data conforming unit 400. When the risk value of the affecting item decreases, the data conforming unit 400 calculates a new conformity value that the affected item receives from the affecting item whose risk value was updated, by multiplying the updated risk value by the quotient of the degree of dependency divided by “9.” When the calculated conformity value is less than the known conformity value, the data conforming unit 400 updates the conformity value that the affected item receives from the affecting item whose risk value was updated, to be the conformity value calculated as described above.

For example, as shown in FIG. 24B, when the risk value of the affecting item A is updated from “3” to “2,” the data conforming unit 400 updates the conformity value that the affected item “b” receives from the affecting item A to be “2.” The data conforming unit 400 updates the risk value of the affected item to be the maximum value from among the conformity values received from the plurality of affecting items. For example, as shown in FIG. 23B, the data conforming unit 400 updates the risk value of the affected item “b” to be “2.” If the affected item has items that are further affected, the data conforming unit 400 updates the risk values of these further affected items by repeating the process described above.

In this way, the information processing system 10 of the present embodiment can automatically generate an integrated schedule with an optimal work order, based on the manager-level management data, such as a general task list and general task dependency relationship information, and engineer-level management data, such as requirement/component dependency relationship information. Therefore, the effort and cost incurred by the product development project can be decreased. Furthermore, the integrated schedule having the optimal work order obtained with consideration to standardized work rules and technical risks can be proposed prior to beginning the project.

Therefore, the information processing system 10 of the present embodiment can generate the integrated schedule with focus placed on a portion of the phases or a portion of the general tasks in the product development project, by using a combination of management data from several layers. As a result, the information processing system 10 can generate an integrated schedule that is more appropriate than an integrated schedule generated for the entire product development project.

Furthermore, when there is an update to the management data, the information processing system 10 of the present embodiment can automatically update the integrated schedule to have the optimal work order according to the content of the update to the management data. Therefore, the effort and cost incurred by the product development project can be decreased. Yet further, even for a product development project in which data is frequently updated according to the progress of the project, the user can be provided with an integrated schedule that always has the optimal work order.

The information processing system 10 of the present embodiment can determine conformity among a plurality of pieces of data based on dependency relationships among these pieces of data that are input by the user. When it is determined that the pieces of data do not conform with each other, the information processing system 10 can prompt the user to input the correct data by outputting information that indicates that there is a lack of conformity among the pieces of data. Therefore, the effort and cost incurred by the product development project can be decreased. Furthermore, conformity among a plurality of pieces of data can be held easily even for a product development project in which a large amount of data is managed.

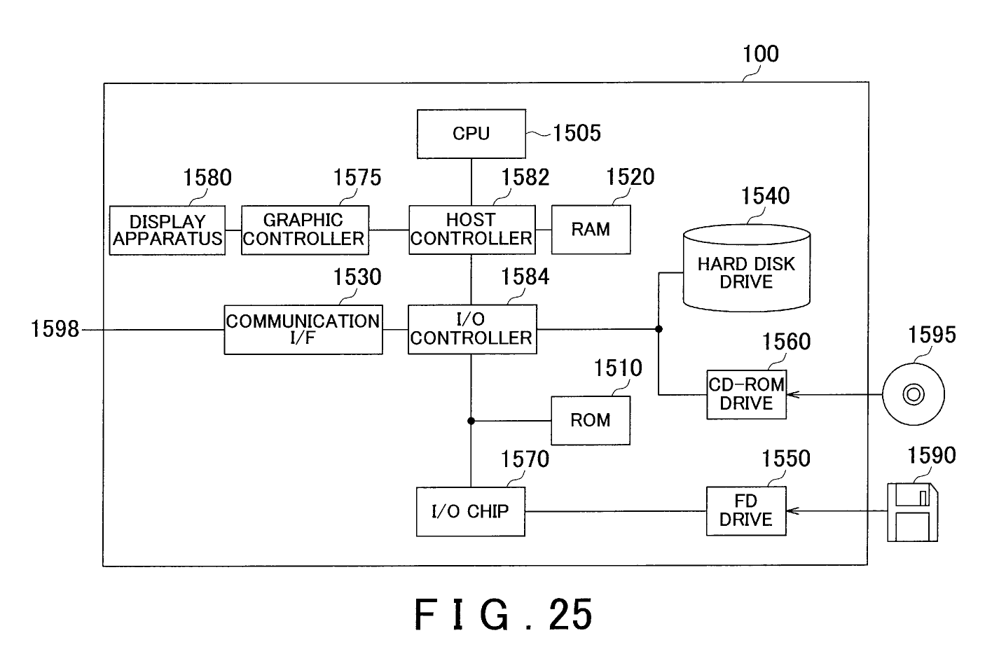

FIG. 25 shows an exemplary hardware configuration of the information processing system 100. The information processing system 100 is provided with a CPU peripheral section, an input/output section, and a legacy input/output section. The CPU peripheral section includes a CPU 1505, a RAM 1520, a graphic controller 1575, and a display apparatus 1580 connected to each other by a host controller 1582. The input/output section includes a communication interface 1530, a hard disk drive 1540, and a CD-ROM drive 1560, all of which are connected to the host controller 1582 by an input/output controller 1584. The legacy input/output section includes a ROM 1510, a flexible disk drive 1550, and an input/output chip 1570, all of which are connected to the input/output controller 1584.

The host controller 1582 is connected to the RAM 1520 and is also connected to the CPU 1505 and graphic controller 1575 accessing the RAM 1520 at a high transfer rate. The CPU 1505 operates to control each section based on programs stored in the ROM 1510 and the RAM 1520. The graphic controller 1575 acquires image data generated by the CPU 1505 or the like on a frame buffer disposed inside the RAM 1520 and displays the image data in the display apparatus. In addition, the graphic controller 1575 may internally include the frame buffer storing the image data generated by the CPU 1505 or the like.

The input/output controller 1584 connects the hard disk drive 1540, the communication interface 1530 serving as a relatively high speed input/output apparatus, and the CD-ROM drive 1560 to the host controller 1582. The hard disk drive 1540 stores the programs and data used by the CPU 1505. The communication interface 1530 is connected to a network communication apparatus 1598 and receives the programs or the data. The CD-ROM drive 1560 reads the programs and data from a CD-ROM 1595 and provides the read information to the hard disk drive 1540 and the communication interface 1530 via the RAM 1520.

Furthermore, the input/output controller 1584 is connected to the ROM 1510, and is also connected to the flexible disk drive 1550 and the input/output chip 1570 serving as a relatively high speed input/output apparatus. The ROM 1510 stores a boot program performed when the information processing apparatus 100 starts up, a program relying on the hardware of the information processing apparatus 100, and the like. The flexible disk drive 1550 reads programs or data from a flexible disk 1590 and supplies the read information to the hard disk drive 1540 and the communication interface 1530 via the RAM 1520. The input/output chip 1570 connects the flexible disk drive 1550 to each of the input/output apparatuses via, for example, a parallel port, a serial port, a keyboard port, a mouse port, or the like.

The programs performed by the CPU 1505 are stored on a recording medium such as the flexible disk 1590, the CD-ROM 1595, or an IC card and are provided by the user. The programs stored on the recording medium may be compressed or uncompressed. The programs are installed on the hard disk drive 1540 from the recording medium, are read by the RAM 1520, and are performed by the CPU 1505.

The programs performed by the CPU 1505 cause the computer to function as the schedule generating unit 200 described in relation to FIGS. 1 to 24 and as each functional section of the schedule generating unit 200. Furthermore, the programs performed by the CPU 1505 cause the computer to function as the data check unit 300 described in relation to FIGS. 1 to 24 and as each functional section of the data check unit 300. Yet further, the programs performed by the CPU 1505 cause the computer to function as the data conforming unit 400 described in relation to FIGS. 1 to 24 and as each functional section of the data conforming unit 400.

The programs shown above may be stored in an external storage medium. In addition to the flexible disk 1590 and the CD-ROM 1595, an optical recording medium such as a DVD or PD, a magnetooptical medium such as an MD, a tape medium, a semiconductor memory such as an IC card, or the like can be used as the recording medium. Furthermore, a storage apparatus such as a hard disk or a RAM disposed in a server system connected to the Internet or a specialized communication network may be used as the storage medium and the programs may be provided to the information processing system 100 via the network.

The following describes a second embodiment of the present invention. The method for calculating the degrees of dependency among the specific tasks indicated by the specific task list in the second embodiment is different from that used in the first embodiment. In the second embodiment, the requirement/component dependency relationship information generating section 226 does not generate requirement/component dependency relationship information. Furthermore, the integrated task dependency relationship calculating section 208 calculates the degrees of dependency among the specific tasks indicated by the specific task list, based on the risk values acquired by the status acquiring section 222 and the degrees of dependency acquired by the dependency degree acquiring section 224.

Specifically, the integrated task dependency relationship calculating section 208 determines the work type of each specific task by referencing the specific task list. Furthermore, the integrated task dependency relationship calculating section 208 acquires, from the specific task list and the DMM table, the risk values, degrees of dependency, and other parameters that are necessary for calculating the degrees of dependency among the specific tasks. The integrated task dependency relationship calculating section 208 calculates the degrees of dependency among the specific tasks by using the acquired parameters to perform a computation corresponding to the work types of the specific tasks.

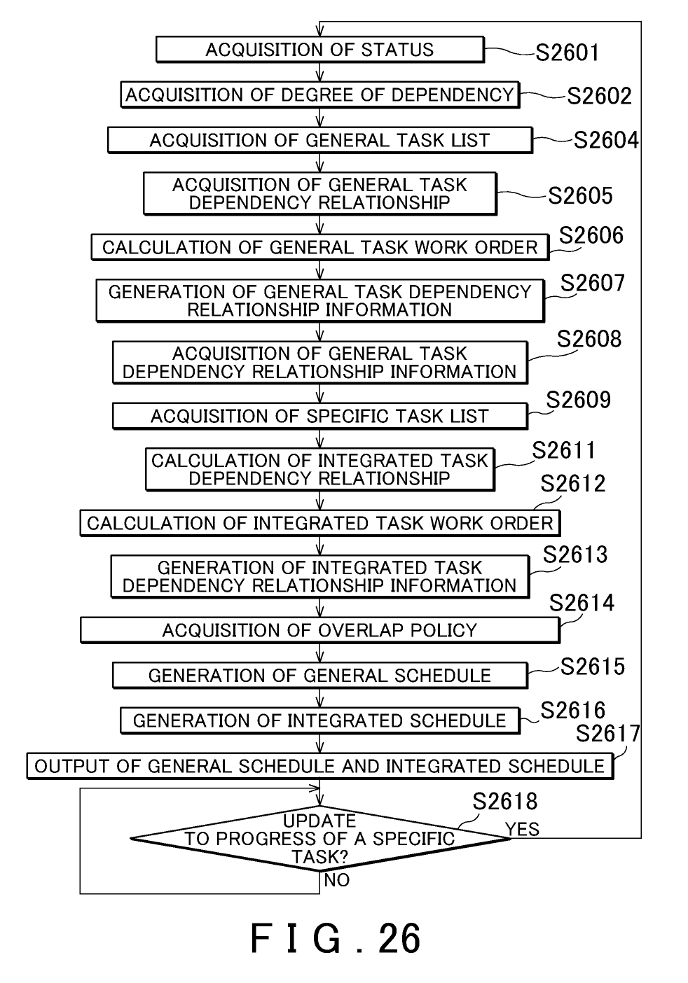

FIG. 26 shows an exemplary process flow performed by the schedule generating unit 200. First, the status acquiring section 222 acquires the status for each of a plurality of requirements and components (S2601). Next, the dependency degree acquiring section 224 acquires the degrees of dependency for the requirements and components (S2602).

Next, the general task list acquiring section 201 acquires a general task list indicating a plurality of general tasks (S2604). The general task dependency relationship acquiring section 231 then calculates the dependency relationship of the general tasks indicated by the general task list acquired at S2604 (S2605). Next, the general task work order calculating section 232 calculates the work order of the general tasks indicated by the general task list acquired at S2604 (S2606). The general task dependency relationship information generating section 233 then generates the general task dependency relationship information indicating the dependency relationship acquired at S2605 and the work order calculated at S2606 of the general tasks (S2607). The general task dependency relationship information acquiring section 202 then acquires the general task dependency relationship information generated at S2607 (S2608).

Next, the specific task list acquiring section 204 acquires the specific task list associated with at least one of a requirement and a component for each of the specific tasks (S2609).

Next, the integrated task dependency relationship calculating section 208 calculates the integrated task dependency relationship, which includes the dependency relationship for the specific tasks indicated by the specific task list acquired at S2609 (S2611). The integrated task work order calculating section 210 then calculates the integrated task work order, which includes the work order of the specific tasks indicated by the specific task list acquired at S2609, based on the integrated task dependency relationship information calculated by the integrated task dependency relationship calculating section 208 (S2612).

Next, the integrated task dependency relationship information generating section 212 generates the integrated task dependency relationship information indicating the dependency relationship calculated at S2611 and the work order calculated at S2612 of the integrated tasks (S2613). The overlap policy acquiring section 214 then acquires the overlap policy that determines the synchronization timing for work dates among specific tasks and the general tasks (S2614).

Next, the general schedule generating section 215 generates the general schedule in which the work dates of the general tasks are synchronized with each other (S2615). The integrated schedule generating section 216 then generates the integrated schedule in which the work dates of the specific tasks are synchronized with each other (S2616).

Next, the output section 217 outputs a plurality of general schedules generated at S2615 and the integrated schedule generated at S2616 (S2617). The update detecting section 218 then determines whether the progress of any of the specific tasks indicated by the specific task list has been updated (S2618).

When the update detecting section 218 determines that there has been an update to the progress of the specific tasks indicated by the specific task list (the “YES” of S2618), the information processing apparatus 100 repeats the process from S2601 onward. On the other hand, when the update detecting section 218 determines that there has not been an update to the progress of the specific tasks indicated by the specific task list (the “NO” of S2618), the information processing apparatus 100 performs S2618 again.

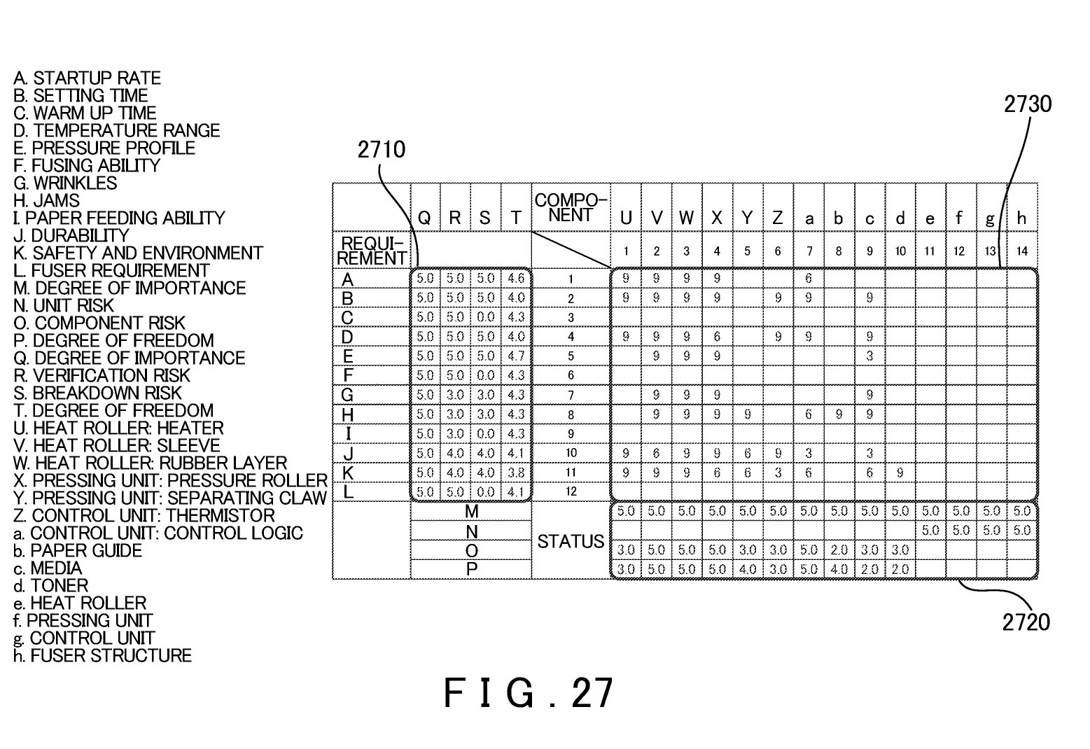

FIG. 27 shows exemplary statuses acquired by the status acquiring section 222 and degrees of dependency acquired by the dependency degree acquiring section 224. The information processing apparatus 100 can display the statuses acquired by the status acquiring section 222 and degrees of dependency acquired by the dependency degree acquiring section 224 in a DMM format. For example, the information processing apparatus 100 may display the statuses and degrees of dependency in a DMM table in which the rows represent components and the columns represent requirements.

The status region 2710 displays status information for each requirement. The requirement status information includes “verification risk” and “breakdown risk.” The “verification risk” is a risk value obtained by the status acquiring section 222 for each requirement, and indicates a degree of attainment. The “breakdown risk” is a status acquired by the status acquiring section 222, and indicates the risk of extracting sub-requirements or design components for achieving the requirement, allocating target specifications of sub-components, and implementing design specifications.

The status region 2720 displays status information for each component. The component status information includes “unit risk” and “component risk.” The “unit risk” is a risk value obtained by the status acquiring section 222 for each component and displayed in units. The “component risk” is a status acquired by the status acquiring section 222, and indicates a degree of risk with regard to degrees of verification and implementation of a design for achieving a requirement associated with the requirement. A high value for the degree of risk of a requirement or component means that it is difficult to achieve that requirement or component.

The dependency degree region 2730 displays the degrees of dependency between the requirements and the components. A high value for the degree of dependency between a requirement and a component means that there is a strong dependency relationship between the requirement and the component. For example, the dependency degree region 2730 displays “9” for the degree of dependency between the requirement “durability” and the component “control unit: thermistor.” This means that the requirement “durability” and the component “control unit: thermistor” exert a strong effect on each other.

Furthermore, the dependency degree region 2730 displays “6” for the degree of dependency between the requirement “durability” and the component “pressing unit: separating claw.” This means that the requirement “durability” and the component “pressing unit: separating claw” exert a relatively strong effect on each other.

The dependency degree region 2730 displays “3” for the degree of dependency between the requirement “durability” and the component “control unit: control logic.” This means that the requirement “durability” and the component “control unit: control logic” exert an effect on each other that is weak, but not weak enough to be ignored.

The dependency degree region 2730 does not display a value for the degree of dependency between the requirement “durability” and the component “paper guide.” This means that the requirement “durability” and the component “paper guide” do not exert an effect on each other, or exert an effect that is small enough to be ignored.

The DMM table displays a degree of design freedom and a degree of importance for each requirement and component. The degree of design freedom represents the degree to which the requirements and components can be freely designed in the current design plan. A large value for the degree of design freedom indicates a high degree of design freedom. For example, in the DMM chart of FIG. 27, the cell designated by the row of “degree of freedom” and the column of “startup rate” displays a value of “4.6” for the degree of design freedom of the requirement “startup rate.” Furthermore, in the DMM chart of FIG. 27, the cell designated by the row of “heat roller: heater” and the column of “degree of freedom” displays a value of “3.0” for the innate degree of design freedom of the component “heat roller: heater.”

The DMM table also displays a degree of importance for each requirement and component. The degree of importance represents how important a requirement or component is in the product planning. A large value for the degree of importance means that a requirement or component is essential in the product planning. For example, in the DMM chart of FIG. 27, the cell designated by the row of “degree of importance” and the column of “startup rate” displays a value of “5.0” for the degree of importance of the requirement “startup rate.” Furthermore, in the DMM chart of FIG. 27, the cell designated by the row of “heat roller: heater” and the column of “degree of importance” displays a value of “5.0” for the innate degree of importance of the component “heat roller: heater.”

In the DMM table shown in FIG. 27, the status regions 2710 and 2720 display statuses at the work start time. For example, in the status region 2710, the cell designated by the row of “verification risk” and the column of “startup rate” displays a value of “5.0” for the risk value at the work start time of the requirement “startup rate.” Furthermore, in the status region 2720, the cell designated by the row of “heat roller: heater” and the column of “component risk” displays a value of “3.0” for the risk value at the work start time of the component “heat roller: heater.”

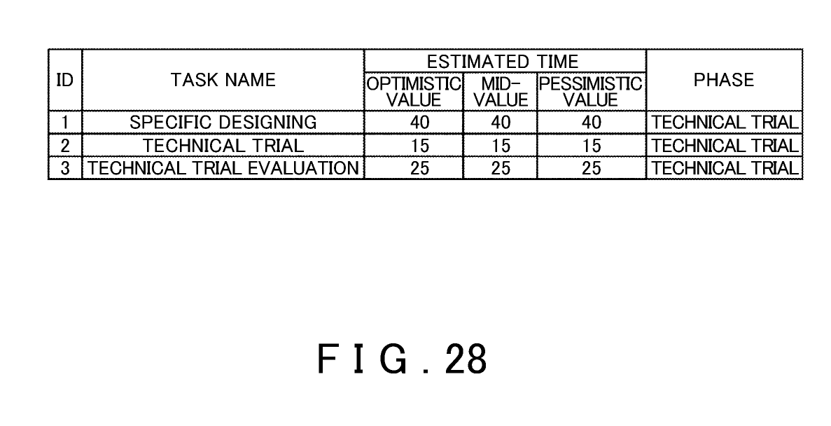

FIG. 28 shows an exemplary general task list acquired by the general task list acquiring section 201. FIG. 28 shows the general task list with focus placed on the “technical trial phase” of the product development project. The general task list includes “task name,” “estimated time,” and “phase” fields.

The name of the general task is input to the “task name” field. The number of work days necessary for the general task is input to the “estimated time” field. The “estimated time” field includes “optimistic value,” “intermediate value,” and “pessimistic value” fields. The same number of days may be entered in each of the “optimistic value,” “intermediate value,” and “pessimistic value” fields. By entering a different number of days into each of the “optimistic value,” “intermediate value,” and “pessimistic value” fields, a range of work days can be set for the general task.

The name of a phase is input to the “phase” field. By inputting a phase name into the “phase” field, the phase becomes associated with the general task.

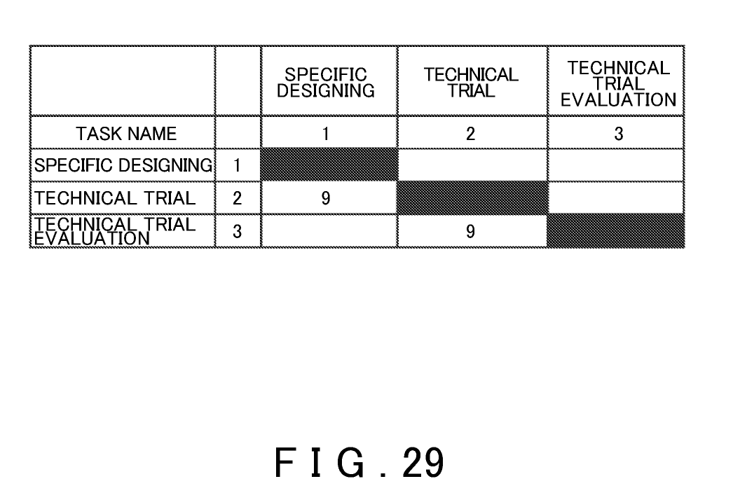

FIG. 29 shows exemplary general task dependency relationship information acquired by the general task dependency relationship information acquiring section 202. FIG. 29 shows the general task dependency relationship information with focus placed on the “technical trial phase” of the product development project. The information processing apparatus 100 can display the general task dependency relationship information in a DSM table. For example, the information processing apparatus 100 may display the general task dependency relationship information in a DSM table in which the main general tasks are placed in the rows and the reference general tasks are placed in the columns.

The general task dependency relationship information displays a value of “9” as the degree of dependency in the cell designated by the row of “specific designing” and the column of “technical trial.” This means that the general task “technical trial” has a relatively strong effect on the general task “specific designing.” On the other hand, the general task dependency relationship information does not display a value for the degree of dependency in the cell designated by the row of “technical trial” and the column of “specific designing.” This means that the general task “specific designing” does not exert an effect on the general task “technical trial,” or exerts an effect that is small enough to be ignored.

The general task dependency relationship information indicates the work order of the general tasks. For example, in the general task dependency relationship information shown in FIG. 29, the rows and columns are arranged in the order of “specific designing,” “technical trial,” and “technical trial evaluation.” Therefore, the general task dependency relationship information indicates that these tasks are desirably performed in the order of “specific designing,” “technical trial,” and “technical trial evaluation.”

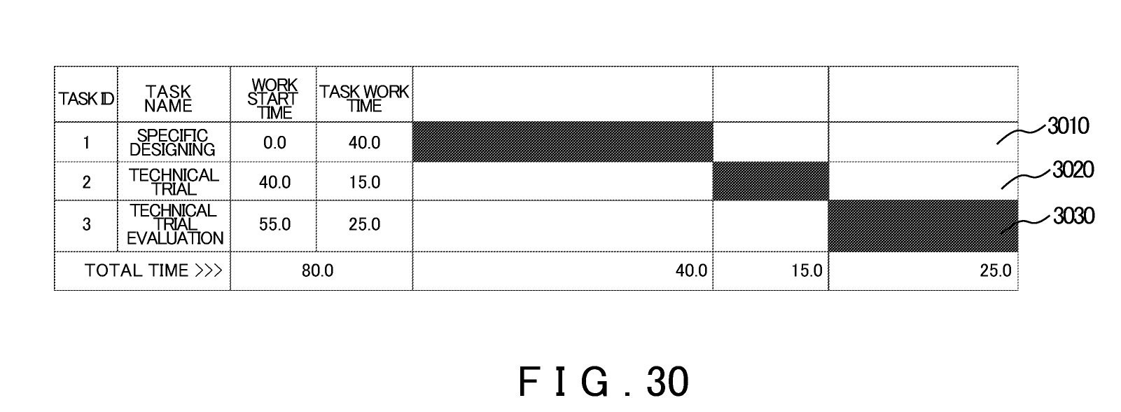

FIG. 30 shows an exemplary general schedule output by the output section 217. The output section 217 may output the general task schedule (binding schedule) generated by the general schedule generating section 215 in a Gantt chart, as shown in FIG. 30.

In the general task schedule of FIG. 30, the schedule 3010 shows a general schedule for the general task “specific designing” in the “technical trial phase” of the product development project. Furthermore, the schedule 3020 shows a general schedule for the general task “technical trial” in the “technical trial phase” of the product development project. The schedule 3030 shows a general schedule for the general task “technical trial evaluation” in the “technical trial phase” of the product development project.

Each general schedule includes “work start time” and “task work time” fields. The work start time of the general task is set in the “work start time” field. The work time of the general task is set in the “task work time” field.

The general schedule generating section 215 determines the work time for each of the general tasks based on the number of work days for each of the general tasks indicated by the general task list. The general schedule generating section 215 determines the work start time for each of the general tasks based on the work time of each general task and the work order of the general tasks indicated by the general task dependency relationship information.

For example, in the general schedule of FIG. 30, a value of “0.0” is displayed in the “work start time” field of the schedule 3010. A value of “40.0” is displayed in the “task work time” field of the schedule 3010. A value of “40.0” is displayed in the “work start time” field of the schedule 3020. A value of “15.0” is displayed in the “task work time” field of the schedule 3020. A value of “55.0” is displayed in the “work start time” field of the schedule 3030. A value of “25.0” is displayed in the “task work time” field of the schedule 3010.

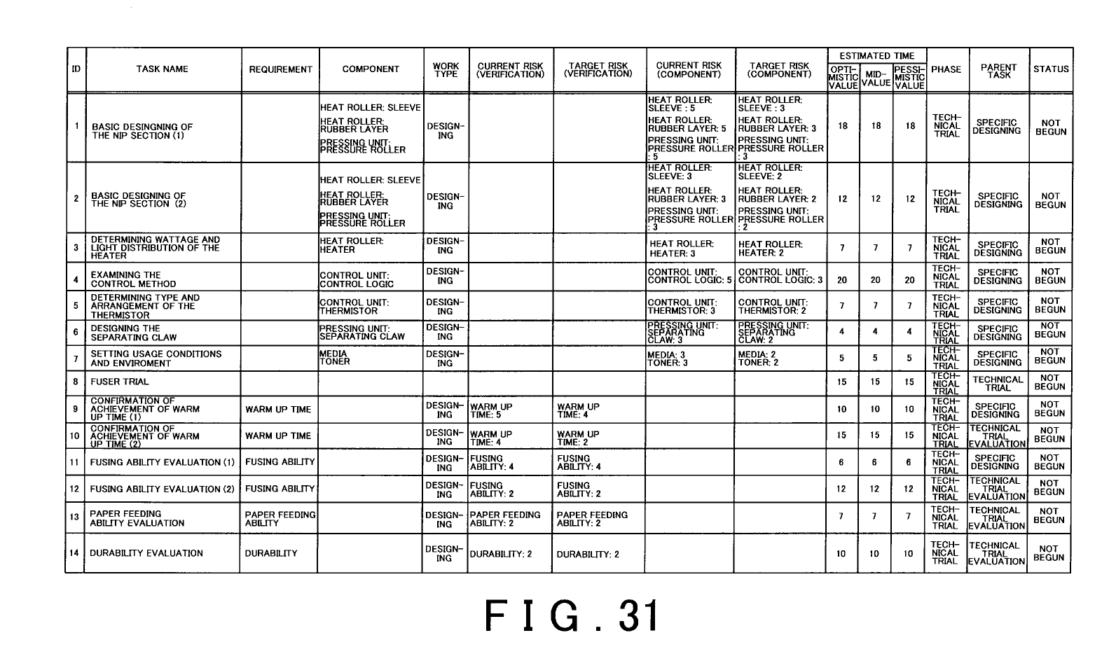

FIG. 31 shows an exemplary specific task list acquired by the specific task list acquiring section 204. FIG. 31 shows a specific task list with focus placed on the “technical trial phase” and the general tasks “specific designing task” and “technical trial evaluation” of the product development project. The specific task list includes “task name,” “requirement,” “component,” “work type,” “current risk (verification),” “target risk (verification),” “current risk (component),” “target risk (component),” “estimated time,” “phase,” “parent task,” and “status” fields.

The name of the specific task is input to the “task name” field. Names of requirements associated with the specific task are input to the “requirement” field. By inputting a requirement name into the “requirement” field, the input requirement becomes associated with the specific task. In the specific task list, a plurality of requirements can be associated with a single specific task.

Names of components associated with the specific task are input to the “component” field. By inputting a component name into the “component” field, the input component becomes associated with the specific task. In the specific task list, a plurality of components can be associated with a single specific task.

The work type associated with the specific task is input to the “work type” field. For example, the work type associated with the specific task input to the “work type” field may be “designing” or “verification.”

The progress of the specific task is input to the “status” field. For example, “in progress,” “not begun,” or “complete” may be input to the “status” field as the progress of a specific task.

A risk value at the work end time of a specific task whose work type is “verification” is input to the “current risk (verification)” for each requirement. A risk value at the work start time of a specific task whose work type is “verification” is input to the “target risk (verification)” for each requirement.

A risk value at the work end time of a specific task whose work type is “designing” is input to the “current risk (component)” for each component. A risk value at the work end time of a specific task whose work type is “designing” is input to the “target risk (component)” for each component.

The number of work days necessary for the specific task is input to the “estimated time” field. The “estimated time” field includes “optimistic value,” “intermediate value,” and “pessimistic value” fields. The same number of days may be entered in each of the “optimistic value,” “intermediate value,” and “pessimistic value” fields. By entering a different number of days into each of the “optimistic value,” “intermediate value,” and “pessimistic value” fields, a range of work days can be set for the specific task.

The name of a phase is input to the “phase” field. The name of a general task that is the higher-level task of the specific task is input to the “parent task” field. By inputting a general task name into the “parent task” field, the general task becomes associated with the specific task. In the specific task list, a plurality of specific tasks can be associated with a single general task.

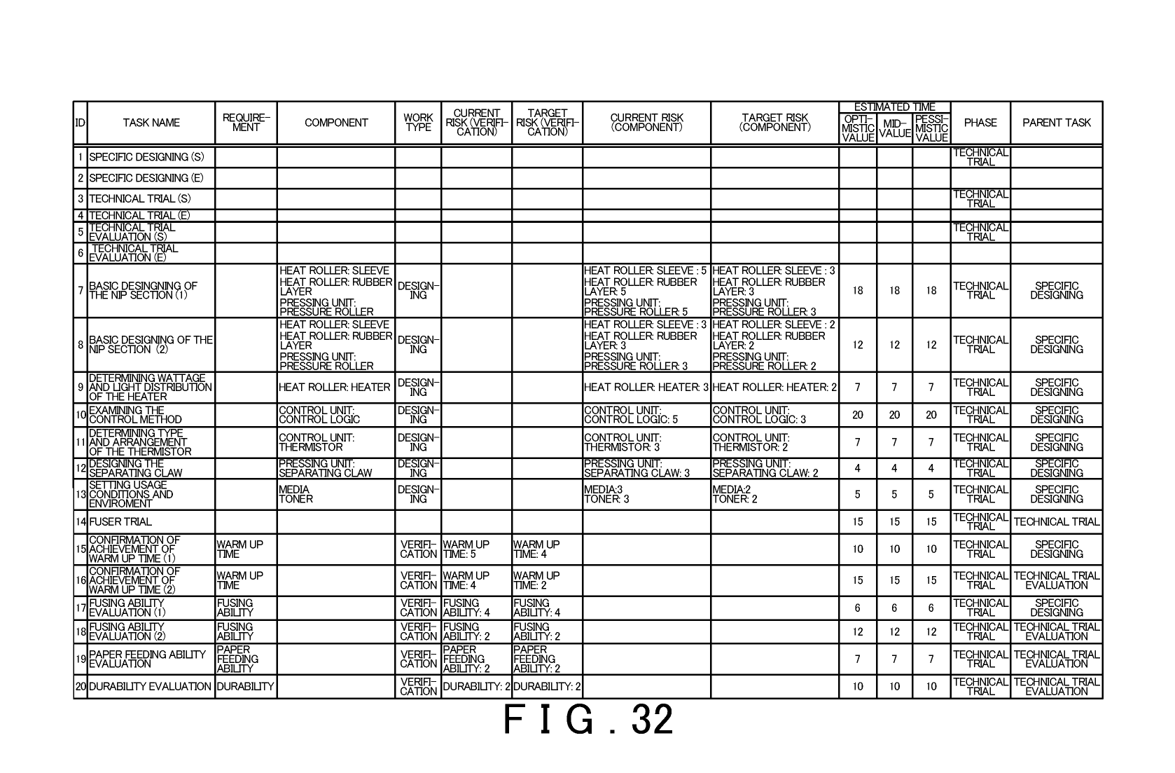

FIG. 32 shows an exemplary integrated task list generated by the integrated task dependency relationship calculating section 208. Before calculating the integrated task dependency relationship, the integrated task dependency relationship calculating section 208 may create an integrated task list that incorporates the general task information and the specific task information. For example, the integrated task dependency relationship calculating section 208 may create the integrated task list based on the specific task list and the general task list. The integrated task list of FIG. 32 is generated by the integrated task dependency relationship calculating section 208 based on the general task list of FIG. 28 and the specific task list of FIG. 31.

The integrated task list of FIG. 32 has the same format as the specific task list. The integrated task dependency relationship calculating section 208 may generate the integrated task list by adding the general tasks indicated by the general task list to the specific task list.

For example, the integrated task list of FIG. 32 is generated by the integrated task dependency relationship calculating section 208 adding, to the specific task list of FIG. 31, the general tasks “specific designing,” “technical trial,” and “technical trial evaluation” indicated by the general task list of FIG. 28.

In the integrated task list of FIG. 32, the integrated task dependency relationship calculating section 208 divides the general task “specific designing” into a general task “specific designing (S)” indicating the start time of the general task and a general task “specific designing (E)” indicating the end time of the general task. In the same way, the integrated task dependency relationship calculating section 208 divides the general task “technical trial” into a general task “technical trial (S)” indicating the start time of the general task and a general task “technical trial (E)” indicating the end time of the general task. Furthermore, the integrated task dependency relationship calculating section 208 divides the general task “technical trial evaluation” into a general task “technical trial evaluation (S)” indicating the start time of the general task and a general task “technical trial evaluation (E)” indicating the end time of the general task.

The integrated task list synchronizes the specific task list and the general task list. Therefore, when the specific task list and the general task list are updated, the integrated task dependency relationship calculating section 208 updates the integrated task list according to the update. When the integrated task list is updated, the integrated task dependency relationship calculating section 208 updates the specific task list and the general task list according to the update.

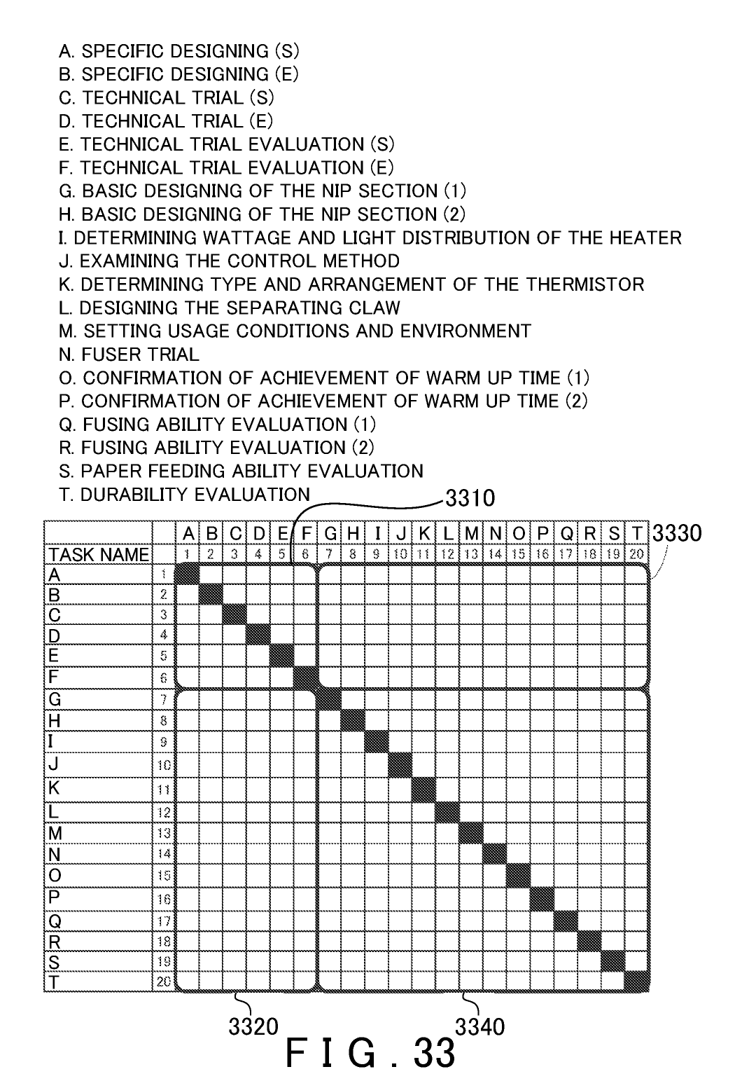

FIG. 33 shows exemplary integrated task dependency relationship information generated by the integrated task dependency relationship information generating section 212. FIG. 33 shows the integrated task dependency relationship information with focus placed on the “technical trial phase” of the product development project. FIG. 33 shows the integrated task dependency relationship information before the degrees of dependency between the tasks are set.

The information processing apparatus 100 can display the integrated task dependency relationship information in a DSM format. For example, in the example of FIG. 33, the information processing apparatus 100 displays the integrated task dependency relationship information in a DSM table in which the main general tasks are placed in the rows and the reference general tasks are placed in the columns.

In the DSM table of FIG. 33, the display region 3310 displays the dependency relationships among the general tasks. The display regions 3320 and 3330 display the dependency relationships between the general tasks and the specific tasks. The display region 3340 displays the dependency relationships among the specific tasks.

The integrated task dependency relationship information generating section 212 sets the degree of dependency as a value between “1” and “10” indicating the strength of the dependency relationship, in the cell of each task having a dependency relationship with another task. A large value for the degree of dependency indicates a strong dependency relationship.

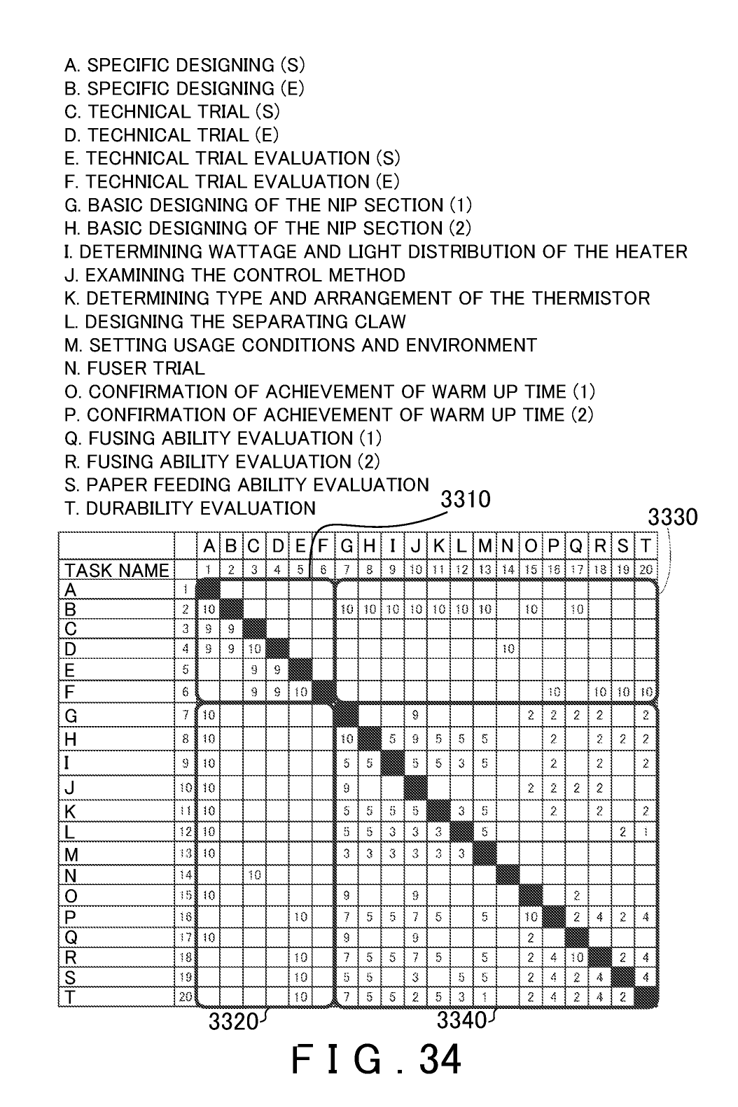

FIG. 34 shows exemplary integrated task dependency relationship information generated by the integrated task dependency relationship information generating section 212. FIG. 34 shows the integrated task dependency relationship information with focus placed on the “technical trial phase” of the product development project. FIG. 34 shows the integrated task dependency relationship information after the degrees of dependency between the tasks are set.

For identical general tasks, an end-task cannot be achieved if a start-task is not begun. Therefore, in the display region 3310 of the DSM table of FIG. 34, the integrated task dependency relationship information generating section 212 sets the degree of dependency to be “10” in each of the cells designated by the general task “specific designing (S)” and the general task “specific designing (E),” the cells designated by the general task “technical trial (S)” and the general task “technical trial (E),” and the cells designated by the general task “technical trial evaluation (S)” and the general task “technical trial evaluation (E).”

Furthermore, the degrees of dependency among the general tasks may be the same as the degrees of dependency among the general tasks in the general task dependency relationship information. Accordingly, in the same way as for the general task dependency relationship information of FIG. 29, the integrated task dependency relationship information generating section 212 sets a degree of dependency of “9” in each cell indicating a dependency relationship among general tasks having a dependency relationship in the display region 3310 of the DSM table of FIG. 34.

If a start-task for a general task is not begun, a specific task associated with this general task cannot be begun. Therefore, the integrated task dependency relationship information generating section 212 sets a degree of dependency of “10” in each cell indicating a dependency relationship between a start-task of a general task and a specific task associated with this general task in the display region 3320.

If all of the specific tasks associated with a general task are not completed, then the general task is not completed. Therefore, the integrated task dependency relationship information generating section 212 sets a degree of dependency of “10” in each cell indicating a dependency relationship between an end-task of a general task and a specific task associated with this general task in the display region 3330.

The integrated task dependency relationship calculating section 208 calculates the degrees of dependency among the specific tasks to be displayed in the display region 3340 of the DSM table of FIG. 34 using a calculation method corresponding to a combination of the work types of the specific tasks. For example, by referencing the specific task list shown in FIG. 31, the integrated task dependency relationship calculating section 208 can determine the work type of each specific task displayed in the DSM table of FIG. 34.

The integrated task dependency relationship calculating section 208 calculates the degree of dependency to be set in each cell in the display region 3340 by using a calculation method corresponding to a combination of the work types of the specific tasks. Furthermore, the integrated task dependency relationship information generating section 212 sets the degree of dependency calculated by the integrated task dependency relationship calculating section 208 in each cell in the display region 3340.

The following describes an exemplary method by which the integrated task dependency relationship calculating section 208 calculates the degrees of dependency among specific tasks according to the combination of work types of the specific tasks, for each combination of specific task work types. The method for calculating the degrees of dependency among specific tasks for combinations other than those described below may be the same as the calculation method described in the first embodiment, and specific examples are therefore omitted.

Before performing the following processes, the integrated task dependency relationship calculating section 208 may adjust the risk values and degrees of freedom necessary when calculating the degrees of dependency among the specific tasks. For example, the integrated task dependency relationship calculating section 208 may calculate each risk value and degree of freedom using the expression ((original value)−1)×2+1). For example, if the original value of the risk value or the degree of freedom is “5,” the integrated task dependency relationship calculating section 208 may adjust the risk value or degree of freedom to be “9.”

Before performing the following processes, the integrated task dependency relationship calculating section 208 may adjust the dependency degree values necessary when calculating the degrees of dependency among the specific tasks. For example, when the original value of the degree of dependency is “10,” the integrated task dependency relationship calculating section 208 may set the new degree of dependency to be “1.” Furthermore, when the original value of the degree of dependency is from “1” to “9,” the integrated task dependency relationship calculating section 208 may calculate the value of the new degree of dependency by dividing the degree of dependency by “9.” For example, when the original value of the degree of dependency is “3,” the integrated task dependency relationship calculating section 208 may set “0.33 . . . ” as the new degree of dependency.

First, an exemplary dependency degree calculation method is described for a case in which the work type of the main specific task is “designing” and the work type of the reference specific task is “designing.” In the following description, the main specific task is referred to as “design task 1.” Furthermore, the reference specific task is referred to as “design task 2.”

The component associated with design task 1 is referred to as “component A.” The component associated with design task 2 is referred to as “component C.” The verification requirement having a dependency relationship with component A and component C is referred to as “requirement B.” The dependency degree indicating the effect of component A on requirement B is referred to as “dependency degree 1.” The dependency degree indicating the effect of component C on requirement B is referred to as “dependency degree 2.”

When the component risk of component A at the start of design task 1 is less than or equal to the component risk of component C at the end of design task 2, the integrated task dependency relationship calculating section 208 determines the degree of dependency between design task 1 and design task 2 to be “0.” When the component risk of component A at the start of design task 1 is greater than the component risk of component C at the end of design task 2, the integrated task dependency relationship calculating section 208 determines the degree of dependency between design task 1 and design task 2 using the method described below.

First, the integrated task dependency relationship calculating section 208 calculates the risk value EV that is transferred from component A to requirement B using an expression Min(start time component risk of Component A, breakdown risk of requirement B). Here, Min( ) represents an expression for obtaining a minimum value from among a plurality of parameters. If there are a plurality of combinations of component A and requirement B, the integrated task dependency relationship calculating section 208 calculates the risk value EV for each combination of component A and requirement B.

Next, the integrated task dependency relationship calculating section 208 calculates the risk value VE that is transferred from requirement B to component C of design task 2 using an expression Min(EV, degree of freedom of component C). If there are a plurality of combinations of the risk value EV and component C, the integrated task dependency relationship calculating section 208 calculates the risk value VE for each combination of the risk value EV and component C.

The integrated task dependency relationship calculating section 208 calculates the risk value EE as a product of VE, dependency degree 1, and dependency degree 2, or sets the risk value EE to be VE. Furthermore, the integrated task dependency relationship calculating section 208 then determines the degree of dependency between design task 1 and design task 2 to be the calculated risk value EE.

If there are a plurality of combinations of the risk value VE, dependency degree 1, and dependency degree 2, the integrated task dependency relationship calculating section 208 calculates the risk value EE for each combination of the risk value VE, dependency degree 1, and dependency degree 2. In this case, the integrated task dependency relationship calculating section 208 then determines the degree of dependency between design task 1 and design task 2 to be the maximum value from among the calculated risk values EE.

Next, an exemplary dependency degree calculation method is described for a case in which the work type of the main specific task is “designing” and the work type of the reference specific task is “verification.” In the following description, the main specific task is referred to as “design task 1.” Furthermore, the reference specific task is referred to as “verification task 1.”

The component associated with design task 1 is referred to as “component A.” The requirement associated with verification task 1 is referred to as “requirement B.” The dependency degree indicating the effect of component A on requirement B is referred to as “dependency degree 1.”

When the component risk of component A at the start of design task 1 is less than or equal to the verification risk of requirement B at the end of verification task 1, the integrated task dependency relationship calculating section 208 determines the degree of dependency between design task 1 and verification task 1 to be “0.” On the other hand, when the component risk of component A at the start of design task 1 is greater than the verification risk of requirement B at the end of verification task 1, the integrated task dependency relationship calculating section 208 determines the degree of dependency between design task 1 and verification task 1 to be (i) a value calculated as the product of the expression Min(start time component risk of component A, start time verification risk of requirement B) and dependency degree 1 or to be (ii) a value of the expression Min(start time component risk of component A, start time verification risk of requirement B).

Next, an exemplary dependency degree calculation method is described for a case in which the work type of the main specific task is “verification” and the work type of the reference specific task is “designing.” In the following description, the main specific task is referred to as “verification task 1.” Furthermore, the reference specific task is referred to as “design task 1.”

The requirement associated with verification task 1 is referred to as “requirement A.” The component associated with design task 1 is referred to as “component B.” The dependency degree indicating the effect of component B on requirement A is referred to as “dependency degree 1.”

When the breakdown risk of requirement A at the start of verification task 1 is less than or equal to the component risk of component B at the end of design task 1, the integrated task dependency relationship calculating section 208 determines the degree of dependency between verification task 1 and design task 1 to be “0.” On the other hand, when the breakdown risk of requirement A at the start of verification task 1 is greater than the component risk value of component B at the end of design task 1, the integrated task dependency relationship calculating section 208 determines the degree of dependency between verification task 1 and design task 1 to be (i) a product of dependency degree 1 and a value of the expression Min(Min(start time breakdown risk of requirement A, start time component risk of component B), degree of freedom of component B)−Max(end time breakdown risk of requirement A, end time component risk of component B) or to be (ii) a value of the expression Min(Min(start time breakdown risk of requirement A, start time component risk of component B), degree of freedom of component B)−Max(end time breakdown risk of requirement A, end time component risk of component B). Here, Max( ) is an expression indicating the maximum value from among a plurality of parameters.

Next, an exemplary dependency degree calculation method is described for a case in which the work type of the main specific task is “verification” and the work type of the reference specific task is “verification.” In the following description, the main specific task is referred to as “verification task 1.” Furthermore, the reference specific task is referred to as “verification task 2.”

The requirement associated with verification task 1 is referred to as “requirement A.” The requirement associated with verification task 2 is referred to as “requirement C.” Furthermore, a superordinate verification requirement having a dependency relationship with requirement A and requirement C is referred to as “requirement B,” and a superordinate design component having a dependency relationship with requirement A and requirement C is referred to as “component B.” A subordinate verification requirement having a dependency relationship with requirement A and requirement C is referred to as “requirement D.” Here, concerning the terms “superordinate” and “subordinate,” a design component is considered to be superordinate to a verification requirement, and a sub-requirement is considered to be subordinate to its parent requirement.

The dependency degree indicating the effect of requirement B or component B on requirement A is referred to as “dependency degree 1.” The dependency degree indicating the effect of requirement B or component B on requirement C is referred to as “dependency degree 2.” The dependency degree indicating the effect of requirement A on requirement D is referred to as “dependency degree 3.” The dependency degree indicating the effect of requirement C on requirement D is referred to as “dependency degree 4.”

First, the integrated task dependency relationship calculating section 208 calculates the risk value P transferred from verification task 1 to verification task 2 using the expression Min(Min(start time breakdown risk of requirement A, verification risk of requirement B or component risk of component B), degree of freedom of requirement B or component B)−Max(end time breakdown risk of requirement A, end time verification risk of requirement C). The integrated task dependency relationship calculating section 208 calculates the risk value VV transferred from verification task 1 to verification task 2 via superordinate requirement B or component B to be (i) the value of P or (ii) the product of P, dependency degree 3, and dependency degree 4. If there are a plurality of combinations of requirement A, requirement C, and requirement B or component B, the integrated task dependency relationship calculating section 208 calculates the risk value vv for each combination of requirement A, requirement C, and requirement B or component B.

Next, the integrated task dependency relationship calculating section 208 calculates the risk value P transferred from verification task 1 to verification task 2 using the expression Min(start time verification risk of requirement A, breakdown risk of requirement D)−Max(end time verification risk of requirement A, end time verification risk of requirement C). The integrated task dependency relationship calculating section 208 calculates the risk value VV transferred from verification task 1 to verification task 2 via subordinate requirement B to be (i) the value of P or (ii) the product of P, dependency degree 3, and dependency degree 4. If there are a plurality of combinations of requirement A, requirement C, and requirement D, the integrated task dependency relationship calculating section 208 calculates the risk value VV for each combination of requirement A, requirement C, and requirement D.

Here, when requirement A of verification task 1 and requirement C of verification task 2 have a direct dependency relationship such that requirement A is superordinate and requirement C is subordinate, the following process is performed. Here, the dependency degree indicating the effect of requirement A on requirement C is referred to as “dependency degree 11.” When the start time verification risk of requirement A of design task 1 is less than or equal to the end time verification risk of requirement C of verification task 2, the integrated task dependency relationship calculating section 208 determines the risk value P transferred from verification task 1 to verification task 2 to be “0.” When the start time verification risk of requirement A of design task 1 is greater than the end time verification risk of requirement C of verification task 2, the integrated task dependency relationship calculating section 208 determines the risk value P transferred from verification task 1 to verification task 2 according to the expression Min(start time verification risk of requirement A, start time verification risk of requirement C). The integrated task dependency relationship calculating section 208 calculates the risk value vV transferred from verification task 1 to verification task 2 to be (i) the value of P or (ii) the product of P and dependency degree 11. If there are a plurality of combinations of requirement A and requirement C, the integrated task dependency relationship calculating section 208 calculates the risk value vV for each combination of requirement A and requirement C.

When requirement A of verification task 1 and requirement C of verification task 2 have a direct dependency relationship such that requirement A is subordinate and requirement C is superordinate, the following process is performed. Here, the dependency degree indicating the effect of requirement C on requirement A is referred to as “dependency degree 11.” When the start time breakdown risk of requirement A of design task 1 is less than or equal to the end time verification risk of requirement C of verification task 2, the integrated task dependency relationship calculating section 208 determines the risk value P transferred from verification task 1 to verification task 2 to be “0.” When the start time breakdown risk of requirement A of design task 1 is greater than the end time verification risk of requirement C of verification task 2, the integrated task dependency relationship calculating section 208 determines the risk value P transferred from verification task 1 to verification task 2 according to the expression Min(start time breakdown risk of requirement A, start time verification risk of requirement C)−Max(end time breakdown risk of requirement A, end time verification risk of requirement C). The integrated task dependency relationship calculating section 208 calculates the risk value Vv transferred from verification task 1 to verification task 2 to be (i) the value of P or (ii) the product of P and dependency degree 11. If there are a plurality of combinations of requirement A and requirement C, the integrated task dependency relationship calculating section 208 calculates the risk value Vv for each combination of requirement A and requirement C.

The integrated task dependency relationship calculating section 208 then determines the degree of dependency between verification task 1 and verification task 2 to be the maximum value from among the risk values VV, the risk values vv, the risk values vV, and the risk values Vv.

In order to gradually lower the risk of one requirement (or component), when there are a plurality of process stages within the requirement, the integrated task dependency relationship calculating section 208 obtains the degrees of dependency among these process stages. First, the integrated task dependency relationship calculating section 208 judges whether the exact same requirement is associated with two process stages. If it is determined that the same requirement is associated with the two process stages, the degree of dependency between the preceding process stage and the following process stage is determined to be “10.”

If a plurality of sub-requirements are included in one requirement (or sub-components are included in a component) as a result of development of the configuration or this requirement, the integrated task dependency relationship calculating section 208 obtains the degrees of dependency among the tasks associated with the sub-requirements. Specifically, the integrated task dependency relationship calculating section 208 determines the degree of dependency between a task associated with a preceding sub-requirement and a task associated with a following sub-requirement to be “10.”

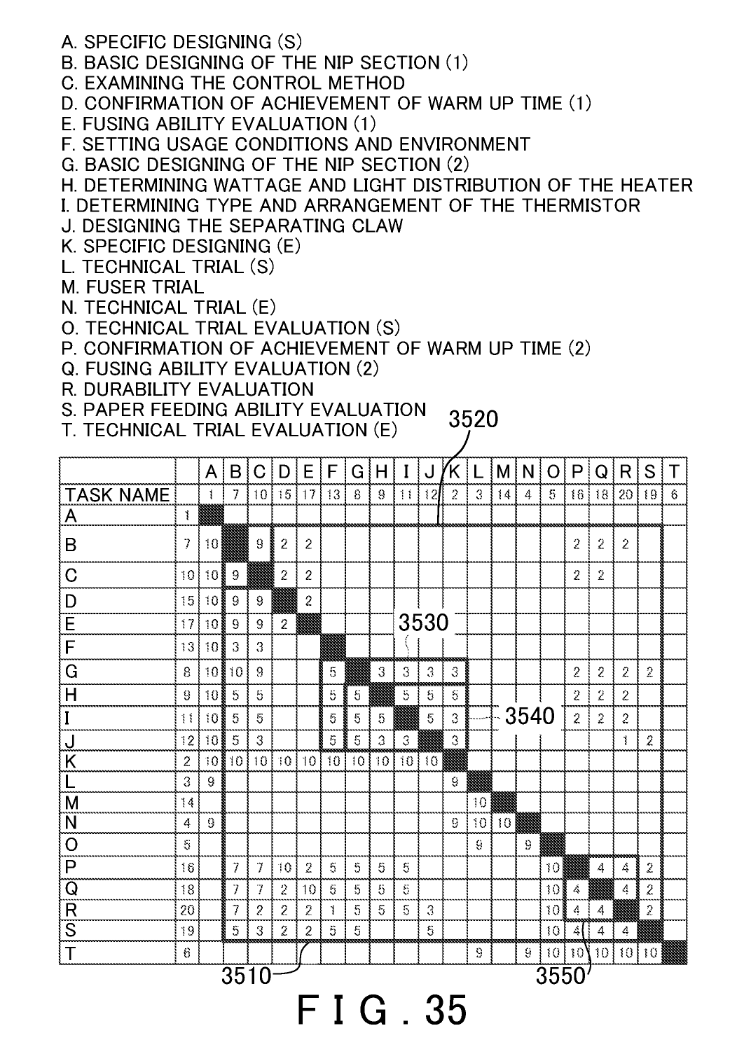

FIG. 35 shows exemplary integrated task dependency relationship information indicating the work order of a plurality of specific tasks. The integrated task dependency relationship information shown in FIG. 35 differs from the integrated task dependency relationship information shown in FIG. 34 in that the rows and columns are lined up according to the work order of the integrated tasks calculated by the integrated task work order calculating section 210.

The integrated task work order calculating section 210 determines the work order of the specific tasks based on the degrees of dependency indicated by the integrated task dependency relationship information. Specifically, by performing a partition analysis on the integrated task dependency relationship information, the integrated task work order calculating section 210 can rearrange the rows and columns of the integrated task dependency relationship information such that specific tasks having a strong dependency relationship are arranged together in the integrated task dependency relationship information. In this case, the integrated task work order calculating section 210 may determine the work order of the specific tasks by performing, on the integrated task dependency relationship information, the partition analysis disclosed in Japanese Patent Application Publication No. 2007-109073.

Specifically, the integrated task work order calculating section 210 generates a loop chain of the integrated task dependency information by performing a partition analysis on the integrated task dependency relationship information. Here, the “loop chain” refers to a grouping of dependency relationships that have a fixable relationship. For example, for the integrated task dependency relationship information shown in FIG. 35, the integrated task work order calculating section 210 generates a loop chain 3510, a loop chain 3520, a loop chain 3530, and a loop chain 3540. For example, the integrated task work order calculating section 210 may generate the loop chains of the integrated task dependency relationships by performing, on the integrated task dependency relationship information, the partition analysis disclosed in Japanese Patent Application Publication No. 2007-109073.

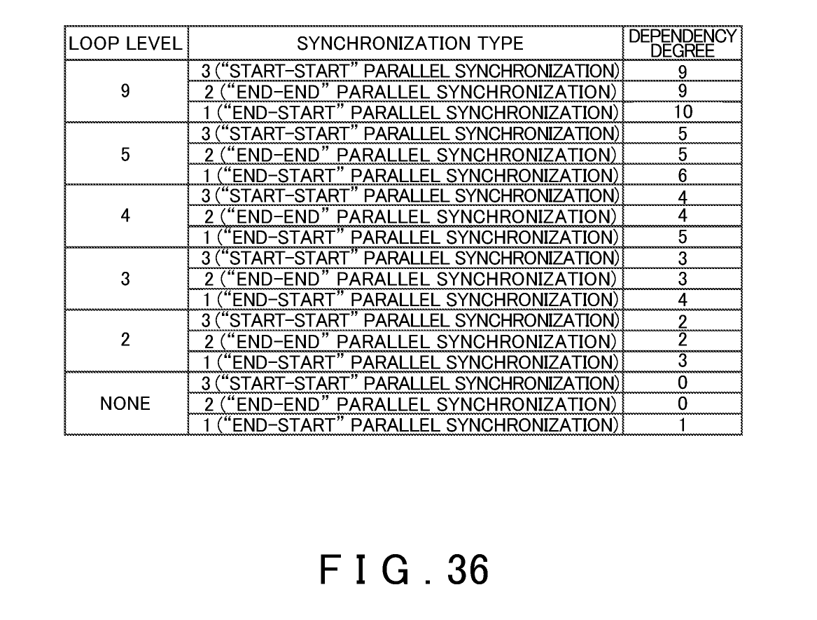

FIG. 36 shows an exemplary overlap policy acquired by the overlap policy acquiring section 214. The overlap policy shown in FIG. 36 includes “loop level,” “dependency degree,” and “synchronization type” fields.

The loop level of the loop chain to achieve parallel work is set in the “loop level” field. In the present embodiment, values from “0” to “10” are set in the “dependency degree” field. The user can set a plurality of loop levels for the overlap policy.

A set value indicating how the determined tasks to be synchronized are to be arranged is set in the “synchronization type” field. In the present embodiment, values from “1” to “3” are set in the “synchronization type” field. The user can set a plurality of synchronization types for each loop level set in the overlap policy.

A threshold value for determining tasks to be synchronized is set in the “dependency degree” field. In the present embodiment, values from “0” to “10” are set in the “dependency degree” field. The user can set a degree of dependency for each synchronization type set in the “synchronization type” field of each loop level set in the “loop level” field.

The integrated schedule generating section 216 generates the integrated schedule in which the tasks determined to be in synchronized are synchronized with each other. In this case, for tasks whose synchronization type is “1,” the integrated schedule generating section 216 generates the schedule in which the tasks are synchronized with each other such that a following task is begun as soon as a preceding task is completed. For tasks whose synchronization type is “2,” the integrated schedule generating section 216 generates the schedule in which the tasks are synchronized with each other such that a preceding task and a following task are completed at the same time. For tasks whose synchronization type is “3,” the integrated schedule generating section 216 generates the schedule in which the tasks are synchronized with each other such that a preceding task and a following task are begun at the same time.

In the overlap policy shown in FIG. 36, for example, the loop level “9” includes synchronization type “3,” synchronization type “2,” and synchronization type “1.” From among these synchronization types, synchronization type “3” is associated with a degree of dependency of “9.” Synchronization type “2” is also associated with a degree of dependency of “9.” Synchronization type “1” is associated with a degree of dependency of “10”.

In this case, the integrated schedule generating section 216 generates the integrated schedule in which the tasks included in loop chains with a loop level of “9” are synchronized with each other. At this time, for tasks with a degree of dependency of “9” or above and whose synchronization type is “3,” the integrated schedule generating section 216 generates the schedule in which these tasks are synchronized with each other such that a preceding task and a following task are begun at the same time.

Furthermore, for tasks with a degree of dependency of “9” or above and whose synchronization type is “2,” the integrated schedule generating section 216 generates the schedule in which these tasks are synchronized with each other such that a preceding task and a following task end at the same time. For tasks with a degree of dependency of “10” or above and whose synchronization type is “1,” the integrated schedule generating section 216 generates the schedule in which these tasks are synchronized with each other such that a following task begins at the same time that a preceding task ends.

When a plurality of loop levels are set for the overlap policy, the integrated schedule generating section 216 generates the schedule such that, for each loop level, the tasks included in loop chains of this loop level are synchronized with each other. When generating a schedule for a single task, if synchronization types are set for a plurality of other tasks, the integrated schedule generating section 216 may reference the most restrictive condition and generate the schedule for the single task such that the single task has the latest start time.

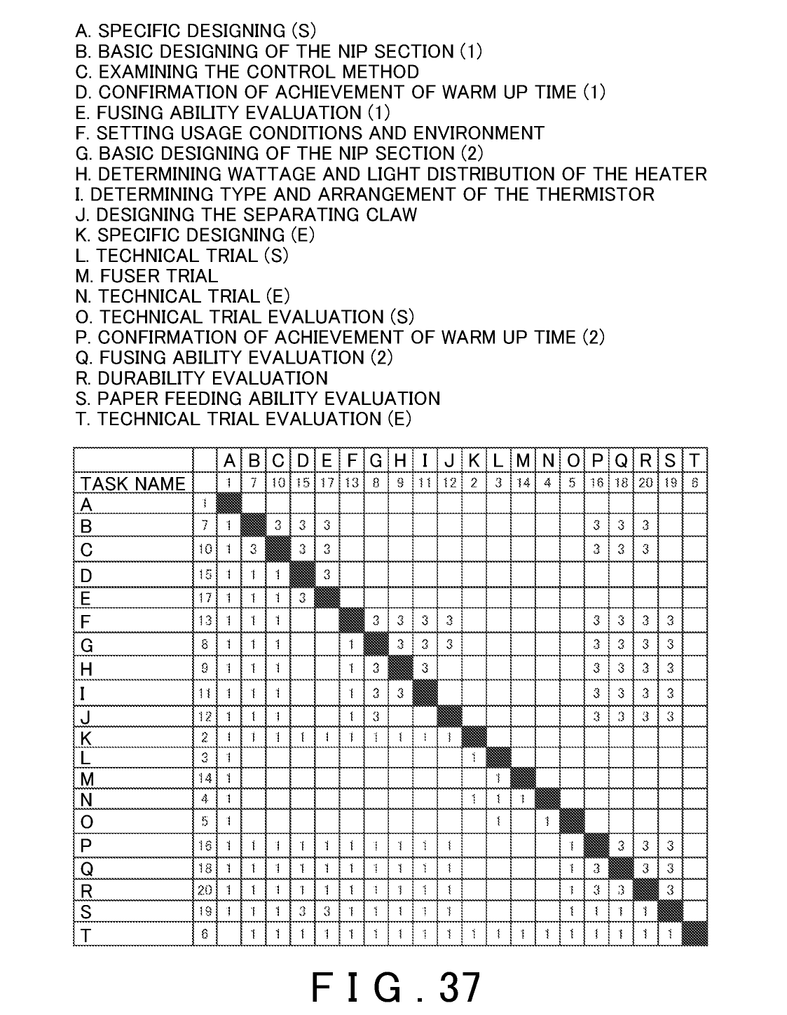

FIG. 37 shows an exemplary synchronization relationship table generated by the integrated schedule generating section 216. Before generating the integrated schedule, the integrated schedule generating section 216 may create a synchronization relationship table indicating the synchronization relationships among the tasks.

In the synchronization relationship chart, the integrated tasks are arranged in the same manner as shown in the integrated task dependency relationship information of FIG. 35. The integrated schedule generating section 216 sets the synchronization type in each cell of the synchronization relationship table based on the degrees of dependency among the integrated tasks of FIG. 35, the loop levels of the loop chains of FIG. 35, and the overlap policy of FIG. 36.

When a certain loop chain is surrounded by another loop chain whose loop level is higher than that of the certain loop chain, the integrated schedule generating section 216 may set the synchronization type in each related cell in the synchronization relationship table, with this certain loop chain being set as a task under consideration.

For example, if the preceding task is a normal task and the following task is a task under consideration, the integrated schedule generating section 216 first identifies the maximum degree of dependency value from among the degrees of dependency of the normal tasks within the preceding task and the following task under consideration, i.e. the loop chain. The integrated schedule generating section 216 then sets, for the preceding task, a synchronization type corresponding to the identified maximum degree of dependency for the synchronization relationship among the normal tasks.

If the preceding task is a task under consideration and the following task is a normal task, the integrated schedule generating section 216 first identifies the maximum degree of dependency value from among the degrees of dependency of the following tasks and each of the normal tasks within the preceding task under consideration, i.e. the loop chain. The integrated schedule generating section 216 then sets, for each of the normal tasks, a synchronization type corresponding to the identified maximum degree of dependency for the synchronization relationship among the following tasks.

If the preceding task is a task under consideration and the following task is a task under consideration, the integrated schedule generating section 216 first identifies the maximum degree of dependency value from among the normal tasks in the preceding task under consideration (loop chain) and the normal tasks in the following task under consideration (loop chain). The integrated schedule generating section 216 then sets, for each of the normal tasks, a synchronization type corresponding to the identified maximum degree of dependency for the synchronization relationship among the normal tasks.

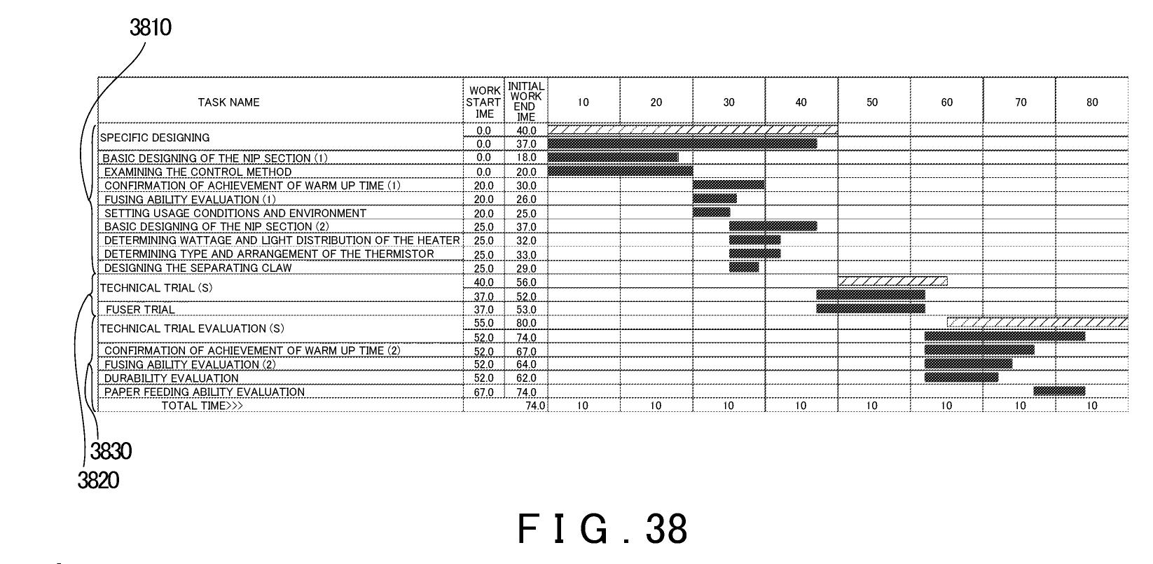

FIG. 38 shows an exemplary integrated schedule output by the output section 217. The output section 217 may output the integrated task schedule (binding schedule) generated by the integrated schedule generating section 216 in a Gantt chart, as shown in FIG. 38.

In the general task schedule of FIG. 38, the schedule 3810 shows an integrated schedule for the general task “specific designing” in the “technical trial phase” of the product development project. Furthermore, the schedule 3820 shows an integrated schedule for the general task “technical trial” in the “technical trial phase” of the product development project. The schedule 3830 shows an integrated schedule for the general task “technical trial evaluation” in the “technical trial phase” of the product development project.

In the integrated schedule of FIG. 38, the task bars with a diagonal-line pattern indicate general schedules (binding schedules) generated by the general schedule generating section 215. The task bars with a solid pattern indicate loose schedules generated by the integrated schedule generating section 216.

Each general schedule and estimated schedule includes “work start time” and “initial work end time” fields. The work start time of the general task or the specific task is set in the “work start time” field. The work end time of the general task or the specific task is set in the “initial work end time” field, according to the work start time and the work time.

In the integrated schedule of FIG. 38, the work time of the estimated schedule for each of the specific tasks is determined by the integrated schedule generating section 216 based on the estimated number of days for each of the specific tasks indicated by the specific task list of FIG. 31.

In the integrated schedule of FIG. 38, the work order of the specific tasks is determined by the integrated schedule generating section 216 based on the work order for the specific tasks indicated by the integrated task dependency relationship information of FIG. 35.

In the integrated schedule of FIG. 38, the work time of the general schedule for each of the general tasks is determined by the integrated schedule generating section 216 based on the general schedule of the general tasks indicated by the general schedule of FIG. 30.

In the integrated schedule of FIG. 38, the work order of the general tasks is determined by the integrated schedule generating section 216 based on the work order for the general tasks indicated by the general schedule of FIG. 30.

In the integrated schedule of FIG. 38, the work time of the estimated schedule for each of the general tasks is determined by the integrated schedule generating section 216 based on the estimated schedule of the specific tasks indicated by the integrated schedule.

The integrated schedule generating section 216 may generate the integrated schedule in which work dates for a plurality of specific tasks are in synchronization with each other, based on the overlap policy of FIG. 36. As one example, in the synchronization relationship table of FIG. 37, synchronization type “3” is set in the cell indicating the synchronization relationship between the specific task “basic designing of the NIP section (1)” and the specific task “examining the control method.” Therefore, the integrated schedule generating section 216 generates the integrated schedule such that the work start time of the specific task “basic designing of the NIP section (1)” is in synchronization with the work start time of the specific task “examining the control method.”

In this way, the information processing apparatus 100 of the present embodiment can generate the integrated schedule with focus placed on a portion of the phases in the product development project, by using a combination of management data from several layers. As a result, the information processing apparatus 100 can generate an integrated schedule that is more appropriate than an integrated schedule generated for the entire product development project.

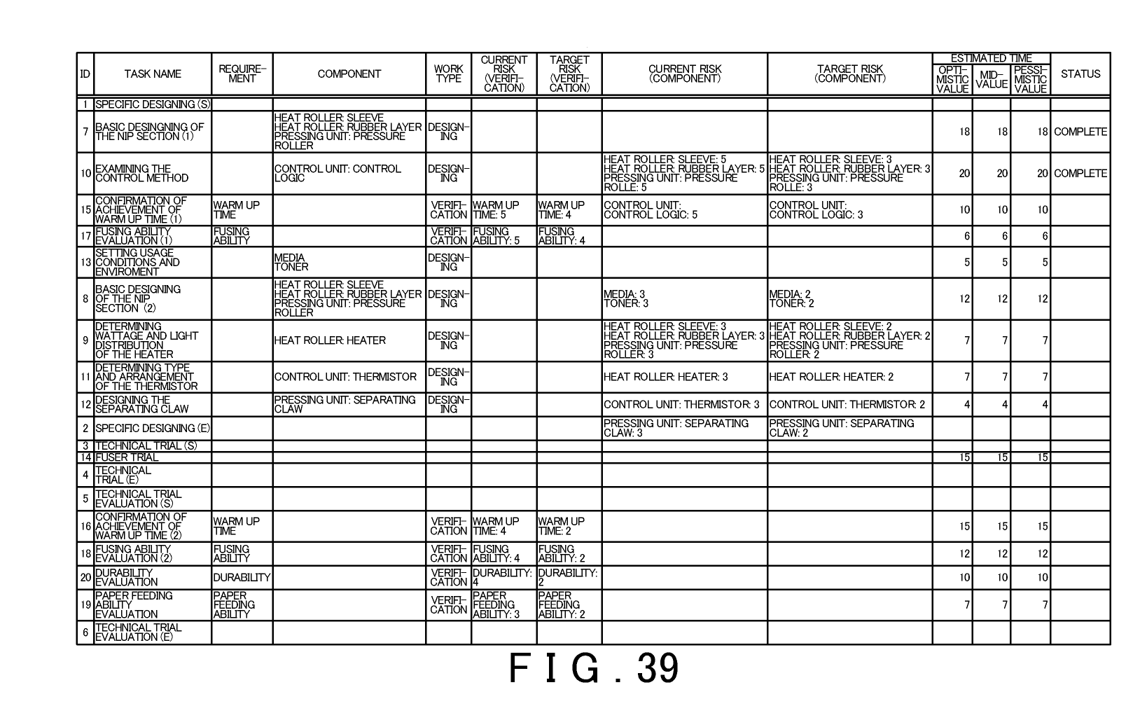

FIG. 39 shows an exemplary integrated task list generated by the integrated task dependency relationship calculating section 208. The integrated task list shown in FIG. 39 differs from the integrated task list shown in FIG. 32 in that the work order of the specific tasks is rearranged according to the work order determined by the integrated schedule generating section 216.

The integrated task list of FIG. 39 further differs from the integrated task list of FIG. 32 in that, in response to the completion of the work for both the specific task “basic designing of the NIP section (1)” and the specific task “examining the control method,” the “status” field for each of the specific task “basic designing of the NIP section (1)” and the specific task “examining the control method” is updated from “not begun” to “complete.”

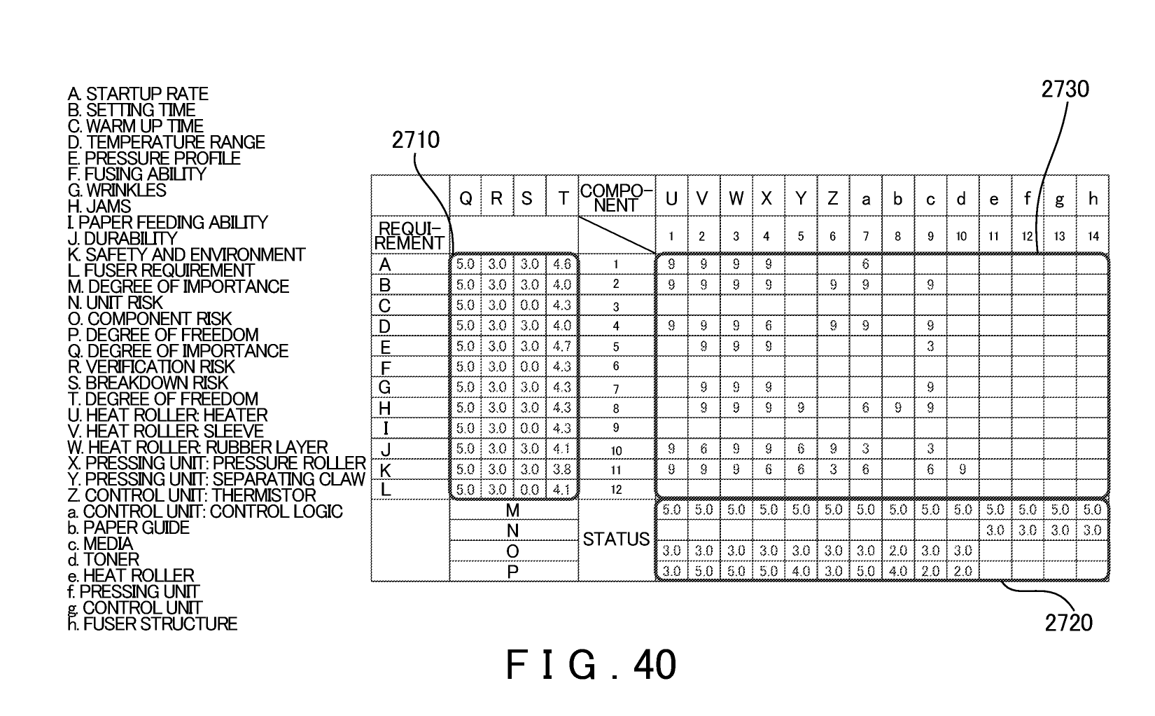

FIG. 40 shows exemplary risk values acquired by the status acquiring section 222 and degrees of dependency acquired by the dependency degree acquiring section 224. The DMM table of FIG. 40 differs from the DMM table of FIG. 27 in that, when the status of a specific task is updated in the integrated task list as shown in FIG. 39, the statuses of a corresponding plurality of components are automatically updated in the status region 2720 and the statuses of a plurality of associated requirements are automatically updated in the status region 2710.

For example, when the status of the specific task “basic designing of the NIP section (1)” becomes “complete” in the status region 2720, the data conforming unit 400 updates the component risk values of the component “heat roller: sleeve,” the component “heat roller: rubber layer,” and the component “pressing unit: pressure roller.” Furthermore, when the status of “examining the control method” becomes “complete,” the data conforming unit 400 updates the component risk of the component “logic unit: control logic” to a value of “3.” In response to the above updates, the unit risk for each of the component “heat roller,” the component “pressing unit,” the component “control unit,” and the component “fuser structure” is automatically updated to a value of “3.” Furthermore, the data conforming unit 400 automatically updates, in the status region 2710, the breakdown risk values and the verification risk values of the requirements associated with the components whose statuses were updated.

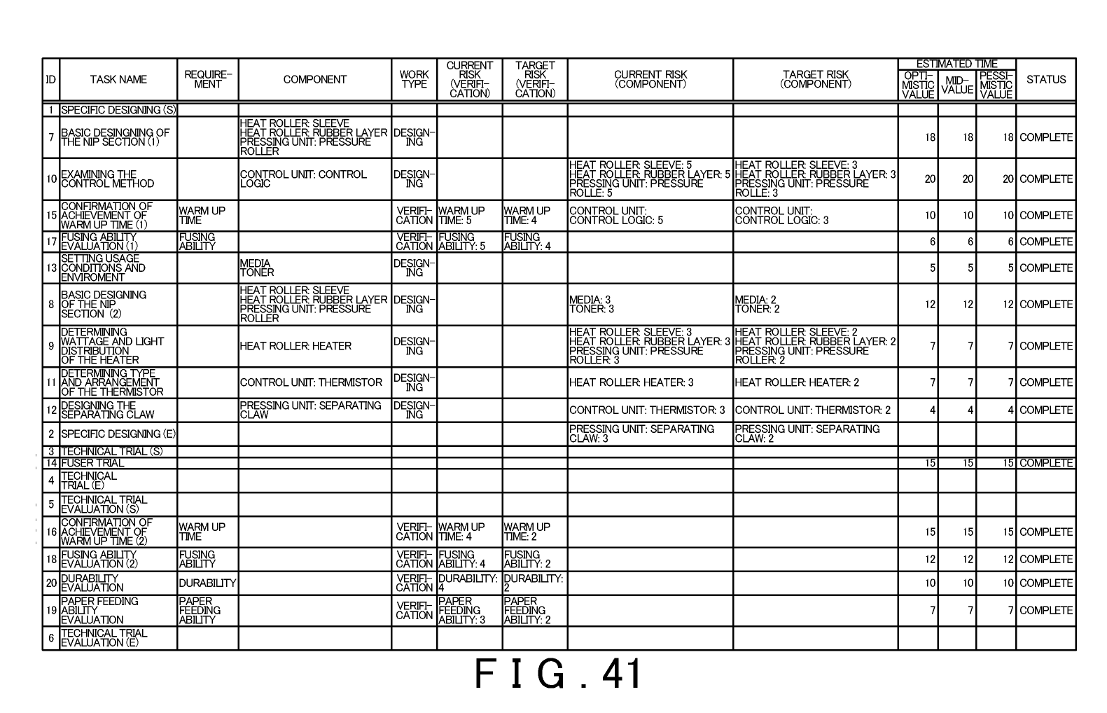

FIG. 41 shows an exemplary integrated task list generated by the integrated task dependency relationship calculating section 208. The integrated task list shown in FIG. 41 differs from the integrated task list shown in FIG. 32 in that the work order of the specific tasks is rearranged according to the work order determined by the integrated schedule generating section 216.

Furthermore, the integrated task list of FIG. 39 differs from that of FIG. 32 in that, in response to the completion of the work for all specific tasks, the “status” fields for all of the specific tasks are updated from “not begun” to “complete.”

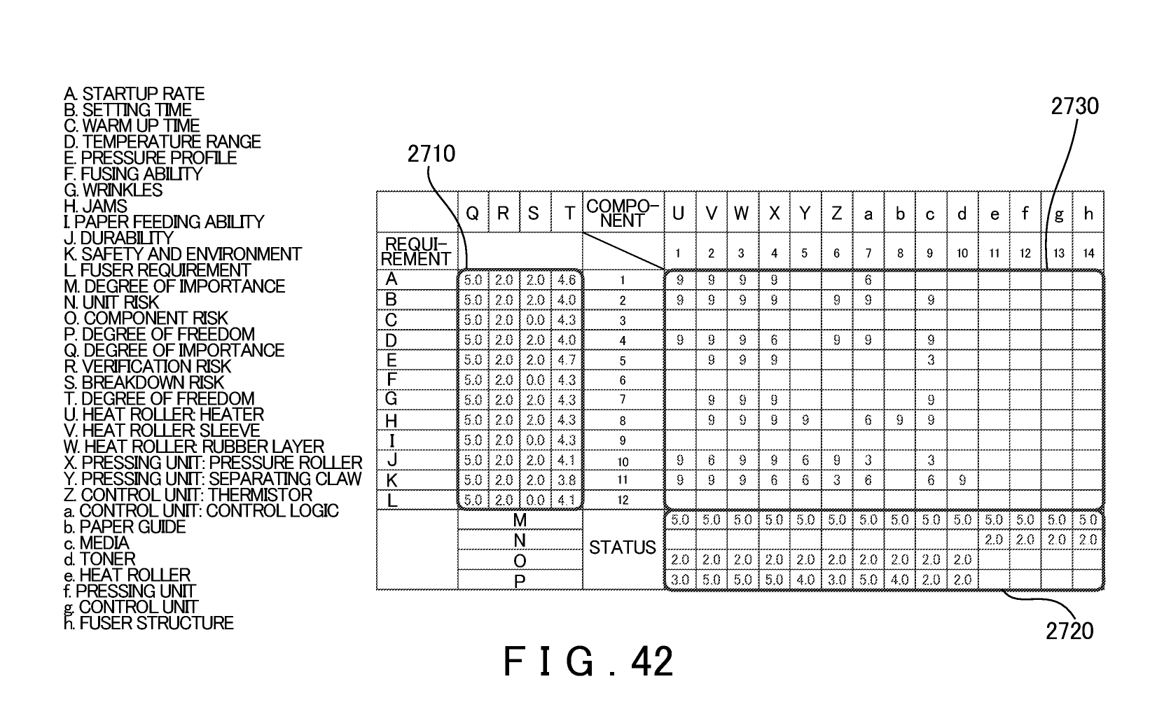

FIG. 42 shows exemplary risk values acquired by the status acquiring section 222 and degrees of dependency acquired by the dependency degree acquiring section 224. The DMM table of FIG. 42 further differs from the DMM table of FIG. 27 in that, when the statuses of all of the specific tasks are updated to “complete” in the integrated task list as shown in FIG. 41, the data conforming unit 400 automatically updates the verification risk values and breakdown risk values of a plurality of requirements in the status region 2710 and automatically updates components risks and unit risks of a plurality of components in the status region 2720.

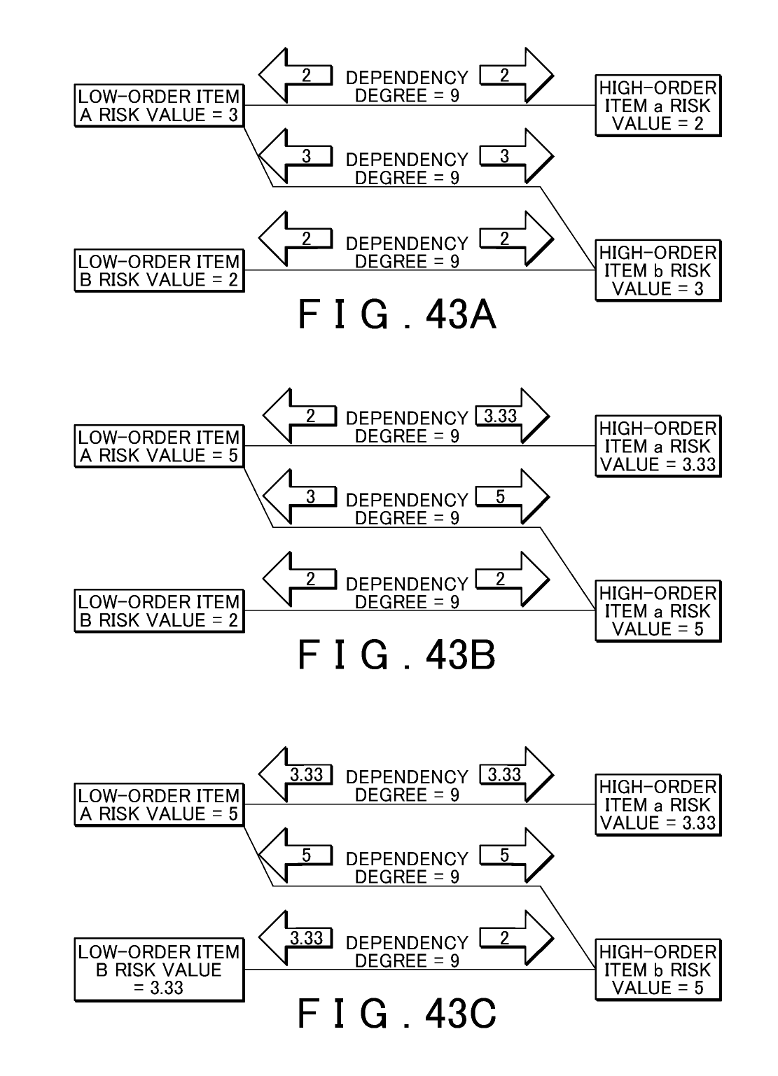

FIGS. 43A to 43C show other exemplary processes performed by the data conforming unit 400. The data conforming unit 400 performs a different process in the second embodiment than in the first embodiment. In the second embodiment, the conformity value storage section 408 stores a conformity value received by a low-order item from a high-order item and a conformity value received by a high-order item from a low-order item, for each path between items having a low-order and high-order relationship with each other. Here, the component risk of a sub-component is higher order than the unit risk of the parent component, the specification risk of a parent requirement is higher order than the specification risk of a sub-requirement, the specification risk of a requirement is higher order than a component risk, a component risk is higher order than the verification risk of a requirement, and the verification risk of a sub-requirement is higher order than the verification risk of a parent requirement. Breakdown risk is one type of specification risk, and in a process for judging conformity of the risk values and a process for updating the risk values, the breakdown risk is processed in alignment with specification risks that are not related to high-order specification risk.

In the example of FIG. 43A, the conformity value storage section 408 stores a value of “2” as the conformity value that the low-order item “a” receives from the high-order item A. Here, the maximum value of the conformity value passed from the low-order item A to the high-order item “a” is “3,” which is obtained as a product of (i) the risk value of item A and (ii) the quotient of the dependency relationship between item A and item “a” divided by “9,” but since the risk value of the high-order item “a” is set as “2,” the conformity value from the low-order item A to the high-order item “a” is limited to the value of the high-order item “a,” which is “2.” Furthermore, the conformity value storage section 408 stores a value of “3” as the conformity value that the high-order item “b” receives from the low-order item A. The conformity value storage section 408 stores a value of “2” as the conformity value that the high-order item “b” receives from the low-order item B.

The conformity value storage section 408 stores a value of “2” as the conformity value that the low-order item A receives from the high-order item “a.” The conformity value storage section 408 stores a value of “3” as the conformity value that the low-order item A receives from the high-order item “b.” The conformity value storage section 408 stores a value of “2” as the conformity value that the low-order item B receives from the high-order item “b.” Here, the maximum value of the conformity value passed from the high-order item “b” to the low-order item A is “3,” which is obtained as a product of (i) the risk value of item “b” and (ii) the quotient of the dependency relationship between item “b” and item B divided by “9,” but since the risk value of the low-order item B is set as “2,” the conformity value from the high-order item “b” to the low-order item B is limited to the value of the low-order item B, which is “2.”

When the risk value of a low-order item increases, first, the data conforming unit 400 updates the risk value of the item having a high-order relationship with regard to the item whose risk value was updated. Specifically, the data conforming unit 400 calculates a new conformity value that the high-order item receives from the low-order item whose risk value was updated, by multiplying (i) the quotient of the updated low-order risk value divided by the low-order risk value before the update by (ii) the known conformity value from the low-order item to the high-order item. The data conforming unit 400 updates the conformity value that the high-order item receives from the low-order item whose risk value was updated, to be the conformity value calculated as described above. The data conforming unit 400 updates the risk value of the high-order item to be the maximum value from among the conformity values received from the plurality of low-order items.

For example, as shown in FIG. 43B, when the risk value of the low-order item A is updated from “3” to “5,” the data conforming unit 400 updates the conformity value that the high-order item “a” receives from the low-order item A from “2” to “3.33.” Furthermore, the data conforming unit 400 updates the conformity value that the high-order item “b” receives from the low-order item A from “3” to “5.” The data conforming unit 400 updates the risk value of the high-order item “a” from “2” to “3.33.” If only integers are allowed for the risk values, the data conforming unit 400 may keep the risk value of the high-order item “a” at “3,” without performing an update. The data conforming unit 400 updates the risk value of the high-order item “b” from “3” to “5.”

If the high-order item has even higher-order items, the data conforming unit 400 updates the risk values of these higher-order items by repeating the process described above.

Next, the data conforming unit 400 updates the risk value of the item having a low-order relationship with regard to the highest-order item. Specifically, the data conforming unit 400 calculates a new conformity value that the low-order item receives from the high-order item whose risk value was updated, by multiplying (i) the quotient of the updated high-order risk value divided by the high-order risk value before the update by (ii) the known conformity value from the high-order item to the low-order item. The data conforming unit 400 updates the conformity value that the low-order item receives from the high-order item whose risk value was updated, to be the conformity value calculated as described above. The data conforming unit 400 updates the risk value of the low-order item to be the maximum value from among the conformity values received from the plurality of high-order items.

For example, as shown in FIG. 43C, when the risk value of the high-order item “a” is updated from “3” to “3.33,” the data conforming unit 400 updates the conformity value that the low-order item A receives from the high-order item “a” from “2” to “3.33.”

Furthermore, as shown in FIG. 43C, when the risk value of the high-order item “b” is updated from “3” to “5,” the data conforming unit 400 updates the conformity value that the low-order item A receives from the high-order item “b” from “3” to “5.” The data conforming unit 400 updates the conformity value that the low-order item B receives from the high-order item “b” from “2” to “3.33.” If only integers are allowed for the risk values, the data conforming unit 400 may update the risk value of received by the parent item B from the sub-item “b” from “2” to “3.”

The data conforming unit 400 updates the risk value of the low-order item B from “2” to “3.33.” Since the risk value of the low-order item A is greater than or equal tot he maximum value from among the conformity values received by each high-order item, the data conforming unit 400 does not update the risk value of the low-order item A.

The process used when the risk value of an item decreases is the same as the update process used when the risk value of this item increases, but the update rule for the conformity values between items is different only in a case where the conformity value from the item whose risk value decreased to the affected item is limited to the value of the affected item. For example, in the state shown in FIG. 43, when the risk value of item A is updated from “5” to “1,” the conformity value from item A to item “b” becomes the greatest conformity value that can be passed from item A having risk value “5” to item “b,” and this greatest conformity value is “5,” as calculated as the product of (i) the risk value of item A and (ii) the quotient of the degree of dependency between item A and item “b” divided by “9.” Therefore, the data conforming unit 400 updates the conformity value in the same manner as when a risk value increases, updating this conformity value to “1.”

On the other hand, for the conformity value from item A to item “a,” the greatest conformity value is “5,” as calculated as the product of (i) the risk value of item A and (ii) the quotient of the degree of dependency between item A and item “a” divided by “9,” but the actual conformity value from item A to item “a” is limited to “3.33” since the risk value of the affected item “a” is “3.33.” Accordingly, in this case, regarding the update of the conformity value from item A to item “a,” the minimum necessary risk value of item A necessary for transferring, to the affected item, the conformity value from item A to item “a” is already calculated to be “3.33,” by multiplying the quotient of the conformity value from item A to item a divided by the product of “9” and the degree of dependency between item A and item “a.” Therefore, the process for updating the conformity value from item A to item “a” when the risk value of item A decreases is achieved by the data conforming unit 400 updating this conformity value to “1,” which is obtained as the product of (i) the quotient of the risk value of the updated item A divided by the necessary risk value of item A and (ii) the known conformity value from item A to item “a,” without having the data conforming unit 400 reference the drop from “5” to “3.33” of the risk value of item A since this drop is greater than or equal to the necessary risk value of item A.

In this way, the information processing apparatus 100 of the present embodiment can automatically update risk values of requirements and components associated with a specific task that has progressed, according to the progression input to the specific task list. Furthermore, since the information processing apparatus 100 can automatically correct non-conformity among risk values of requirements and components that occurs due to an update to the risk values of requirements and components associated with the specific tasks, the information processing apparatus 100 can maintain conformity among the risk values of the requirements and the components. Therefore, by inputting the progress of a specific task list according to the scheduled completion of a specific task, a user can easily understand the state of the risk values of the requirements and components. Furthermore, by inputting theoretical progress of a specific task list according to the theoretical completion of a specific task, the user can easily understand how the state of the risk values of the requirements and components would change. For example, by understanding the effect of the progress on the risk values, the user can judge whether certain work is being overlooked and whether it is necessary to alter the plan.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

1. An information processing system for obtaining dependency relationships of a plurality of tasks in a product development project, the information processing system comprising:
a specific task list acquiring section that acquires a specific task list in which at least one of a requirement that is needed for a product being developed and a component included in the product being developed is associated with each of a plurality of specific tasks;
a status acquiring section that acquires a risk value for each requirement and component indicated by the specific task list;
a dependency degree acquiring section that acquires, for each requirement and component indicated by the specific task list, a degree of dependency of the requirement or component on another requirement or component;
an integrated task dependency relationship calculating section that calculates dependency relationships of the specific tasks based on the risk values acquired by the status acquiring section and the degrees of dependency acquired by the dependency degree acquiring section; and
an integrated task dependency relationship information generating section that generates integrated task dependency relationship information indicating the dependency relationships of the specific tasks.

2. The information processing system according to claim 1, further comprising an integrated task work order calculating section that calculates a work order of the specific tasks based on the dependency relationships of the specific tasks, wherein
the integrated task dependency relationship information generating section generates the integrated task dependency relationship information to indicate the dependency relationships of the specific tasks and the work order of the specific tasks.

3. The information processing system according to claim 1, further comprising a general task dependency relationship information acquiring section that acquires general task dependency relationship information indicating dependency relationships of a plurality of general tasks, which are superordinate tasks of the specific tasks, wherein
the integrated task dependency relationship calculating section calculates the dependency relationships of the specific tasks further based on the general task dependency relationship information.

4. The information processing system according to claim 1, further comprising a specific schedule generating section that generates a schedule for the specific tasks based on the work order of the specific tasks indicated by the integrated task dependency relationship information.

5. The information processing system according to claim 4, further comprising an overlap policy acquiring section that acquires an overlap policy determining synchronization timings of work dates among the specific tasks, wherein
the specific schedule generating section generates the schedule for the specific tasks such that the work dates are synchronized among the specific tasks, based on the overlap policy.

6. The information processing system according to claim 1, further comprising an update detecting section that detects an update to at least one of the risk values of the requirements and the risk values of the components indicated by the specific task list, wherein
as a result of the update detecting section detecting the update, (i) the status acquiring section acquires an updated risk value and (ii) the integrated task dependency relationship calculating section calculates the dependency relationships of the specific tasks based on the updated risk value and the degrees of dependency acquired by the dependency degree acquiring section.

7. (canceled)

8. (canceled)

9. A computer readable medium storing thereon a program for use by an information processing system for obtaining dependency relationships of a plurality of tasks in a product development project, the program causing a computer to function as:
a specific task list acquiring section that acquires a specific task list in which at least one of a requirement that is needed for a product being developed and a component included in the product being developed is associated with each of a plurality of specific tasks;
a status acquiring section that acquires a risk value for each requirement and component indicated by the specific task list;
a dependency degree acquiring section that acquires, for each requirement and component indicated by the specific task list, a degree of dependency of the requirement or component on another requirement or component;
an integrated task dependency relationship calculating section that calculates dependency relationships of the specific tasks based on the risk values acquired by the status acquiring section and the degrees of dependency acquired by the dependency degree acquiring section; and
an integrated task dependency relationship information generating section that generates integrated task dependency relationship information indicating the dependency relationships of the specific tasks.

10. (canceled)

11. An information processing method for obtaining dependency relationships of a plurality of tasks in a product development project, the information processing method comprising:
acquiring a specific task list in which at least one of a requirement that is needed for a product being developed and a component included in the product being developed is associated with each of a plurality of specific tasks;
acquiring a risk value for each requirement and component indicated by the specific task list;
acquiring, for each requirement and component indicated by the specific task list, a degree of dependency of the requirement or component on another requirement or component;
calculating dependency relationships of the specific tasks based on the acquired risk values and the acquired degrees of dependency; and
generating integrated task dependency relationship information indicating the dependency relationships of the specific tasks.

12. (canceled)
